(19) United States
(12) Patent Application Publication
(10) Pub. No.: US 2023/0013375 A1
(43) Pub. Date: Jan. 19, 2023

(54) AUTOMATED AND HIGH THROUGHPUT IMAGING MASS CYTOMETRY

(71) Applicant: FLUIDIGM CANADA INC., Markham (CA)

(72) Inventors: Daaf Sandkuijl, Markham (CA); Alexander Loboda, Thornhill (CA); Vincent Yi-Ching Yeh, Toronto (CA); Ladan Gheiratmand, Toronto (CA)

(73) Assignee: FLUIDIGM CANADA INC., Markham, ON (CA)

(21) Appl. No.: 17/756,475

(22) PCT Filed: Nov. 25, 2020
(86) PCT No.: PCT/US2020/062268

§ 371 Date: May 25, 2022

Related U.S. Application Data
(60) Provisional application No. 63/045,512, filed on Jun. 29, 2020.
(60) Provisional application No. 62/941,028, filed on Nov. 27, 2019.

(51) Int. Cl. G01N 35/00; G01N 15/14

(52) U.S. Cl. CPC G01N 35/0099; G01N 15/14; G01N 2015/1006

(57) ABSTRACT

Methods and systems for automated slide handling for imaging applications are described herein. In certain aspects, an automated slide handler may be operatively coupled to a slide hotel and/or one or more imaging systems described herein. The automated slide handler may be a robotic arm with up to 6 degrees of freedom. Automated slide handling may include sample preparation, such as sectioning and staining. Suitable imaging systems include a fluorescence microscope or an imaging mass cytometer. Methods and systems disclosed herein enable high throughput profiling of tissue sections.

### CROSS-REFERENCE TO RELATED APPLICATIONS

This application claims the benefit of priority to U.S. Provisional Application No. 63/045,512, filed Jun. 29, 2020 and U.S. Provisional Application No. 62/941,028, filed Nov. 27, 2019, the contents of both of which are incorporated herein by reference for all purposes.

### FIELD OF ASPECTS OF THE INVENTION

Embodiments of the present invention relates to methods and systems of automated and high throughput imaging, such as automated slide handling for imaging applications, including for imaging mass cytometry.

### BACKGROUND

Imaging of a plurality of samples, such as tissue samples, can require excessive hands-on operation. For imaging modalities that are slow, such as some imaging modalities that rely on pixel by pixel acquisition, automated sample introduction may be beneficial. However, an imaging system may require slide introduction at an arbitrary location. In addition, individual samples may have different regions of interest determined by initial interrogation to guide subsequent imaging.

### SUMMARY

Methods and systems for automated and high throughput imaging, including automated slide handling for imaging applications are described herein.

In certain aspects, a system for introduction of slides into an imaging system includes an automated slide handler comprising multiple degrees of freedom, such as 6 degrees of freedom. The slide handler may include a robotic arm, such as a six axis robotic arm. The system may further include one or more of a laser ablation system, an imaging system, one or more cameras integrated to direct robotic arm operation, and/or a slide hotel. For example, the system may include a slide hotel configured to hold a plurality of slides, and the slide handler may be configured to transfer slides between the slide hotel and one or more imaging systems.

The system may be configured (e.g., by a controller and software) to record regions of interest for a plurality of slides in the slide hotel and optionally further to direct imaging (e.g., imaging mass cytometer) at the regions of interest.

The system may further include a sample preparation station. The sample preparation station may be configured to deliver reagents to samples mounted on one or more slide. The reagents may include mass tagged specific binding partners (e.g., antibodies).

The system may further include one or more imaging systems, which may include an imaging mass cytometer. The system may include an imaging system that performs pixel by pixel acquisition, such as by LA-ICP-MS, imaging mass cytometry, and/or confocal microscopy.

The system may be configured to record one or more regions of interest for imaging by imaging mass cytometry.

The system may include an imaging mass cytometer that includes a sampling device such as a laser ablation source or an ion beam source. The imaging mass cytometer may further include an ionization source, such as a plasma (e.g., an inductively coupled plasma). Alternatively or in addition, the imaging mass cytometer may include a detector, such as a magnetic sector or time-of-flight detector.

The system may include an optical microscope integrated with an imaging mass cytometry system (such as an LA-ICP-MS imaging mass cytometry system), or separate from an imaging mass cytometry system. The system may be configured to create fiducials on slides through laser ablation. The system may be configured to identify laser ablation fiducials (e.g., that allow calibration of X-Y coordinates or that directly indicative ROIs) on a slide to direct sampling of an ROI.

An imaging system may include an optical microscope, such as a wide-field fluorescence microscope or a confocal microscope. The system may include an imaging mass cytometer and an optical microscope separate from the imaging mass cytometer, wherein the slide handler is configured to transfer slides between the optical microscope and the imaging mass cytometer (e.g., such as through a slide hotel intermediate). The system may be configured to perform imaging mass cytometry on an ROI determined by the optical microscope, such as a fluorescence microscope. The system may be configured to identify ROI based on features of a tissue section on a slide, such as through user input or through predetermined software. A system comprising an imaging mass cytometer operatively coupled to an automated slide handler comprising 6 degrees of freedom.

Also included are methods of using the systems described herein. Methods may include automated introduction of a plurality of slides into an imaging system from a slide hotel.

A method may include recording regions of interest (ROIs) on a plurality of slides in a first step. The method may further include introducing the plurality of slides into the imaging system, and imaging regions of interest using the imaging system, in a second step. The imaging system may include an imaging mass cytometer. As such, the method may further include identifying regions of interest in the plurality of samples prior to imaging mass cytometry. In certain aspects, the samples include banked FFPE samples and/or serial sections on separate slides. Methods may also include creating fiducials on the slide through laser ablation.

Alternatively or in addition, a method may include, a method may include resin embedding and array tomography sample preparation.

Alternatively or in addition, a method may include automated staining of samples, such as by a fluidic staining system.

Alternatively or in addition, a method may include staining the sample with a segmentation panel comprising mass tagged antibodies to a plurality of membrane targets for IMC analysis.

### BRIEF DESCRIPTION OF THE FIGURES

FIG. 1 is a diagram describing 6 degrees of freedom.

FIG. 2 is a diagram showing range of operation of an exemplary robotic arm.

FIG. 3 is a diagram showing axes of a robotic arm.

FIG. 4A-C is a diagram of various slide handling systems of the subject application.

### DETAILED DESCRIPTION

Methods and systems for automated and high throughput imaging applications are described herein. In certain aspects, an automated slide handler may be operatively coupled to a slide hotel and/or one or more imaging systems described herein.

High throughput imaging (HTI) systems and workflows are capable of imaging a large number of slides, such as more than 5, 10, 20, 50 or 100 slides without user intervention. Imaging systems such as imaging mass cytometers may benefit from an automation tool for high throughput unattended operation. Potential systems (e.g., HTI units) of the subject application include pixel by pixel imaging systems and imaging systems that generate large datasets and/or require a long time to operate. In commercially available microscopes, automation for slide loading has been performed using a cartesian coordinate robot such as the PL200 robot from Prior. However, a slide handler comprising at least 3, 4, or 5 degrees of freedom (e.g., 6 degrees of freedom), such as a multi-axes robotic arm would be a more costly solution. However, the downside of the more expensive solution can be offset by the simplicity of installation and calibration and by the future accessibility of mass-produced robotic arms suitable for this task. Further, such slide introduction may allow for coupling of various imaging systems, slide hotels and/or sample preparation stations, as well as manipulation of different slide sizes and shapes.

### Automated Slide Hander and Operation

A slide handler of the subject application may have at least 3, 4, or 5 degrees of freedom. In certain aspects, the slide handler has 6 degrees of freedom.

The slide handler may be configured to manipulate slides, such as slides in a slide hotel and/or imaging system. The slide handling system may include software to transfer slide between a slide hotel and one or more imaging systems. The software may further include a format for recording a region of interest (e.g., based on an optical microscopy image or initial imaging mass cytometry scan) for each slide and/or imaging (e.g., by imaging mass cytometry) a recorded region of interest on each slide.

### Degrees of Freedom

The slide handler may have at least 3, 4, or 5 degrees of freedom. In certain aspects, the slide handler has 6 degrees of freedom.

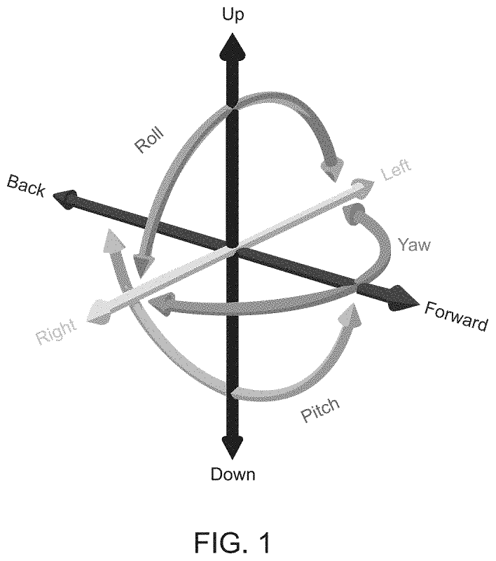

FIG. 1 shows 6 degrees of freedom, including 3 translational movements and 3 rotational movements. The 3 translational movements include surge (forward and backward on the X-axis), sway (left and right on the Y-axis), and heave (up and down on the Z-axis). The 3 rotational movements include roll (tilting side to side on the X-axis), pitch (tilting forward and backward on the Y-axis), and yaw (Turning left and right on the Z-axis).

An increased degree of freedom of the slide handler allows it to manipulate slides at arbitrary locations. For example, the slide handler may transfer slides between a slide hotel and one or more imaging systems.

### Robotic Arm

In certain aspects, the slide handler is a robotic arm. The robotic arm may have a plurality of axes, such as at least 3, 4, 5, or 6 axes. As such, the robotic arm may have 3, 4, 5, or 6 degrees of freedom. In certain aspects, the robotic arm is a 6 axis robotic arm (i.e., comprises at least 6 axes). The robotic arm may further comprise a base. The robotic arm may further comprise a gripper configured to grab and release slides.

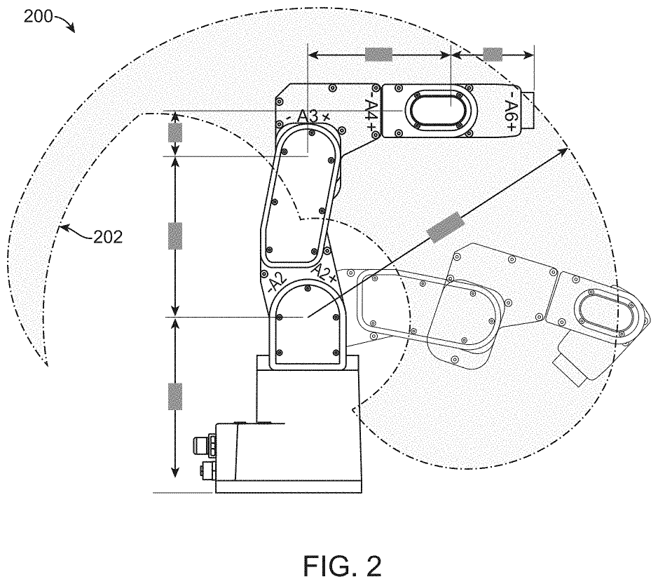

As shown in FIG. 2, a robotic arm 200 has an area of operation 202 in which it can be operatively coupled to one or more systems, such as a slide hotel and/or imaging system. The exemplary robotic arm shown in FIG. 2 is the Meca 500 small robot arm, provided by Mecademic.

In certain aspects, the system may include a camera with a field of view covering most or all of the area of operation of the robotic arm. The camera may be mounted on the robotic arm, or may be separate from the robotic arm. The camera may be integrated (e.g., with a controller of the robotic arm) to direct the robotic arm to transfer slides between slots of slide hotel and a slide introduction location of an imaging device.

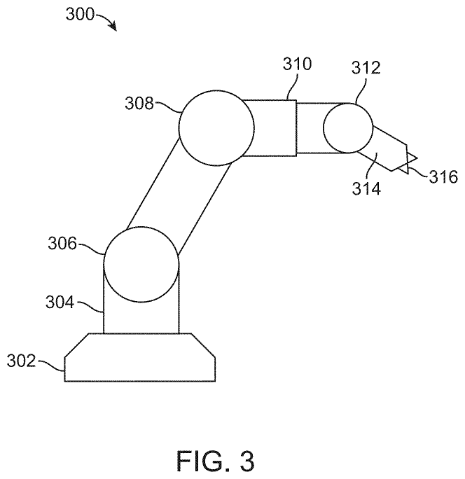

As shown in FIG. 3, a robotic arm 300 may include a base 302, multiple axes of operation 304, 306, 308, 310, 312 and 314, and a gripper 316.

Aspects of the subject application include use of a 6-axis robotic arm for grabbing a slide from a “slide hotel” and delivering the slide to the slide holder (e.g., slide introduction location) of the HTI unit. This approach is flexible enough and generic enough that with minor modifications it can be utilized on a wide variety of microscopes.

The inventors have realized that creating a slide loader based on a sufficiently accurate 6-axis robotic arm may only require calibration of the relative position of the robotic arm to the slide hotel, and the relative position of the robotic arm to the slide holder in the HTI unit. This represents a significant simplification of the design, and improvement in modularity over alternative slide loaders, since almost all complexity is contained within the robotic arm.

In certain HTI configurations, the slide is grabbed by a robotic gripper attached to the 6-axis arm. The gripper may provide customization for different configurations of slide sources and slide receivers, in general. The arm itself can be a generic arm of sufficient positioning accuracy, reach (e.g., area of operation) and mechanical strength.

A potential problem with the whole setup is that the gripper may damage the slide when trying to grip it or when carrying it and running into an obstacle or when inserting the slide into the slide holder. To avoid this problem the slide gripper may have features to register the slide position. Or, the gripper might grip the slide imprecisely and the slide holder receiver might have features to guide the insertion of the imprecisely gripped slide. As a yet another alternative, there could be an intermediate location where the imprecisely gripped slide can be inserted, and that action will register the slide in the intermediate location. This well registered slide can be gripped with precision and then inserted into the slide holder.

### Cameras

In terms of further integration. It could be beneficial to install a monitoring camera or cameras either on the arm itself or in the critical areas of manipulation such as the slide holder insertion area and in the slide storage area. Software can be used to detect abnormalities and handle errors. Machine learning could be suitable for image processing and status monitoring. Another potentially useful tool on the storage side is the slide present detector. This tool can take a form of individual optical detectors for every slide insert on the hotel side. A camera and a slide detection software can provide slide detection function as well. A similar slide present detector can be utilized on the microscope slide holder. This would avoid a situation where the slide loader is attempting to load a slide into an already loaded slide holder.

In a batch operation, the slide loader may remove the slide from the microscope stage and then return it to a free location in a slide “hotel”. The software may mark that location as a “used” slide. A new slide will then be picked up and the slide loader will insert it into the slide holder on the microscope stage. In the case of an HTI unit these loading/unloading operations may be synchronized with the opening and closing of a door to the slide introduction location (e.g., of a laser ablation chamber), flushing of the gases in ablation chamber and/or movement of the ablation XYZ stage to and from the loading/unloading location.

In one embodiment the cameras are used for the 3D vision to assess position of the slide with respect to the gripper, or with respect to the slide holder of the microscope (or ablation chamber) or with respect to the slide storage (slide rack, slide hotel).

The information from the cameras may be processed using machine vision algorithms. For example, the 3D vision setup can be activated just before the slide is to be inserted into the slide holder. The sequence (for illustration purpose) can go as following: the arm with the gripper moves the slide into close proximity to the slide holder; the 3D vision system reads the relative position of the slide in the gripper with respect to the slide holder and makes a correction in the next move that engages the slide into the slide holder to account for observed errors in the previously taken 3D image.

The 3D vision setup can include a pair of cameras. In one embodiment the cameras are mounted at 90 degrees angle to each other; one camera is looking at the thin side of the slide and the other one is looking at the wide side of the slide. In this arrangement the edges of the slide are visible. In another embodiment the cameras are mounted at a different relative angle, for instance at 120 degrees angle. Still, the machine vision algorithms are reprocessing the images to calculate 3D coordinates of the slide and the slide holder. Dedicated illumination sources and specialized choices of optical wavelengths can be setup to facilitate observation of slide edges. Special microscope slides may comprise fiducials, for instance with highlighted (or, colored) edges that are used to provide visual feedback to guide the movement of the robotic arm in the subject methods. Alternatively or in addition, the workstation may include fiducials used as a reference to identify a position of the slide or the arm.

For 3D vision, other technologies such as LIDAR based cameras and stereoscopic cameras based on structured light illumination or light patterns can be employed.

The cameras can be mounted on the robotic arm and will move with the arm, or the cameras can be stationary and located near critical areas such as slide loading/unloading zone.

In one embodiment the stereoscopic 3D vision is accomplished by a pair of cameras where one camera is stationary and located in the critical area and the second camera is attached to the robotic arm.

The downside of the stationary cameras is that the 3D vision setup needs to be replicated for every critical area. In the case of a simple pick and place activity between the slide rack and the slide holder in a microscope (or, a mass cytometry microscope) four cameras will be required. But, a more complex system with multiple instruments will require many cameras. This is when placing the 3D vision system on the robotic arm could become beneficial. On the other hand, the prices of simple cameras that are adequate for this task continue to decline and stereoscopic cameras are now offered at the price of $200 per setup. This means spending $200 on a system that acts as a critical interlock can be justifiable for a complex equipment and expensive samples on the slides.

With the 3D vision system acting as a critical interlock (facilitated by machine vision), the software can process unitary operations and conduct a check of success for each operation. For example, the arm can bring the slide close to the slide holder. Then, the system would read the relative positions. If the system finds that the relative positions are outside of acceptable range the system would correct the motion/position or halt its operation in a safe state. The same approach can be repeated once the slide is inserted into the slide holder. The system can check on the relative location of the slide in the slide holder and decide if it is safe to proceed with further actions, to modify further actions based on the relative position detected, or if the system needs to come to a halt. In many cases halting the operation in the abnormal scenario is the optimal course of action. Indeed, proceeding to operate in abnormal conditions can result in a loss of precious sample. Since the system will be designed to rarely experience abnormal conditions the halting operation will not reduce the throughput too much. But, in the instances the abnormal operation does happen the checks from the 3D vision system will allow the system to save the sample. In FMEA terms—without the 3D vision checks and SW analysis in place the system will have the low probability of failure and a high penalty for severity of sample loss (or damage to the hardware). Thus, the product of Probability and Severity might still be too high for many applications. Addition of the check of abnormal states allows one to reduce the Probability by several orders of magnitude and bring the value of Probability*Severity to an acceptable level.

Aspects may further include a computer readable medium comprising instructions for checking a position (e.g., location and/or orientation) of the robotic arm (e.g., of a grippr of the robotic arm) and/or a slide, prior to committing to an action that moves the slide. The action may be one that requires alignment of the slide with equipment accessed by the robotic arm, such as removing or loading the slide from/to a slide hotel or from/to an imaging system. The robotic arm may be stopped while the position is checked. Variance of the position from an expected position may be used to correct the position, or may trigger an error alert to notify a user. The computer readable medium may use image recognition to identify the robotic arm, a slide, one or more additional pieces of equipment, and/or one or more fiducials. The computer readable medium may be on a computer external to the robotic arm. The computer readable medium may provide instructions to a controller of the robotic arm, and may further provide instructions to one or more additional pieces of equipment. In general, the computer readable medium may execute any of the methods described herein.

Overall, any of the above embodiments may provide an automated pipeline for comprehensive investigation of tissues.

### Additional Components to the Slide Handler

In certain aspects, a system or method of the subject application may include one or more additional pieces of equipment described below (e.g., equipment accessible by a automated slide handler such as a robotic arm).

When multiple (e.g., 3 or more, or 5 or more) pieces of equipment are serviced by the robotic arm the equipment can be set up on a long linear bench and the robotic arm can be setup on a rail that visits different locations as demanded by the process. The robotic arm carrier on the rail can include a slide storage compartment to shuttle the samples and the arm between two different pieces of equipment.

As an alternative. A robotic arm can be setup to service multiple (e.g., 3 or more, or 5 or more) pieces of equipment located around a semicircle. More than one semicircle each with its robotic arm can be setup when many different pieces of equipment must be integrated. To transfer samples between these robotic arms a one-way or two-way conveyor can be operated. A random-access conveyor such as the one developed by Planar Motors can used to transfer slides between semi-circular clusters each equipped with its robotic arm.

Overall, a system with high degree of automation could be suitable to act as a central imaging hub for a core facility or a hospital. In such setups a robotic arm equipped with machine vision hardware and machine vision software becomes a critical piece that allows one to integrate various diverse pieces of equipment into a set of standardized but flexible imaging workflows. The whole setup can be viewed as a one automated microscope and the robotic arm with machine vision acts as a critical component to glue together a diverse set of equipment.

Additional equipment may include one or more of:

Slide storage units (blank slides, stained slides, processed slides);

Slide barcoding station and slide barcode readers where needed;

A tissue sectioning station that accepts the slides and the sample blocks and generates slides with tissue sections:

A tissue staining station there could be more than one as different sections could go to different workflows;

A microscope slide scanner (fluorescent or brightfield). This could be used for the main analysis or for preliminary analysis before analysis by an imaging mass cytometer.

Slide reformatting station. This could be a piece of equipment which facilitates conversion of slides from one holder format to another to make the slides compatible with other equipment.

An Imaging Mass Cytometry instrument as described further herein, such as a LA-ICP-MS system or a SIMS system;

An instrument for applying matrix for MALDI for the tissue sections or a similar sample preparation tool;

An imaging mass spectrometry instrument or imaging of small drug molecules or lipids or other intact ions, such as by MALDI or DESI;

An SEM (secondary electron microscope) or other type of electron microscope for high resolution imaging; and/or

A super resolution optical microscope.

In one embodiment the robotic arm facilitates transfer of samples between multiple pieces of equipment with different functions. Examples of such instruments are tissue sectioning module, automated slide staining module or multiple modules, slide barcoding module, quick optical pre-scan module, optical microscope, mass cytometry microscope, imaging mass spectrometry setup, electron microscope, physical sample format conversion module and storage modules. In one embodiment the setup automates multimodal imaging. For example, a section can be stained for optical microscopy and mass cytometry microscopy. Then, after staining, the section is loaded automatically into an optical pre-scan module or goes directly into the optical microscope for brightfield and fluorescence imaging. After the optical imaging, the slide is transferred into the storage module and the data is transferred to the server. This gives scientists access to the information allowing them to select ROIs and schedule these ROIs for imaging by mass cytometry microscopy. Another serial section can be prepared independently for the mass spectrometry imaging, for example to image concentrations of small molecules (e.g. lipids, cholesterol, drugs and their metabolites, etc.). Multiple serial sections can be stained and imaged by various techniques for tissue tomography. The optical pre-scan can constitute taking a photograph or several photographs of the slide of interest to capture the slide in its entirety by one of the service cameras. The image won't be of high quality, but it should be enough for crude purposes of navigation on the slide. The camera of the slide loading setup can have a second duty to read the barcode or QR-code of the slide.

### Slide Hotel

In certain aspects, the slide handling system comprises slide handler is operatively coupled to a slide hotel. The slide hotel includes multiple sites for holding slides. Aspects include a slide handler of the subject application operatively coupled to a slide hotel with a plurality of slides.

In certain aspects, the slide hotel may include thermal control to maintain stability of samples mounted on the slides. The slide hotel may seal slides from the external environment, and be operable to actively provide slides to a robotic arm described herein.

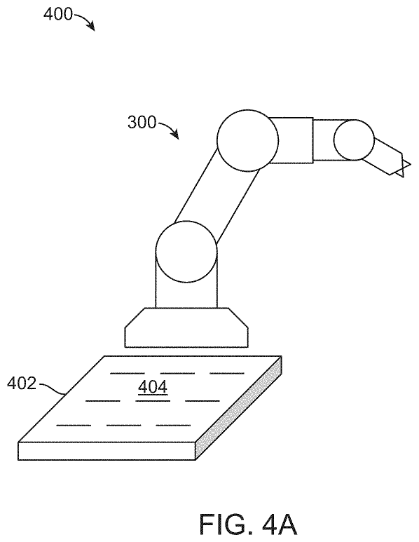

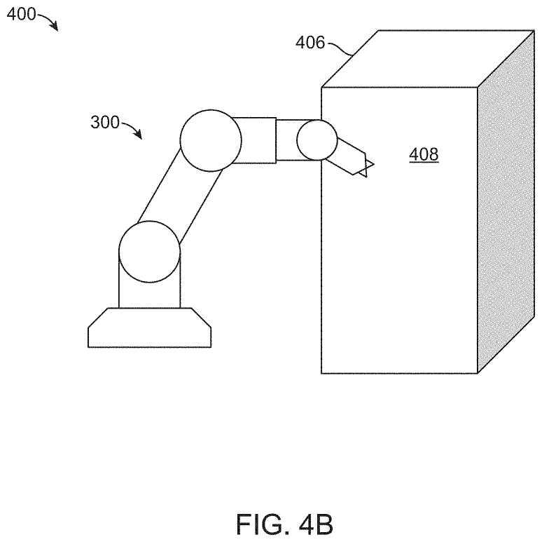

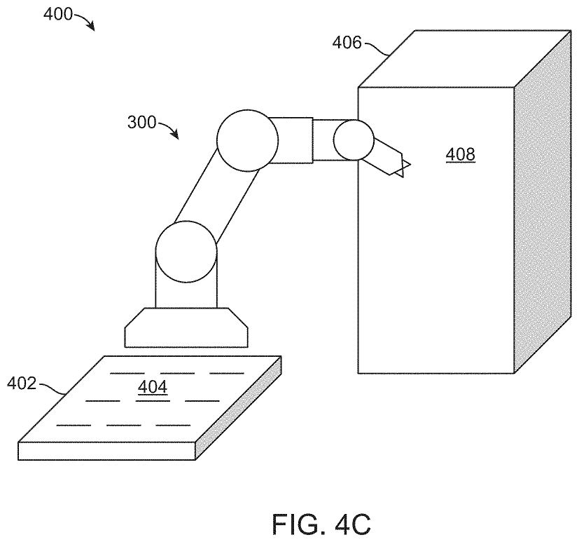

As shown in FIG. 4A, a slide handling system 400 may include a robotic arm 300 operatively coupled to a slide hotel 402 comprising a plurality of slots 404 configured to hold slides.

### Sample Preparation Station

In certain aspects, the slide handling system includes a sample preparation station for preparing slides for imaging. The sample preparation station may be configured to introduce mass-tagged specific binding pairs (SBPs), such as an antibody (that binds to its cognate antigen), aptamer or oligonucleotide for hybridizing to a DNA or RNA target, as described in more detail below, or other biomolecules to samples mounted on slides. Further, the sample preparation station may be configured to perform other sample preparation steps described herein. The sample preparation system may be part of a slide hotel, or may be coupled to the slide hotel by the slide handler.

For example, a robotic-arm based slide loader could form a basis of a microscope with sequential staining of antibodies where the fluorescent readout has a limited number of channels. The robotic arm can be configured to shuffle slides between the readout microscope and the re-staining chemical processing station.

The format of the samples transferred by the robotic arm does not have to be always a plain microscope slide. In some embodiments a set of microscope slides are arranged in a rack or on a plate. Some of the instruments might only operate with the samples arranged in a rack or on a holder plate. For instance, slide strainers for H&E often operate with a rack of samples. While the slide stainers for IHC often take a plate of samples as a format. In certain aspects, a microscope slide is fitted to a specialized holder to provide ease of handling by a gripper of the robotic arm. In certain aspects, a slide reformatting station may be configured to apply fiducials to a slide (e.g., highlight an edge of the slide) and/or fit a holder to a slide, such as a textured surface to enable gripping by the robotic arm.

The task for the robotic arm can include taking the samples in one format and converting them into another format.

Repositioning of the slides between the samples and scheduling of these operations can be orchestrated by the server setup to run the automated line of tissue imaging.

### Imaging Systems and Workflows

Imaging systems and workflows for imaging mass cytometry and any other imaging modality described herein may be integrated with slide handling systems and workflows.

As shown in FIG. 4B, a slide handling system 400 may include an imaging system 406 operatively coupled to a robotic arm 300, such the robotic arm 300 can access a slide introduction location 408 on the imaging system 406. In certain aspects, the imaging system 406 includes a imaging mass cytometer. The slide handling system may include a plurality of imaging systems 406.

As shown in FIG. 4C, a slide handling system 400 may include an imaging system 406 operatively coupled to a slide hotel 402 through a robotic arm 300.

In certain aspects, the imaging system performs pixel by pixel acquisition, such as in imaging mass cytometer and confocal microscopy. For example, an imaging mass cytometer may sample from spots (pixels) of a sample at different X Y coordinates, and analyse the labelling atoms at each spot. Pixel by pixel acquisition may take at least 10 minutes, 30 minute, 1 hour, 2 hours, 4 hours, or more for each sample.

### Imaging Mass Cytometer

As described further herein, an imaging mass cytometer samples, ionizes, and detects mass tags (e.g., labelling atoms of mass tags) from a biological sample on a solid support (slide).

### ROI Determination

Regions of interest (ROIs) of samples may be determined by an initial interrogation, for example by wide field imaging or a rapid scan.

Methods of the subject application may include determining ROIs for a plurality of samples. ROIs may be recorded as X-Y coordinates in software, and/or fiducials on the slides. Fiducials may be created by laser ablation to indicate a region of interest (e.g., alone or in combination with recorded X-Y coordinates) and/or to allow for calibration of X-Y coordinates. When slides comprise serial sections, the ROI(s) determined for one slide may be applied across slides.

Features of a biological sample, such as tissue morphology, markers and/or specific cell types may be used to determine an ROI. An ROI may be determined by a user or by automated software of the subject system. ROIs associated with each sample may be interrogated by imaging mass cytometry after introduction of the sample to an imaging mass cytometer by a slide handler.

For HTI, a user might want to get optical images (aka Panoramas) of the samples on the HTI unit to use these images to identify regions of interest (ROIs). Thus, the user may first load a batch of samples just to collect optical panoramas and unload them. As the slide panoramas start to arrive the user can quickly create a batch file for each slide allocating ROIs based on scanned images. The batch of ROIs can be identified manually or automatically via computer algorithms. The user can then initiate a second round of loading for the same slides. This time, the slides may be loaded and read by the imaging mass cytometry method based on the ROIs selected by the user. To further improve the accuracy of the ROI position on the slide after the second loading the user can instruct the HTI unit to burn in fiducials during the first loading cycle by laser ablation. Then, during the second loading of the slide these fiducials can be used for XY coordinate registration as performed now by the CyTOF 7.0 software. The first and the second loadings of the slide can be automated with the help of the slide loader. The ability to burn in fiducials is not common among other types of microscopes, but it is easily accomplished by the HTI due to its laser ablation hardware. The other microscope can rely on finding landmarks in the images to be used as fiducials.

The need to load the slide, record a simple image and then unload it and work on that image to select ROIs for a more sophisticated microscopy is not unique to the HTI. It can be encountered in fluorescent microscopy. For instance, the system can load the slide to read a brightfield image and then make that image available to operator for ROI selections. Once the slide is unloaded the system can process another slide. And the first slide can be automatically reloaded by the batch once the ROIs and the set of instructions for the more imaging processes have been defined by the user.

For example, an ROI may be determined by wide field imaging. The ROI may later be analysed by pixel by pixel imaging modality such as imaging mass cytometry, which may take at least 10 minutes, 30 minute, 1 hour, 2 hours, 4 hours, or more for each sample. As such, a first step in the subject methods may include determining ROI(s) for a plurality of samples based on user input in a first step, and pixel by pixel imaging of ROI(s) for each sample in a second (e.g., slower) step. The sample handler of the subject application may enable automation of the second step.

Of note, determination of an ROI may be by rapid pixel acquisition, such as by subsampling pixels and/or operating an imaging system at reduced sensitivity. Such ROI determination may be through imaging mass cytometry.

### Imaging Mass Cytometers

Imaging mass cytometry comprises sampling, ionization, and detection of mass tags from a biological sample on a solid support. An imaging mass cytometer may include a sampling system, for example a radiation source such as a laser, ion beam, or electron beam source. In certain aspects, the sampling system may also atomize and/or ionize the sample. Ionization and/or atomization may occur downstream of the sampling system, for example at a plasma such as an inductively coupled plasma. An imaging mass cytometer may include ion optics for selectively passing labelling atoms from mass tags to a detector. An imaging mass cytometer comprises a detector, such as a time-of-flight or magnetic sector detector. A variety of imaging mass cytometers and sub-systems thereof are described herein.

### Laser Sampling

Laser sampling of a biological sample may be by laser ablation, laser desorption, LIFTing (e.g., heating a film underlying the sample using laser radiation), or direct ionization (e.g., by forming a plasma at or near the sample surface).

A laser ablation based analyser typically comprises three components. The first is a laser ablation sampling system for the generation of plumes of vaporous and particulate material from the sample for analysis. Before the atoms in the plumes of ablated sample material (including any detectable labelling atoms as discussed below) can be detected by the detector system—a mass spectrometer component (MS component; the third component), the sample must be ionised (and atomised). Accordingly, the system may comprise a second component which is an ionisation system that ionises the atoms to form elemental ions to enable their detection by the MS component based on mass/charge ratio. The laser ablation sampling system may be coupled to the ionisation system by a transfer conduit.

### Laser Ablation Sampling System

In brief summary, the components of a laser ablation sampling system include a laser source that emits a beam of laser radiation that is directed upon a sample. The sample is positioned on a stage within a chamber in the laser ablation sampling system (the sample chamber). The stage is usually a translation stage, so that the sample can be moved relative to the beam of laser radiation, whereby different locations on the sample can be sampled for analysis (e.g. locations more remote from one another than can be ablated as a result of the relative movement in the laser beam can be induced by laser scanning system described herein). As discussed below in more detail, gas may be flowed through the sample chamber, and the flow of gas carries away the plumes of aerosolised material generated when the laser source ablates the sample, for analysis and construction of an image of the sample based on its elemental composition (including labelling atoms such as labelling atoms from elemental tags). As explained further below, in an alternative mode of action, the laser system of the laser ablation sampling system can also be used to desorb material from the sample.

It is possible to conduct laser ablation at a fluence near the ablation threshold of the sample material. Ablating in this manner often improves aerosol formation which in turn can help improve the quality of the data following analysis. Often to obtain the smallest crater, to maximise the resolution of the resulting image, a Gaussian beam is employed.

The laser system can be set up to produce single or multiple (i.e. two or more) wavelengths of laser radiation. Typically, the wavelengths of laser radiation discussed refer to the wavelength which has the highest intensity (the “peak” wavelength). If the system produces different wavelengths, they can be used for different purposes, for example, for targeting different materials in a sample (by targeting here is meant that the wavelength chosen is one which is absorbed well by a material).

### Laser Scanning System

A laser sampling system may include components for scanning the laser across a sample, for example, as described further herein. The laser scanning system directs laser radiation onto the sample to be ablated. As the laser scanner is capable of redirecting the position of laser focus on the sample much more quickly than moving the sample stage relative to a stationary laser beam (due to much lower or no inertia in the operative components of the scanning system), it enables ablation of discrete spots on the sample to be performed more quickly. This quicker speed can enable a significantly greater area to be ablated and recorded as a single pixel, or the speed of the laser spot movement can simply translate to, e.g., an increase in pixel acquisition rate, or a combination of both. In addition, the rapid change in the location of the spot onto which a pulse of laser radiation can be directed permits the ablation of arbitrary patterns, for instance so that a whole cell of non-uniform shape is ablated, by a burst of pulses/shots of laser radiation in rapid succession directed onto locations on the sample by the laser scanner system, and then ionised and detected as a single cloud of material, thus enabling single cell analysis (see the “Error! Reference source not found.” section described further herein). A similar rapid-burst technique can also be deployed in methods using desorption to remove sample material from a sample carrier, i.e. cell LIFTing (Laser Induced Forward Transfer), as discussed in more detail regarding system and methods described further herein.

In existing imaging mass cytometers, the stage may be moved to allow for ablation of different pixels (ablation spots). Laser scanning using the positioners described herein (optionally alongside translation of a sample stage) may allow for acquisition of pixels of arbitrary shape and size, such as rapid acquisition of a feature or part of a feature. A pixel may be detected as a continuous signal provided by a transient ablation plume.

### Opposite Side Ablation

As described above, radiation (e.g., laser radiation) may pass through a sample support to impinge on the sample. The radiation may be produced by a fs laser, such as a UV, IR or green laser. When the laser is a UV laser, the sample support may be quartz or silica. When the laser is IR or green, the sample support can be glass. A green fs laser may allow for a glass support (e.g., glass slide), which is preferable from a cost standpoint, while still enabling high resolution.

### High NA Objective and Opposite Side Ablation

In certain aspects, a sample chamber of the subject methods and systems may comprise high NA objective (e.g., lens).

When an immersion lens is used (for example, when an immersion lens is positioned on the opposite side of a slide from the sample), the sample may be an ultrathin sample, such as a tissue section having a thickness of 300 nm or less, 200 nm or less, 150 nm or less, 100 nm or less, 75 nm or less, 50 nm or less, or 30 nm or less in thickness. Such tissue sections (especially tissue sections of 100 nm or less in thickness) may be prepared in a similar or identical way as for electron microscopy. For example, a tissue may be embedded with a resin (e.g., epoxy, acrylic or polyester) prior to ultrathin sectioning.

A high NA objective may have an NA of 0.5 or greater, 0.7 or greater, 0.9 or greater, 1.0 or greater. 1.2 or greater, or 1.4 or greater. Of note, NA above 1.0 may be achieve with a medium such as oil or a solid transparent material that has a higher refractive index higher than air or vacuum (e.g., higher than 1.0). High NA optics may provide a spot size of 400 nm or less, 300 nm or less, 200 nm or less, 150 nm or less, or 100 nm or less.

In certain aspects, laser radiation focused by a high NA objective is 1 um or less in wavelength, such as in the green or UV range. The laser may be a fs laser, as described herein. For example, a fs laser in the near-IR range may be operated at the 2^{nd} harmonic to provide laser radiation in the green range, or at the 3^{rd} harmonic to provide laser radiation in the UV range. A lower wavelength such as a green or UV may allow for higher resolution (e.g., smaller spot size). When the laser radiation travels across a sample support to impinge on the sample, the sample support needs to be transparent to the laser radiation. Glass and silica are transparent to green wavelength, which silica slides but not glass are transparent to UV. To maximise the resolution while allowing for use of a glass slide, an IR fs laser may be operated at the 2^{nd} harmonic (e.g., around 50% conversion efficiency) to provide green laser radiation. Of note, commercially available objectives often have the best correction in the green range.

### Sample Chamber

The sample is placed in the sample chamber when it is subjected to laser ablation. The sample chamber comprises a stage, which holds the sample (typically the sample is on a sample carrier). When ablated, the material in the sample forms plumes, and the flow of gas passed through the sample chamber from a gas inlet to a gas outlet carries away the plumes of aerosolised material, including any labelling atoms that were at the ablated location. The gas carries the material to the ionisation system, which ionises the material to enable detection by the detector. The atoms, including the labelling atoms, in the sample can be distinguished by the detector and so their detection reveals the presence or absence of multiple targets in a plume and so a determination of what targets were present at the ablated locus on the sample. Accordingly, the sample chamber plays a dual role in hosting the solid sample that is analysed, but also in being the starting point of the transfer of aerosolised material to the ionisation and detection systems. This means that the gas flow through the chamber can affect how spread out the ablated plume of material becomes as it passes through the system. A measure of how spread out the ablated plume becomes is the washout time of the sample chamber. This figure is a measure of how long it takes material ablated from the sample to be carried out of the sample chamber by the gas flowing through it.

The spatial resolution of the signals generated from laser ablation (i.e. when ablation is used for imaging rather than exclusively for clearing, as discussed below) in this way depends on factors including: (i) the spot size of the laser, as signal is integrated over the total area which is ablated; and the speed with which plumes are generated versus the movement of the sample relative to the laser, and (ii) the speed at which a plume can be analysed, relative to the speed at which plumes are being generated, to avoid overlap of signal from consecutive plumes as mentioned above. Accordingly, being able to analyse a plume in the shortest time possible minimises the likelihood of plume overlap (and so in turn enables plumes to be generated more frequently), if individual analysis of plumes is desired.

Accordingly, a sample chamber with a short washout time (e.g. 100 ms or less) is advantageous for use with the system and methods disclosed herein. A sample chamber with a long washout time will either limit the speed at which an image can be generated or will lead to overlap between signals originating from consecutive sample spots (e.g. reference¹, which had signal duration of over 10 seconds). Therefore aerosol washout time is a key limiting factor for achieving high resolution without increasing total scan time. Sample chambers with washout times of ≤100 ms are known in the art. For example, reference² discloses a sample chamber with a washout time below 100 ms. A sample chamber was disclosed in reference³ (see also reference⁴) which has a washout time of 30 ms or less, thereby permitting a high ablation frequency (e.g. above 20 Hz) and thus rapid analysis. Another such sample chamber is disclosed in reference⁵. The sample chamber in reference 5 comprises a sample capture cell configured to be arranged operably proximate to the target, the sample capture cell including: a capture cavity having an opening formed in a surface of the capture cell, wherein the capture cavity is configured to receive, through the opening, target material ejected or generated from the laser ablation site and a guide wall exposed within the capture cavity and configured to direct a flow of the carrier gas within the capture cavity from an inlet to an outlet such that at least a portion of the target material received within the capture cavity is transferrable into the outlet as a sample. The volume of the capture cavity in the sample chamber of reference 5 is less than 1 cm³ and can be below 0.005 cm³. Sometimes the sample chamber has a washout time of 25 ms or less, such as 20 ms or less, 10 ms or less, 5 ms or less, 2 ms or less, 1 ms, [¹] Kindness et al. (2003) Clin Chem 49:1916-23.[²] Gurevich & Hergenröder (2007) J. Anal. At. Spectrom., 22:1043-1050.[³] Wang et al. (2013) Anal. Chem. 85:10107-16.[⁴] WO 2014/146724.[⁵] WO 2014/127034. less or 500 μs or less, 200 μs or less, 100 μs or less, 50 μs or less, or 25 μs or less. For example, the sample chamber may have a washout time of 10 μs or more. Typically, the sample chamber has a washout time of 5 ms or less.

For completeness, sometimes the plumes from the sample can be generated more frequently than the washout time of the sample chamber, and the resulting images will smear accordingly (e.g. if the highest possible resolution is not deemed necessary for the particular analysis being undertaken). Although this may not be desirable for high resolution imaging, as discussed herein, where a burst of pulses is directed at the sample (e.g. the pulses are all directed at a feature/region of interest, such as a cell), and the material in the resulting plumes detected as a continuous event, overlapping of the signals from specific plumes is not of such concern. Indeed, here, the plumes from each individual ablation event within the burst in effect form a single plume, which is then carried on for detection.

A sample chamber typically comprises a translation stage which holds the sample (and sample carrier) and moves the sample relative to a beam of laser radiation (in some embodiments of the present invention, both the sample stage and the laser beam may be moving at the same time, e.g. where the sample stage is moving at a constant speed and the laser scanning system is directing the laser on a matched sweep across the sample as it moves on the sample stage; e.g. the sample stage moves in the X-axis and the laser scanning system sweeps across in the Y-axis, with the principal vector of the movement by the laser scanning system is orthogonal to the direction of travel of the stage (accounting for any movement in the laser scanner to account for the movement of the stage)). When a mode of operation is used which requires the direction of laser radiation through the sample carrier to the sample, e.g. as in the LIFTing methods discussed herein, the stage holding the sample carrier should also be transparent to the laser radiation used.

Thus, the sample may be positioned on the side of the sample carrier (e.g., glass slide) facing the laser radiation as it is directed onto the sample, such that ablation plumes are released on, and captured from, the same side as that from which the laser radiation is directed onto the sample. Alternatively, the sample may be positioned on the side of the sample carrier opposite to the laser radiation as it is directed onto the sample (i.e. the laser radiation passes through the sample carrier before reaching the sample), and ablation plumes are released on, and captured from, the opposite side to the laser radiation.

The control of the movement of the sample stage in system according to aspects of the invention may be co-ordinated by the same control module that co-ordinates the movement of the laser scanner system, and optionally controls emission of pulses of laser radiation (e.g. the trigger controller for a pulse picker).

One feature of a sample chamber, which is of particular use where specific portions in various discrete areas of sample are ablated, is a wide range of movement in which the sample can be moved in the x and y (i.e. horizontal) axes in relation to the laser (where the laser beam is directed onto the sample in the z axis), with the x and y axes being perpendicular to one another. More reliable and accurate relative positions are achieved by moving the stage within the sample chamber and keeping the laser's position fixed in the laser ablation sampling system of the system. The greater the range of movement, the more distant the discrete ablated areas can be from one another. The sample is moved in relation to the laser by moving the stage on which the sample is placed. Accordingly, the sample stage can have a range of movement within the sample chamber of at least 10 mm in the x and y axes, such as 20 mm in the x and y axes, 30 mm in the x and y axes, 40 mm in the x and y axes, 50 mm in the x and y axes, such as 75 mm in the x and y axes. Sometimes, the range of movement is such that it permits the entire surface of a standard 25 mm by 75 mm microscope slide to be analysed within the chamber. Of course, to enable subcellular ablation to be achieved, in addition to a wide range of movement, the movement should be precise. Accordingly, the stage can be configured to move the sample in the x and y axes in increments of less than 10 μm, such as less than 5 μm, less than 4 μm, less than 3 μm, less than 2 μm, 1 μm, or less than 1 μm, less than 500 nm, less than 200 nm, less than 100 nm. For example, the stage may be configured to move the sample in increments of at least 50 nm. Precise stage movements can be in increments of about 1 μm, such as 1 μm±0.1 μm. Commercially available microscope stages can be used, for example as available from Thorlabs, Prior Scientific, and Applied Scientific Instrumentation. Alternatively, the motorised stage can be built from components, based on positioners providing the desired range of movement and suitably fine precision movement, such as the SLC-24 positioners from Smaract. The movement speed of the sample stage can also affect the speed of the analysis. Accordingly, the sample stage has an operating speed of greater than 1 mm/s, such as 10 mm/s, 50 mm/s or 100 mm/s.

Naturally, when a sample stage in a sample chamber has a wide range of movement, the sample must be sized appropriately to accommodate the movements of the stage. Sizing of the sample chamber is therefore dependent on size of the sample to be involved, which in turn determines the size of the mobile sample stage. Exemplary sizes of sample chamber have an internal chamber of 10×10 cm, 15×15 cm or 20×20 cm. The depth of the chamber may be 3 cm, 4 cm or 5 cm. The skilled person will be able to select appropriate dimensions following the teaching herein. The internal dimensions of the sample chamber for analysing biological samples using a laser ablation sampler must be bigger than the range of movement of the sample stage, for example at least 5 mm, such as at least 10 mm. This is because if the walls of the chamber are too close to the edge of the stage, the flow of the carrier gas passing through the chamber which takes the ablated plumes of material away from the sample and into the ionisation system can become turbulent. Turbulent flow disturbs the ablated plumes, and so instead of remaining as a tight cloud of ablated material, the plume of material begins to spread out after it has been ablated and carried away to the ionisation system of the system. A broader peak of the ablated material has negative effects on the data produced by the ionisation and detection systems because it leads to interference due to peak overlap, and so ultimately, less spatially resolved data, unless the rate of ablation is slowed down to such a rate that it is no longer experimentally of interest.

As noted above, the sample chamber comprises a gas inlet and a gas outlet that takes material to the ionisation system. However, it may contain further ports acting as inlets or outlets to direct the flow of gas in the chamber and/or provide a mix of gases to the chamber, as determined to be appropriate by the skilled artisan for the particular ablative process being undertaken.

### Transfer Conduit

In certain aspects, a transfer conduit (also referred to as an injector) forms a link between the laser ablation sampling system and the ionisation system, and allows the transportation of plumes of sample material, generated by the laser ablation of the sample, from the laser ablation sampling system to the ionisation system. Part (or all) of the transfer conduit may be formed, for example, by drilling through a suitable material to produce a lumen (e.g., a lumen with a circular, rectangular or other cross-section) for transit of the plume. The transfer conduit sometimes has an inner diameter in the range 0.2 mm to 3 mm. Sometimes, the internal diameter of the transfer conduit can be varied along its length. For example, the transfer conduit may be tapered at an end. A transfer conduit sometimes has a length in the range of 1 centimeter to 100 centimeters. Sometimes the length is no more than 10 centimeters (e.g., 1-10 centimeters), no more than 5 centimeters (e.g., 1-5 centimeters), or no more than 3 cm (e.g., 0.1-3 centimeters). Sometimes the transfer conduit lumen is straight along the entire distance, or nearly the entire distance, from the ablation system to the ionisation system. Other times the transfer conduit lumen is not straight for the entire distance and changes orientation. For example, the transfer conduit may make a gradual 90 degree turn. This configuration allows for the plume generated by ablation of a sample in the laser ablation sampling system to move in a vertical plane initially while the axis at the transfer conduit inlet will be pointing straight up, and move horizontally as it approaches the ionisation system (e.g. an ICP torch which is commonly oriented horizontally to take advantage of convectional cooling). The transfer conduit can be straight for a distance of least 0.1 centimeters, at least 0.5 centimeters or at least 1 centimeter from the inlet aperture though which the plume enters or is formed. In general terms, typically, the transfer conduit is adapted to minimize the time it takes to transfer material from the laser ablation sampling system to the ionisation system.

One or more gas flows may deliver an ablation plume to an ionisation system. For example, Helium, Argon, or a combination thereof may deliver ablation plumes to an ionisation system. In certain aspects, a separate gas flow may be provided to the sample chamber and the injector, which mix upon entrainment of the ablation plume in the injector. In certain cases, there in only one gas flow, such as when the injector inlet starts within the sample chamber.

At higher flows, the risk of turbulence occurring in the conduit increases. This is particularly the case where the transfer conduit has a small internal diameter (e.g. 1 mm). However, it is possible to achieve high speed transfer (up to and in excess of 300 m/s) in transfer conduits with a small internal diameter if a light gas, such as helium or hydrogen, is used instead of argon which is traditionally used as the transfer flow of gas.

High speed transfer presents problems insofar as it may cause the plumes of ablated sample material to be passed through the ionisation system without an acceptable level of ionisation occurring. The level of ionisation can drop because the increased flow of cool gas reduces the temperature of the plasma at the end of the torch. If a plume of sample material is not ionised to a suitable level, information is lost from the ablated sample material—because its components (including any labelling atoms/elemental tags) cannot be detected by the mass spectrometer. For example, the sample may pass so quickly through the plasma at the end of the torch in an ICP ionisation system that the plasma ions do not have sufficient time to act on the sample material to ionise it. This problem, caused by high flow, high speed transfer in narrow internal diameter transfer conduits can be solved by the introduction of a flow sacrificing system at the outlet of the transfer conduit. The flow sacrificing system is adapted to receive the flow of gas from the transfer conduit, and pass only a portion of that flow (the central portion of the flow comprising any plumes of ablated sample material) onwards into the injector that leads to the ionisation system. To facilitate dispersion of gas from the transfer conduit in the flow sacrificing system, the transfer conduit outlet can be flared out.

### Ionisation System

In order to generate elemental ions, it is necessary to use a hard ionisation technique that is capable of vaporising, atomising and ionising the atomised sample.

### Inductively Coupled Plasma Torch

Commonly, an inductively coupled plasma is used to ionise the material to be analysed before it is passed to the mass detector for analysis. It is a plasma source in which the energy is supplied by electric currents produced by electromagnetic induction. The inductively coupled plasma is sustained in a torch that may consist of a plurality of (e.g., three) concentric tubes, the innermost tube being known as the injector.

The injector may be coupled to the sample chamber described herein. The injector may comprise an inlet or aperture situated above a sample support, such that material released from a sample by laser ablation may be carried into the injector. The sample chamber may include one or more gas inlets for carrying an ablation plume into the injector, and the injector may include a transfer gas inlet (e.g., sheath gas inlet) for transporting an ablation plume captured in the injector to the ICP torch. In certain aspects, the system may include a single gas source.

An injector to the ICP may have an inlet in the sample chamber. For example, when the injector is positioned on the same side of the sample (or sample support) as the laser radiation, the injector may include a window through which laser radiation passes, and an aperture through which laser radiation passes and through which a resulting laser ablation plume is captured by the injector for delivery to the ICP torch. Alternatively, the injector may extend through a lens, window, or other optics for laser ablation. In another example, the laser radiation may be oriented opposite the sample (or sample chamber) from the injector, and may pass through the sample support. When laser radiation passes through the sample support to impinge on the sample, the injector may comprise an inlet proximal to the site of laser ablation, opposite the side of laser radiation. In certain aspects, the inlet or aperture of the injector may be in the form of a sample cone (e.g., with a narrow end oriented toward the site of laser ablation).

Aspects of the fluidics and/or optics may be configured to allow for a short and/or straight path from an injector aperture or inlet to an ICP-MS system. For example, some or all of the optics may be oriented opposite a sample support from the injector. Alternatively or in addition, an injector may pass through optical elements, such as one or more lenses and/or mirrors.

The induction coil that provides the electromagnetic energy that maintains the plasma is located around the output end of the torch. The alternating electromagnetic field reverses polarity many millions of times per second. Argon gas is supplied between the two outermost concentric tubes. Free electrons are introduced through an electrical discharge and are then accelerated in the alternating electromagnetic field whereupon they collide with the argon atoms and ionise them. At steady state, the plasma consists of mostly of argon atoms with a small fraction of free electrons and argon ions.

The ICP can be retained in the torch because the flow of gas between the two outermost tubes keeps the plasma away from the walls of the torch. A second flow of argon introduced between the injector (the central tube) and the intermediate tube keeps the plasma clear of the injector. A third flow of gas is introduced into the injector in the centre of the torch. Samples to be analysed are introduced through the injector into the plasma.

### Electron Ionisation

Electron ionisation involves bombarding a gas-phase sample with a beam of electrons. An electron ionisation chamber includes a source of electrons and an electron trap. A typical source of the beam of electrons is a rhenium or tungsten wire, usually operated at 70 electron volts energy. Electron beam sources for electron ionisation are available from Markes International. The beam of electrons is directed towards the electron trap, and a magnetic field applied parallel to the direction of the electrons travel causes the electrons to travel in a helical path. The gas-phase sample is directed through the electron ionisation chamber and interacts with the beam of electrons to form ions. Electron ionisation is considered a hard method of ionisation since the process typically causes the sample molecules to fragment. Examples of commercially available electron ionisation systems include the Advanced Markus Electron Ionisation Chamber.

### Alternative Radiation Sources

### Source of Charged Particles

In certain aspects a source of charged particles is used to pass a beam of charged particles to a location on the sample. In certain aspects, such sampling may at or near vacuum, and resultant ions may be passed directly to ion optics without a vacuum interface.

### Ion Beam:

Ions can be any suitable ion for generating sputtering from the sample to be analysed. Examples of primary ion sources are: the Duoplasmatron which generates oxygen (¹⁶O⁻, ¹⁶O₂⁺, ¹⁶O₂⁻), argon (⁴⁰Ar⁺), xenon (Xe⁺), SF₅⁺, or C₆₀⁺ primary ions; a surface ionisation source which generates ¹³³Cs⁺ primary ions; and liquid metal ion guns (LMIG) which generate Ga⁺ primary ions. Other primary ions include cluster ions such as Auₙ⁺ (n=1-5), Biₙ^{q+} (n=1-7, q=1 and 12), C₆₀^{q+} probes (q=1-3) and large Ar clusters (Muramoto, Brison, & Castner, 2012).

The choice of ion source depends on the type of ion bombardment being deployed (i.e. static or dynamic) and the sample to be analysed. Static involves using a low primary ion beam current (1 nA/cm²), usually a pulsed ion beam. Because of the low current, each ion strikes a new section of the sample surface, removing only a monolayer of particles (2 nm). Hence, static is suitable for imaging and surface analysis (Gamble & Anderton, 2016). Dynamic involves using a high primary ion beam current (10 mA/cm²), usually a continuous primary ion beam, which results in the fast removal of surface particles. As a result, is possible to use dynamic for depth profiling. Furthermore, since more material is removed from the sample surface, dynamic SIMS gives a better detection limit than static. Dynamic typically produces high image resolution (less than 100 nm) (Vickerman & Briggs, 2013).

In certain aspects, the ion beam may have an energy at or between 10 pj, 100 pj, 500 pj, 1 nJ, 10 nJ, 50 nj, 100 nJ, 500 nJ, 1 uJ, 5 uJ, 10 uJ, 20 uJ, 50 uJ, 100 uJ, and 500 uJ. The energy of the ion beam may allow for efficient heat transfer at the sample spot.

Oxygen primary ions enhance ionisation of electropositive elements (Malherbe, Penen, Isaure, & Frank, 2016) and are used in the commercially available Cameca IMS 1280-HR, whereas caesium primary ions are used to investigate electronegative elements (Kiss, 2012) and are used in the commercially available Cameca NanoSIMS 50.

For rapid analysis of a sample a high frequency of sputtering is needed, for example more than 200 Hz (i.e. more than 200 packets of ions directed at the sample per second). Commonly, the frequency of primary ion pulse generation by the primary ion source is at least 400 Hz, such as at least 500 Hz, or at least 1 kHz. For instance, the frequency of ion pulses in some embodiments is at least 10 kHz, at least 100 kHz, at least 1 MHz, or at least 10 MHz. For instance, the frequency of ion pulses is within the range 400-100 MHz, within the range 1 kHz-100 MHz, within the range 10 kHz-100 MHz, within the range 100 kHz-100 MHz or within the range 1 MHz-100 MHz.

Accordingly, the present invention provides an apparatus wherein the source of charged particles is an ion beam.

### Electron Beam

Electron beam radiation involves bombarding a gas-phase sample with a beam of electrons. An electron ionisation chamber includes a source of electrons and an electron trap. A typical source of the beam of electrons is a rhenium or tungsten wire, usually operated at 70 electron volts energy. The beam of electrons is directed towards the electron trap, and a magnetic field applied parallel to the direction of the electrons travel causes the electrons to travel in a helical path. The gas-phase sample is directed through the electron ionisation chamber and interacts with the beam of electrons to form ions.

In certain aspects, the ion beam is an electron beam. Electron beams with the energy of 1 kV to 100 kV may be particularly suitable to interrogate a specimen with a thickness at or less than 100 nm, 50 nm, or 30 nm.

A high intensity pulsed electron beam is used to cause ablation/sputtering. When the pulse of the electron current is insufficient for ablation, its effect can be used just as an ignition event as described above, followed by energy pumping by the laser pulse set at the brightness level below the level of ablation of native material but above the level of energy pumping required for ablation of an already activated material.

For rapid analysis of a sample a high frequency of sputtering is needed, for example more than 200 Hz (i.e. more than 200 packets of electrons directed at the sample per second). Commonly, the frequency of electron pulse generation by the electron source is at least 400 Hz, such as at least 500 Hz, or at least 1 kHz. For instance, the frequency of electron pulses in some embodiments is at least 10 kHz, at least 100 kHz, at least 1 MHz, or at least 10 MHz. For instance, the frequency of electron pulses is within the range 400-100 MHz, within the range 1 kHz-100 MHz, within the range 10 kHz-100 MHz, within the range 100 kHz-100 MHz or within the range 1 MHz-100 MHz.

An advantage of utilising an electron beam for the source of charged particles is that the whole instrument can be built on a platform containing an electron microscope. Accordingly, the present invention provides an apparatus further comprising an electron microscope. Accordingly, the present invention provides an apparatus wherein the source of charged particles is an electron beam wherein the electron beam is an electron source in the electron microscope.

### Ion Optics

An imaging mass cytometer may include ion optics for improving detection of labelling atoms. Ion optics may include mass filters and/or ion focusing optics. For example, a high pass filter, such as an RF quadrupole, may only pass ions above a certain mass threshold, such as above 80 or more amu so as to remove Argon dimer ions produced in the plasma.

### Detector

### Quadrupole Detector

Quadrupole mass analysers comprise four parallel rods with a detector at one end. An alternating RF potential and fixed DC offset potential is applied between one pair of rods and the other so that one pair of rods (each of the rods opposite each other) has an opposite alternative potential to the other pair of rods. The ionised sample is passed through the middle of the rods, in a direction parallel to the rods and towards the detector. The applied potentials affect the trajectory of the ions such that only ions of a certain mass-charge ratio will have a stable trajectory and so reach the detector. Ions of other mass-charge ratios will collide with the rods.

### Magnetic Sector Detector

In magnetic sector mass spectrometry, the ionised sample is passed through a curved flight tube towards an ion detector. A magnetic field applied across the flight tube causes the ions to deflect from their path. The amount of deflection of each ion is based on the mass to charge ratio of each ion and so only some of the ions will collide with the detector—the other ions will be deflected away from the detector. In multicollector sector field instruments, an array of detectors is be used to detect ions of different masses. In some instruments, such as the ThermoScientific Neptune Plus, and Nu Plasma II, the magnetic sector is combined with an electrostatic sector to provide a double-focussing magnetic sector instrument that analyses ions by kinetic energy, in addition to mass to charge ratio. In particular those multidetectors having a Mattauch-Herzog geometry can be used (e.g. the SPECTRO MS, which can simultaneously record all elements from lithium to uranium in a single measurement using a semiconductor direct charge detector). These instruments can measure multiple m/Q signals substantially simultaneously. Their sensitivity can be increased by including electron multipliers in the detectors. Array sector instruments are always applicable, however, because, although they are useful for detecting increasing signals, they are less useful when signal levels are decreasing, and so they are not well suited in situations where labels are present at particularly highly variable concentrations.

### Time of Flight (TOF) Detector

A time of flight mass spectrometer comprises a sample inlet, an acceleration chamber with a strong electric field applied across it, and an ion detector. A packet of ionised sample molecules is introduced through the sample inlet and into the acceleration chamber. Initially, each of the ionised sample molecules has the same kinetic energy but as the ionised sample molecules are accelerated through the acceleration chamber, they are separated by their masses, with the lighter ionised sample molecules travelling faster than heaver ions. The detector then detects all the ions as they arrive. The time taking for each particle to reach the detector depends on the mass to charge ratio of the particle.

Thus a TOF detector can quasi-simultaneously register multiple masses in a single sample. In theory TOF techniques are not ideally suited to ICP ion sources because of their space charge characteristics, but TOF instruments can in fact analyse an ICP ion aerosol rapidly enough and sensitively enough to permit feasible single-cell imaging. Whereas TOF mass analyzers are normally unpopular for atomic analysis because of the compromises required to deal with the effects of space charge in the TOF accelerator and flight tube, tissue imaging according to the subject disclosure can be effective by detecting only the labelling atoms, and so other atoms (e.g. those having an atomic mass below 100) can be removed. This results in a less dense ion beam, enriched in the masses in (for example) the 100-250 dalton region, which can be manipulated and focused more efficiently, thereby facilitating TOF detection and taking advantage of the high spectral scan rate of TOF. Thus rapid imaging can be achieved by combining TOF detection with choosing labelling atoms that are uncommon in the sample and ideally having masses above the masses seen in an unlabelled sample e.g. by using the higher mass transition elements. Using a narrower window of label masses thus means that TOF detection to be used for efficient imaging.

Suitable TOF instruments are available from Tofwerk, GBC Scientific Equipment (e.g. the Optimass 9500 ICP-TOFMS), and Fluidigm Canada (e.g. the CyTOF™ and CyTOF™2 instruments). These CyTOF™ instruments have greater sensitivity than the Tofwerk and GBC instruments and are known for use in mass cytometry because they can rapidly and sensitively detect ions in the mass range of rare earth metals such as lanthanides (particularly in the m/Q range of 100-200) [⁶]. A mass cytometer of the subject application may preferentially detect ions in such a mass range. For example, an system of the subject application may be configured to selectively detect the presence of a plurality of mass tags, such as lanthanide isotopes of the mass tags. [⁶] Bandura et al. (2009) Anal. Chem., 81:6813-22.

Thus these are preferred instruments for use with the disclosure, and they can be used for imaging with the instrument settings already known in the art e.g. references ⁷ & ⁸. Their mass analysers can detect a large number of markers quasi-simultaneously at a high mass-spectrum acquisition frequency on the timescale of high-frequency laser ablation or sample desorption. They can measure the abundance of labelling atoms with a detection limit of about 100 per cell, permitting sensitive construction of an image of the tissue sample. Because of these features, mass cytometry can now be used to meet the sensitivity and multiplexing needs for tissue imaging at subcellular resolution. By combining the mass cytometry instrument with a high-resolution laser ablation sampling system and a rapid-transit low-dispersion sample chamber it has been possible to permit construction of an image of the tissue sample with high multiplexing on a practical timescale. [⁷] Bendall et al. (2011) Science 332,687-696.[⁸] Bodenmiller et al. (2012) Nat. Biotechnol. 30:858-867.

The TOF may be coupled with a mass-assignment corrector. The vast majority of ionisation events generate M⁺ ions, where a single electron has been knocked out of the atom. Because of the mode of operation of the TOF MS there is sometimes some bleeding (or cross-talk) of the ions of one mass (M) into the channels for neighbouring masses (M±1), in particular where a large number of ions of mass M are entering the detector (i.e. ion counts which are high, but not so high that an ion deflector positioned between the sampling ionisation system and MS would prevent them from entering the MS, if the system were to comprise such an ion deflector). As the arrival time of each M⁺ ion at the detector follows a probability distribution about a mean (which is known for each M), when the number of ions at mass M⁺ is high, then some will arrive at times that would normally be associated with the M−1⁺ or M+1⁺ ions. However, as each ion has a known distribution curve upon entering the TOF MS, based on the peak in the mass M channel it is possible to determine, the overlap of ions of mass M into the M±1 channels (by comparison to the known peak shape). The calculation is particularly applicable for TOF MS, because the peak of ions detected in a TOF MS is asymmetrical. Accordingly it is therefore possible to correct the readings for the M−1, M and M+1 channels to appropriately assign all of the detected ions to the M channel. Such corrections have particular use in correcting imaging data due to the nature of the large packets of ions produced by sampling and ionisation systems such as those disclosed herein involving laser ablation (or desorption as discussed below) as the techniques for removing material from the sample. Programs and methods for improving the quality of data by de-convoluting the data from TOF MS are discussed in references ⁹, ¹⁰ and ¹¹. [⁹] WO2011/098834[¹⁰] U.S. Pat. No. 8,723,108.[¹¹] WO2014/091243

### Constructing an Image

The system may provide signals for multiple atoms in packets of ionised sample material removed from the sample. Detection of an atom in a packet of sample material reveals its presence at the position of ablation, be that because the atom is naturally present in the sample or because the atom has been localised to that location by a labelling reagent. By generating a series of packets of ionised sample material from known spatial locations on the sample's surface the detector signals reveal the location of the atoms on the sample, and so the signals can be used to construct an image of the sample. By labelling multiple targets with distinguishable labels it is possible to associate the location of labelling atoms with the location of cognate targets, so the method can build complex images, reaching levels of multiplexing which far exceed those achievable using traditional techniques such as fluorescence microscopy.

Assembly of signals into an image will use a computer and can be achieved using known techniques and software packages. For instance, the GRAPHIS package from Kylebank Software may be used, or other packages such as TERAPLOT can also be used. Imaging using MS data from techniques such as MALDI-MSI is known in the art e.g. reference ¹² discloses the ‘MSiReader’ interface to view and analyze MS imaging files on a Matlab platform, and reference ¹³ discloses two software instruments for rapid data exploration and visualization of both 2D and 3D MSI data sets in full spatial and spectral resolution e.g. the ‘Datacube Explorer’ program. [¹²] Robichaud et al. (2013) J Am Soc Mass Spectrom 24(5):718-21.[¹³] Klinkert et al. (2014) Int J Mass Spectrom http://dx.doi.org/10.1016/j.ijms.2013.12.012

Images obtained using the methods disclosed herein can be further analysed e.g. in the same way that IHC results are analysed. For instance, the images can be used for delineating cell sub-populations within a sample, and can provide information useful for clinical diagnosis. Similarly, SPADE analysis can be used to extract a cellular hierarchy from the high-dimensional cytometry data which methods of the disclosure provide [¹⁴]. In certain aspects, cell types (e.g., identified through SPADE analysis) may be colorized to allow for a plurality of cell types (at least some of which are characterized by a combination of markers) to be visualized simultaneously. [¹⁴] Qiu et al. (2011) Nat. Biotechnol. 29:886-91.

Alternatively or in addition, serial sections may be imaged by imaging mass cytometry and stacked to provide a 3D image of the sample. Abundance of tagging atoms may be integrated across features or a region of interest (ROI) in 2 or 3 dimensions, such as across a cell, cluster of cells, micrometastises, tumor or tissue subregion, and so forth. In certain aspects, laser scanning may be performed to rapidly analyse such a feature or ROI on one or more tissue sections. Such integration of signal may simplify analysis and/or improve sensitivity.

### Multiple Imaging Modalities

Multiple imaging modalities may be used to image one or more tissue sections. In some cases, sections from the same tissue may each be imaged by a different modality that is then co-registered (e.g., mapped to the same coordinate system, stacked, superimposed, and/or combined to identify higher level features). In addition, one or more imaging modalities may be used to identify region(s) of interest in a sample for subsequent analysis as described herein.

Aspects of the invention include a method of coregistering images, including obtaining a first image from a first tissue section of a tissue sample by an imaging modality other than imaging mass cytometry, obtaining a second image of a second tissue section of the tissue sample by imaging mass cytometry, and coregistering the first and second images. In certain aspects, the first image, or both the first and second images, may be provided by a third party.

In some cases, an imaging mass cytometer may be equipped to image in additional modalities, including but not limited to light microscopy, such as brightfield, fluorescence, and/or nonlinear microscopy. For example, the imaging mass cytometer may stack optics for laser ablation and light microscopy. A histochemical stain may be imaged by light microscopy to identify a region of interest (ROI) for analysis by imaging mass cytometry. Alternatively or in addition, light microscopy may be used to coregister an image obtained by imaging mass cytometry from a first tissue section with an image obtained from a second tissue section (e.g., serial section) by another modality (e.g, by another system) as described herein. When a high speed (e.g., femtosecond) laser is used, nonlinear microscopy may be performed at one or more harmonics, thereby imaging structural aspects of the sample. When an antibody is tagged with both labelling atom(s) and fluorophore label, analysis of the distribution of the fluorophore label may be non-destructive to the sample, and may be followed by IMC analysis of the labeling atom(s). In certain aspects, the fluorophore label may be a fluorescent barcode cleaved (e.g., photocleaved) from a region of interest and analysed after aspiration.

In some cases, and additional imaging modality may be electron microscopy, such as scanning electron microscopy or transmission electron microscopy. At a general level, an electron microscope comprises an electron gun (e.g. with a tungsten filament cathode), and electrostatic/electromagnetic lenses and apertures that control the beam to direct it onto a sample in a sample chamber. The sample is held under vacuum, so that gas molecules cannot impede or diffract electrons on their way from the electron gun to the sample. In transmission electron microscopy (TEM), the electrons pass through the sample, whereupon they are deflected. The deflected electrons are then detected by a detector such as a fluorescent screen, or in some instances a high-resolution phosphor coupled to a CCD. Between the sample and the detector is an objective lens which controls the magnification of the deflected electrons on the detector.

TEM requires ultrathin sections to enable sufficient electrons to pass through the sample such that an image may be reconstructed from the deflected electrons that hit the detector. Typically, TEM samples are 100 nm or thinner, as prepared by use of an ultramicrotome. Biological tissue specimens are chemically fixed, dehydrated and embedded in a polymer resin to stabilize them sufficiently to allow the ultrathin sectioning. Sections of biological specimens, organic polymers and similar materials may require staining with heavy atom labels in order to achieve the required image contrast, as unstained biological samples in their native unstained state rarely interact strongly with electrons, so as to deflect them to allow electron microscopy images to be recorded.

As noted above, when thin sections are used, it is possible to perform electron microscopy on a sample also analysed by IMS or IMC. Accordingly, high resolution structural images can be obtained by electron microscopy, for example transmission electron microscopy, and then this high resolution image used to refine the resolution of image data obtained by IMS or IMC to a resolution beyond that achievable with ablation using laser radiation (due to the much shorter wavelength of electrons compared to photons). In some instances, both electron microscopy and elemental analysis by IMC or IMS are performed on the sample in a single system (as IMC/IMS are destructive processes, electron microscopy is performed prior to IMC/IMS).

One or more tissue sections may be analysed by imaging mass cytometry and one or more additional imaging modalities, and co-registered based on fiducials (such as a coordinate system) present on slide(s) holding the tissue section(s). Alternatively or in addition, co-registration can be performed by aligning features (e.g., structures or patterns) present on two sections from the same tissue. The features may be identified by the same or different imaging modalities. Even when identified by the same imaging modality, the features or their x,y coordinates may be used to coregister different imaging modalities.

In certain aspects, an additional imaging modality is MALDI mass spectrometry imaging. The sample preparation of a tissue section for MALDI imaging may be incompatible with preparation for imaging mass cytometry. As such, MALDI imaging of a first section may be co-registered with imaging mass cytometry of a second section (e.g, serial section) from the same tissue. Laser desorption ionization in MALDI imaging provides a molecular ions that are detected by mass spectrometry. A MALDI image of a sample may identify distribution of an analyte (e.g, a drug, such as a cancer drug, potential cancer drug, or metabolite thereof) in a tissue section or subregion thereof comprising a tumor and/or healthy tissue. When the analyte is a drug, it may be administered to a subject (e.g., human patient or animal model) from which a tissue sample is collected for analysis as described herein. An otherwise identical analyte may be isotopically labelled, such as with a non naturally abundant isotope (e.g., of H, C, or N) and applied to the tissue along with the matrix to identify and expected peak in the mass spectrum relating to the original analyte. Alternatively or in addition to imaging distribution of an analyte, the MALDI image may provide a distribution of endogenous biomolecules (or molecular ions thereof). MALDI imaging may be coregistered with an IMC image through a shared or similar histochemical stain (such as cresyl violet, Ponceau S, bromophenol blue, Ruthenium Red, Trichrome stain, osmium tetroxide, and so forth). In certain aspects, labelling atoms of a sample analysed by MALDI imaging may survive the procedure, allowing for analysis of IMC. However, MALDI sample prep may complicate sample prep for IMC imaging, in which case the MALDI and IMC images may be obtained from different tissue sections.

Co-registration of a MALDI image with a mass cytometry image may provide additional insight into the portion of the tissue retaining the drug and/or the effect of the drug on the tissue. For example, metal containing histochemical stains, viability reagents and/or cell state indicators may identify whether or not a drug is targeted to at least one of connective tissue (e.g, stroma, extracellular matrix or macromolecules such as collagen or glycoproteins, fibrous proteins such as actin, keratin, tubuluin), cells or a subregion of a cell (e.g., cell membrane, cytoplasm and/or nucleus), proliferating cells, live or dead cells, hypoxic cells or regions, necrotic regions, tumor cells or regions having a tumor signature (e.g., combination of surface markers and/or cell state markers characteristic of a tumor), and/or healthy tissue. In some cases, the effect of a drug can be inferred by the combination of the drug distribution (e.g., identified by MALDI imaging) and state of the tissue at or around the drug (e.g., identified by imaging mass cytometry). For example, the number, position, cell activity surface markers, intracellular signalling markers, cell type markers of tumor cells or tumor infiltrating immune cells may be used to identify the effect of the drug and/or identify additional drug targets (such as a receptor up or down regulated in a tumor cell or tumor infiltrating immune cell in response to the drug). Tumor infiltrating immune cells may include one or more of dendritic cells, lymphocytes (such as B cells, T cells and/or NK cells), or subsets of immune cells such as CD4+, CD8+, and/or CD4+CD25+ T cells. In some cases, imaging mass cytometry may identify a plurality of immune cell types in a tumor microenvironement, and may further identify cell state (e.g., intracellular signalling and/or expression of receptors involved in activation or suppression of an immune response). An area of drug distribution imaged by MALDI may identify a ROI for imaging mass cytometry analysis and/or be co-registered with a mass cytometry image.

In certain aspects, coregistering a IMC image with a non-IMC image provides distribution of a plurality (e.g. at least 5 10, 20, or 30) different targets (e.g., or their associated labelling atoms) at cellular or subcellular resolution. The IMC image may be obtained through LA-ICP-MS, and optionally through use of a femtosecond laser and/or laser scanning system as described herein.

Coregistration may include mapping (e.g., aligning) two images (obtained by different imaging modalities) to one another (e.g., to a shared coordinate system). Two coregistered images (or aspects of each image) may be superimposed or combined to present higher level features such as coexpresison of two targets detected by two different imaging modalities. In certain aspects, coregistration may only be at a region of interest.

### Optical Microscope

An optical microscope may allow identification of a region of interest of the sample, e.g., for further analysis by imaging mass cytometry. The optical microscope may also allow for additional imaging modalities to be coregistered with imaging mass cytometry. An optical microscope may have various components and capabilities described below. An optical microscope may include be capable of brightfield microscopy and/or a fluorescence microscopy. An optical microscope may be integrated with an imaging mass cytometer, or may be operatively coupled to an imaging mass cytometer through an automated slide handler.

### Camera

The inclusion of a camera (such as a charged coupled device image sensor based (CCD) camera or an active pixel sensor based camera), or any other light detecting means in a laser ablation sampling system enables various further analyses and techniques. A CCD is a means for detecting light and converting it into digital information that can be used to generate an image. In a CCD image sensor, there are a series of capacitors that detect light, and each capacitor represents a pixel on the determined image. These capacitors allow the conversion of incoming photons into electrical charges. The CCD is then used to read out these charges, and the recorded charges can be converted into an image. An active-pixel sensor (APS) is an image sensor consisting of an integrated circuit containing an array of pixel sensors, each pixel containing a photodetector and an active amplifier, e.g. a CMOS sensor.

A camera can be incorporated into any laser ablation sampling system discussed herein. The camera can be used to scan the sample to identify cells of particular interest or regions of particular interest (for example cells of a particular morphology), or for fluorescent probes specific for an antigen, or an intracellular or structure. In certain embodiments, the fluorescent probes are histochemical stains or antibodies that also comprise a detectable metal tag. Once such cells have been identified, then laser pulses can be directed at these particular cells to ablate material for analysis, for example in an automated (where the system both identifies and ablates the feature(s)/regions(s), such as cell(s), of interest) or semi-automated process (where the user of the system, for example a clinical pathologist, identifies the features/region(s) of interest, which the system then ablates in an automated fashion). This enables a significant increase in the speed at which analyses can be conducted, because instead of needing to ablate the entire sample to analyse particular cells, the cells of interest can be specifically ablated. This leads to efficiencies in methods of analysing biological samples in terms of the time taken to perform the ablation, but in particular in the time taken to interpret the data from the ablation, in terms of constructing images from it. Constructing images from the data is one of the more time-consuming parts of the imaging procedure, and therefore by minimising the data collected to the data from relevant parts of the sample, the overall speed of analysis is increased.

The camera may record the image from a optical microscope, such as a brightfield microscope or a fluorescence microscope.

When a laser is used to excite fluorophores for fluorescence microscopy, in some embodiments this laser is the same laser that generates the laser radiation used to ablate material from the biological sample (and for LIFTing (desorption)), but used at a fluence that is not sufficient to cause ablation or desorption of material from the sample. In some embodiments, the fluorophores are excited by a wavelength of laser radiation that is used for sample ablation or desorption. In others, a different wavelength may be used, for example by exploiting different harmonics of the laser to obtain laser radiation of different wavelengths. The laser radiation that excites the fluorophores may be provided by a different laser source from the ablation and/or lifting laser source(s).

By using an image sensor (such as a CCD detector or an active pixel sensor, e.g. a CMOS sensor), it is possible to entirely automate the process of identifying features/regions of interest and then ablating them, by using a control module (such as a computer or a programmed chip) which correlates the location of the fluorescence with the x,y coordinates of the sample and then directs the ablation laser radiation to the area surrounding that location before the cell at the location is lifted. As part of this process, in some embodiments, the first image taken by the image sensor has a low objective lens magnification (low numerical aperture), which permits a large area of the sample to be surveyed. Following this, a switch to an objective with a higher magnification can be used to home in on the particular features of interest that have been determined to be of interest, e.g. fluoresce if the sample has been stained by fluorescent labelling reagents, by higher magnification optical imaging. These features recorded to be of interest, e.g. to fluoresce, may then be ablated/desorbed. Using a lower numerical aperture lens first has the further advantage that the depth of field is increased, thus meaning features buried within the sample may be detected with greater sensitivity than screening with a higher numerical aperture lens from the outset.

The analysis that identifies the features/regions of interest can be conducted by the system of aspects of the invention, or can be conducted outside of the system. For instance, the slide may be analysed remote from the system of aspects of the invention by a physician or histologist, and the positional information of where on the slide should be ablated can be fed back to the system.

For example, an embodiment of aspects of the invention may include identifying the location of a region of interest, such as a cell, and directing a burst of laser pulses to sample all or part of the cell. As described herein, the burst of laser pulses is directed by a laser scanning system at multiple known locations within the feature of interest, and the resulting plumes from the burst of laser pulses can be detected as a single event.

In some instances, the positional information may be in the form of absolute measurements as to the position of the feature of interest on the sample carrier. In other instances, the locational information of the feature of interest may be recorded in a relative manner. For instance, a visual image of the sample may be recorded following illumination with UV light on which a number of features fluoresce. The position of the features of interest may be recorded as positional information relative to the pattern of fluorescing features. Use of relative positional information to identify the locations that are to be ablated accordingly reduces errors resulting from imprecise positioning of the sample in the system. Methods for calculating the location of the features of interest with respect to such a reference pattern are standard for one of skill in the art, for example by using a barycentric coordinate system.

In some instances, the feature of interest, e.g. a cell in a biological sample, may be surrounded by other biological material, for instance intracellular matrix or other cells which could impinge upon the ablation of the cell of interest. Here, ablation using the laser scanner system may be used to clear material surrounding the cell of interest, thereby allowing burst of laser pulses to ablate the cell of interest either as a continuous event or at a subcellular resolution. Sometimes, no data are recorded from the ablation performed to clear the area around the feature of interest (e.g. the cell of interest). Sometimes, data is recorded from the ablation of the surrounding area. Useful information that can be obtained from the surrounding area includes what target molecules, such as proteins and RNA transcripts, are present in the surrounding cells and intercellular milieu. This may be of particular interest when imaging solid tissue samples, where direct cell-cell interactions are common, and what proteins etc. are expressed in the surrounding cells may be informative on the state of the cell of interest.

Accordingly, in some embodiments disclosed herein, the method comprises using the locational information of the feature of interest to ablate a cell, comprising first performing laser ablation to remove sample material surrounding the feature of interest, before the cell of interest is ablated. In some embodiments, the features are identified by inspection of an optical image of the sample, optionally wherein the sample has been labelled with fluorescent labels and the sample is illuminated under such conditions that the fluorescent labels fluoresce.

### Confocal Microscopy

An imaging system of the subject application may be capable of confocal microscopy.

Confocal microscopy is a form of optical microscopy that offers a number of advantages, including the ability to reduce interference from background information (light) away from the focal plane. This happens by elimination of out-of-focus light or glare. Confocal microscopy can be used to assess unstained samples for the morphology of the cells, or whether a cell is a discrete cell or part of a clump of cells. Often, the sample is specifically labelled with fluorescent markers (such as by labelled antibodies or by labelled nucleic acids). These fluorescent makers can be used to stain specific cell populations (e.g. expressing certain genes and/or proteins) or specific morphological features on cells (such as the nucleus, or mitochondria) and when illuminated with an appropriate wavelength of light, these regions of the sample are specifically identifiable. Some systems described herein therefore can comprise a laser for exciting fluorophores in the labels used to label the sample. Alternatively, an LED light source can be used for exciting the fluorophores. Non-confocal (e.g. wide field) fluorescent microscopy can also be used to identify certain regions of the biological sample, but with lower resolution than confocal microscopy.

As an example technique combining fluorescence and laser ablation, it is possible to label the nuclei of cells in the biological sample with an antibody or nucleic acid conjugated to a fluorescent moiety. Accordingly, by exciting the fluorescent label and then observing and recording the positions of the fluorescence using a camera, it is possible to direct the ablating laser specifically to the nuclei, or to areas not including nuclear material. The division of the sample into nuclei and cytoplasmic regions will find particular application in field of cytochemistry. By using an image sensor (such as a CCD detector or an active pixel sensor, e.g. a CMOS sensor), it is possible to entirely automate the process of identifying features/regions of interest and then ablating them, by using a control module (such as a computer or a programmed chip) which correlates the location of the fluorescence with the x,y coordinates of the sample and then directs the ablation laser to that location. As part of this process the first image taken by the image sensor may have a low objective lens magnification (low numerical aperture), which permits a large area of the sample to be surveyed. Following this, a switch to an objective with a higher magnification can be used to home in on the particular features of interest that have been determined to fluoresce by higher magnification optical imaging. These features recorded to fluoresce may then be ablated by a laser. Using a lower numerical aperture lens first has the further advantage that the depth of field is increased, thus meaning features buried within the sample may be detected with greater sensitivity than screening with a higher numerical aperture lens from the outset.

In methods and systems in which fluorescent imaging is used, the emission path of fluorescent light from the sample to the camera may include one or more lenses and/or one or more optical filters. By including an optical filter adapted to pass a selected spectral bandwidth from one or more of the fluorescent labels, the system is adapted to handle chromatic aberrations associated with emissions from the fluorescent labels. Chromatic aberrations are the result of the failure of lenses to focus light of different wavelengths to the same focal point. Accordingly, by including an optical filter, the background in the optical system is reduced, and the resulting optical image is of higher resolution.

A higher resolution optical image is advantageous in this coupling of optical techniques and laser ablation sampling, because the accuracy of the optical image then determines the precision with which the ablating laser can be directed to ablate the sample.

Accordingly, in some embodiments disclosed herein, the system of aspects of the invention comprises a camera. This camera can be used on-line to identify features/areas of the sample, e.g. specific cells, which can then be ablated (or desorbed by LIFTing—see below), such as by firing a burst of pulses at the feature/region of interest to ablate or desorb a slug of sample material from the feature/region of interest. Where a burst of pulses is directed at the sample, the material in the resulting plumes detected can be as a continuous event (the plumes from each individual ablation in effect form a single plume, which is then carried on for detection). While each cloud of sample material formed from the aggregated plumes from locations within a feature/region of interest can be analysed together, sample material in plumes from each different feature/region of interest is still kept discrete. That is to say, that sufficient time is left between ablation of different features/areas of interest to allow sample material from the nth feature/area interest before ablation of the (n+1)th feature/area is begun.

In a further mode of operation combining both fluorescence analysis and laser ablation sampling, instead of analysing the entire slide for fluorescence before targeting laser ablation to those locations, it is possible to fire a pulse from the laser at a spot on the sample (at low energy so as only to excite the fluorescent moieties in the sample rather than ablate the sample) and if a fluorescent emission of expected wavelength is detected, then the sample at the spot can be ablated by firing the laser at that spot at full energy, and the resulting plume analysed by a detector as described below. This has the advantage that the rastering mode of analysis is maintained, but the speed is increased, because it is possible to pulse and test for fluorescence and obtain results immediately from the fluorescence (rather than the time taken to analyse and interpret ion data from the detector to determine if the region was of interest), again enabling only the loci of importance to be targeted for analysis. Accordingly, applying this strategy in imaging a biological sample comprising a plurality of cells, the following steps can be performed: (i) labelling a plurality of different target molecules in the sample with one or more different labelling atoms and one or more fluorescent labels, to provide a labelled sample; (ii) illuminating a known location of the sample with light to excite the one or more fluorescent labels; (iii) observing and recording whether there is fluorescence at the location; (iv) if there is fluorescence, directing laser ablation at the location, to form a plume; (v) subjecting the plume to inductively coupled plasma mass spectrometry, and (vi) repeating steps (ii)-(v) for one or more further known locations on the sample, whereby detection of labelling atoms in the plumes permits construction of an image of the sample of the areas which have been ablated.

In some instances, the sample, or the sample carrier, may be modified so as to contain optically detectable (e.g., by optical or fluorescent microscopy) moieties at specific locations. The fluorescent locations can then be used to positionally orient the sample in the system. The use of such marker locations finds utility, for example, where the sample may have been examined visually “offline”—i.e. in a piece of system other than the system of aspects of the invention. Such an optical image can be marked with feature(s)/region(s) of interest, corresponding to particular cells by, say, a physician, before the optical image with the feature(s)/region(s) of interest highlighted and the sample are transferred to an system according to aspects of the invention. Here, by reference to the marker locations in the annotated optical image, the system of aspects of the invention can identify the corresponding fluorescent positions by use of the camera and calculate an ablative and/or desorptive (LIFTing) plan for the positions of the laser pulses accordingly. Accordingly, in some embodiments, aspects of the invention comprises an orientation controller module capable of performing the above steps.

In some instances, selection of the features/regions of interest may performed using the system of aspects of the invention, based on an image of the sample taken by the camera of the system of aspects of the invention.

### Nonlinear Microscopy

An imaging system of the subject application may be capable of nonlinear microscopy.

An alternative imaging technique is two-photon excitation microscopy (also referred to as nonlinear or multiphoton microscopy). The technique commonly employs near-IR light to excite fluorophores. Two photons of IR light are absorbed for each excitation event. Scattering in the tissue is minimized by IR. Further, due to the multiphoton absorption, the background signal is strongly suppressed. The most commonly used fluorophores have excitation spectra in the 400-500 nm range, whereas the laser used to excite the two-photon fluorescence lies in near-IR range. If the fluorophore absorbs two infrared photons simultaneously, it will absorb enough energy to be raised into the excited state. The fluorophore will then emit a single photon with a wavelength that depends on the type of fluorophore used that can then be detected.

When a laser is used to excite fluorophores for fluorescence microscopy, sometimes this laser is the same laser that generates the laser light used to ablate material from the biological sample, but used at a power that is not sufficient to cause ablation of material from the sample. Sometimes the fluorophores are excited by the wavelength of light that the laser then ablates the sample with. In others, a different wavelength may be used, for example by generating different harmonics of the laser to obtain light of different wavelengths, or exploiting different harmonics generated in a harmonic generation system, discussed above, apart from the harmonics which are used to ablate the sample. For example, if the fourth and/or fifth harmonic of a Nd:YAG laser are used, the fundamental harmonic, or the second to third harmonics, could be used for fluorescence microscopy.

An imaging mass cytometer integrating nonlinear microscopy may provide one or more of two-photon fluorescence, second harmonic generation (SHG), three-photon fluorescence (3PF), third harmonic generation (THG), and or coherent anti-Stokes Raman scattering (CARS). In certain aspects, the sample may be prepared for imaging by one or more forms of nonlinear microscopy, such as by a contrast agent or by a fluorophore tagged SBP. The sample may further be prepared with mass tagged SBPs.

In second harmonic generation (SHG), the signal is generated most strongly in collagen-containing tissues, where the signal has been shown to give rich information on the type of collagen in the laser focal spot as well as its 3-dimensional orientation. Such information cannot be obtained through other microscopy techniques. In third harmonic generation, the signal is uniquely generated in samples in the presence of interfaces between dissimilar materials. For example, this signal is generated at cell membranes, meaning it can be used to improve the accuracy of cell segmentation. In two-photon excitation fluorescence, the signal behaves very similarly to ‘normal’ fluorescence, except that the signal-to-noise ratio of the resulting images is generally much better due to no signal being generated outside of the laser focus. In Stimulated Raman Scattering or Coherent anti-Stokes Raman Scattering (SRS, CARS), signals are generated by concentrations of specific chemicals (inherent or introduced) with optically active vibrational bonds that resonate at particular frequencies. As an example, recent research has shown 30-plex SRS imaging of a series of engineered chemicals. Another strong application of this signal is in the detection of high lipid concentrations, such as in the cell wall or lipid droplets inside cells.

### Samples

A variety of samples may be provided on a solid support (also referred to herein as a slide) for processing by a slide handler system coupled to an imaging system. In certain aspects, the sample is a biological sample, such as a sample comprising a tissue section or cell smear. In certain aspects, the sample may be stained with mass tags as described herein.

Biological samples may have small and/or irregular features (e.g., cells on the micron scale), and may benefit from analysis at a large field of view. As used herein, features may include regions of tissue, individual cells, subcellular components, the membrane of a cell, a cell-cell interfaces, and/or extracellular matrix, as well as different tissue or cells within a section or image (e.g., healthy tissue, tumor, lymphocytes such as tumor infiltrating lymphocytes, muscle such as skeletal or smooth muscle, epithelium such as vasculature, and/or connective tissue such as stroma or fibers). Such features may be acquired (e.g., selectively acquired) by laser scanning as described herein. Analysing such features in a wide field of view (e.g., on the mm or cm scale) and/or across many samples may take hours or days by traditional IMC in which each pixel is around 1 um and needs to be distinguished from surrounding pixels. In the subject methods and systems, laser scanning (optionally combined with stage movement), may allow for rapid acquisition of individual features. In certain aspects, a system and/or method enables a cell acquisition rate of more than 10, 50, 100, 200, 500, 1000, 2000 or 5000 cells per second. Features may be automatically identified by optical microscopy (e.g., brightfield and/or fluorescence microscopy) and sampled by laser modulation as described herein. In certain aspects, contrast agents may improve the identification of such features.

In certain aspects, a method and/or system may sample across a wide field of view to identify regions of interest (ROIs). Specifically, the presence of mass tags may be detected by rapid scanning with a fs laser, removing only a thin layer of sample and leaving the remainder of the mass tagged sample intact (suitable for further analysis). Sampling from spaced (non-adjacent) spots may allow for an initial interrogation of the spatial distribution of mass tags and the identification of regions of interest for more in-depth sampling (e.g., pixel-by-pixel or for repeated scanning). The laser may be scanned and the stage moved continuously during such initial interrogation. As such, a large field of view and/or large number of samples (e.g., totaling more than a square centimetre) may be rapidly initially interrogated (e.g., in less than an hour, 30 minutes, 10 minutes, or 5 minutes) to identify ROIs to investigate further by IMC.

In certain aspects a sample of suspended cells (such as peripheral blood mononuclear cells (PBMCs), a non-adherent cell culture, or disaggregated cells from intact tissue or an adherent cell culture) may be provided for analysis as a cell smear. Such cells can be stained in suspension with mass-tagged SBPs, and applied to a surface (such as a slide) for analysis by the subject methods and systems. A cell smear may be provided on a support alongside element standard particles for calibration and/or normalization. Alternatively or in addition, a cell smear may be provided along assay barcoded beads for detecting free analyte in a biological sample. For example, a cell smear comprising PBMCs may be provided alongside assay barcoded beads bound to free analytes from the same blood sample as the PBMCs. In certain aspects, the surface may have capture sites, such as micron-scale wells, for retaining cells and/or beads.

Assay barcoded beads may be individually detectable, and may be on the micron scale. Such beads may comprise an assay barcode on their surface or in their interior, that identifies an SBP on the bead surface. A unique combination of assay barcode isotopes may identify the SBP on the bead surface, such that each assay barcode bead having a different SBP is distinguished by the assay barcode. The assay barcoded beads may be mixed with a biological fluid (e.g., cell supernatant, cell lysate, or blood serum) and bound to free analyte (e.g., cytokines) in the sample. A reporter SBP bound to a reporter mass tag may bind the analyte bound to the SBP on the cell surface. The same reporter mass tag may be used across assay barcoded beads, as the assay barcode would distinguish the analyte.

In certain aspects, a control cell sample, such as a homogeneous cell line or PBMCs may be applied to the slide (e.g., as a cell smear, a section of tissue, or as adherent cells). The control cell sample may be used to normalize for variations in sample processing, such as staining. The control cell sample may come from a previously characterized sample (e.g., and have known expression levels of markers) and/or may be used across multiple slides alongside other samples. The control cell sample may be used normalization and/or quantitation, and or for classification, and may control for variation in sample staining. For example, while an element standard may be used for calibration, normalization and/or quantitation of mass tags to account for fluctuations in instrument sensitivity, control cells stained alongside a sample of interest may allow for normalization to account for variation in sample staining. Control cells with previously defined populations of interest (e.g., PBMCs) may be used to classify cells of similar populations in one or more samples of interest. Control cells may have one or more labelling atoms (such as a sample barcode), which may identify the cells as control cells.

The control cell sample may be a paraffinized cell sample, for example when a sample of interest (e.g., on the same slide) is also a paraffinized sample. In certain aspects the control cell sample may be a paraffinized cell line on a sample slide used to trace reproducibility of sample processing. Alternatively, the control cell sample may be a frozen tissue section, for example when a sample of interest (e.g., on the same slide) is also a frozen tissue sample. In either case, the control cell sample may be processed alongside a sample of interest, including a staining step. Alternatively or in addition, a control cell sample may be pre-stained. For example, a pre-stained control cell sample could be to a control cell sample stained alongside a sample of interest to determine whether the staining was similar (and optionally normalize variations from staining and/or other aspects of sample preparation).

An interior of an assay barcode bead may include an assay barcode, such as a distinguishable combination of metal isotopes. The interior of the bead may be any of a variety of suitable structures, such as a solid metal core, metal chelating polymer interior, nanocomposite interior, or hybrid interior. A solid metal core may be formed by subjecting a mixture (e.g., solution) of one or more metal elements and/or isotopes to high heat and/or pressure. A nanocomposite structure may comprise a combination (e.g., matrix) of nanoparticles/nanostructures (e.g., each comprising different physical properties and contributing one or more assay barcode elements/isotopes and/or providing scaffolding for other nanoparticles comprising assay barcode elements/isotopes). The interior of the bead may include a polymer entrapping the assay barcode metals and/or chelating assay barcode metals (e.g., through pendant groups such as DOTA, DTPA, or a derivative thereof). Suitable polymer backbones may be branched (e.g., hyperbranched) or form a matrix. In some aspects, the polymer may be formed in emulsion, or by a controlled living polymerization. In certain aspects, the interior of an assay bead may present an inert surface (e.g., such as a solid metal surface) that needs to be functionalized (e.g., by polymerization across the surface) prior to attachment to assay biomolecules (e.g., an oligonucleotide or antibody). The surface of an assay bead may comprise a polymer, linkers to space assay biomolecules (e.g., SBPs) away from the surface and/or add colloidal stability (e.g., PEG linkers), functional group(s) for attaching (or attached to) an assay biomolecule and/or a sample barcode.

Cells of a cell smear and/or assay barcoded beads from multiple samples may be combined when sample barcoded. A sample barcode may comprise a plurality of isotopes that are not used for staining (i.e., are not associated with mass tags of SBPs). A sample barcode may include one or more small molecules or SBPs that delivers sample barcode isotope(s) to cells or beads. A unique combination of isotopes is applied to beads and/or cells from each sample. When a cell or bead is analysed by mass cytometry (e.g., LA-ICP-MS), the unique combination of barcode isotopes identifies the sample that cell or bead was originally from. Samples may be from different sources and/or may be subject to different treatment and/or staining conditions. In certain aspects, a live cell barcode (e.g., a thiol-reactive tellurium-based barcode, or an element tagged antibody to a widely expressed surface marker) could be used, which can add the benefit of also barcoding live cells in the sample (e.g., fresh blood). This approach could be performed alongside a stimulation or another treatment of live cells (e.g., of PBMCs). In some cases, the sample barcode can be capable of barcoding live cells. In some cases, the sample barcode can be non-damaging to live cells, such as being non-toxic to live cells.

In some cases, barcoding reagents can be provided in a pre-configured form by preparing the barcoding reagents with a number of unique combinations of assay barcodes and sample barcodes. In such cases, each unique barcoding reagent can be stored in distinct containers, such as distinct wells of a well plate. In an example, a well plate can be established such that all wells along a particular column (or row) share the same assay barcode, whereas all wells along a particular row (or column) share the same sample barcode. In another example, a well plate can be established such that each filled well contains barcoding reagents with various combinations of a particular unique sample barcode and numerous assay barcodes. Thus, a first well may contain barcoding reagents all having a first sample barcode but each having different assay barcodes, and a second well may contain barcoding reagents all having a second barcode but each having different assay barcodes. In some cases, pre-configured barcoding reagents can require the manufacture of thousands of groups of unique beads.

To automate staining, a biological sample (e.g., comprising cells) on a surface may be stained by flowing mass-tagged SBPs across the surface of the cells (e.g., using an sample preparation station described herein).

The identification of the cells of interest in order to be able to identify the regions that should be ablated typically involves the examination of a visual image of the cells. For instance, for simplified analysis, in a cell smear it is desirable to analyse individual cells which are present as discrete cells on the smear (i.e. not as a doublet, triplet or higher numbered cluster of cells), and this determination can be easily accomplished by visual inspection of the sample. As discussed below, in certain embodiments disclosed herein, the sample can be examined for markers evident from inspection of the cells in the visible light range. Sometimes, cell morphology as identified under confocal microscopy will be sufficient to identify a cell as being of interest. In other instances, the sample can be stained with one or more histochemical stains or one or more SBPs conjugated to fluorescent labels (which in some cases, can be an SBP that is also conjugated to a labelling atom). These fluorescent makers can be used to stain specific cell populations (e.g. expressing certain genes and/or proteins) or specific morphological features on cells (such as the nucleus, or mitochondria) and when illuminated with an appropriate wavelength of light, these regions of the sample are specifically identifiable. In some instances, the absence of a particular kind fluorescence from a particular area may be characteristic. For instance, a first fluorescent label targeted to a cell membrane protein may be used to broadly identify cells, but then a second fluorescent label targeted to the ki67 antigen (encoded by the MK167 gene) can discriminate between proliferating cells and non-proliferating cells. Thus by targeting cells which lack fluorescence from the second label fluorescent, non-replicating cells can be specifically targeted for analysis. In some embodiments, the systems described herein therefore can comprise a laser for exciting fluorophores in the labels used to label the sample. Alternatively, an LED light source can be used for exciting the fluorophores. Non confocal (e.g. wide field) fluorescent microscopy can also be used to identify certain regions of the biological sample, but with lower resolution than confocal microscopy.

Certain aspects of the disclosure provides a method of imaging a biological sample. Such samples can comprise a plurality of cells which can be subjected to imaging mass cytometry (IMC) in order to provide an image of these cells in the sample. In general, aspects of the invention can be used to analyse tissue samples which are now studied by immunohistochemistry (IHC) techniques, but with the use of labelling atoms which are suitable for detection by mass spectrometry (MS) or optical emission spectrometry (OES).

In certain aspects, a sample may comprise a plurality of sections (e.g., serial tissue sections). In certain aspects, the tissue section may be chilled (e.g., frozen) and/or wax (e.g., paraffin) embedded before sectioning. Any sectioning method known to one of skill in the art may be used, although most methods of sectioning involve the cutting a tissue sample with a sharp blade applied at an angle, and mounting the resultant tissue section on a solid support such as a slide. Sections (e.g., serial sections) from the same tissue may be imaged by imaging mass cytometry and/or a different modality, and co-registered with one another as described herein. When the penetration of a stain and/or the imaging modality only allows a top layer of a tissue section to be analysed, tissue sectioning may involve preparing two serial sections that are stained and/or imaged on the side that faces one another. For example, one section may be flipped such that it presents the face adjacent to the other section. When identifying an ROI based on the first section, and/or when co-registering images from the two sections, and image obtained from one section may be flipped. Alternatively or in addition, serial sections can be aligned with fiducials on respective slides (or on the same slide) such that their rough position with respect to one another prior to sectioning is preserved or represented. Any suitable tissue sample can be used in the methods described herein. For example, the tissue can include tissue from one or more of epithelium, muscle, nerve, skin, intestine, pancreas, kidney, brain, liver, blood (e.g. a blood smear), bone marrow, buccal swipes, cervical swipes, or any other tissue. The biological sample may be an immortalized cell line or primary cells obtained from a living subject. For diagnostic, prognostic or experimental (e.g., drug development) purposes the tissue can be from a tumor. In some embodiments, a sample may be from a known tissue, but it might be unknown whether the sample contains tumor cells. Imaging can reveal the presence of targets which indicate the presence of a tumor, thus facilitating diagnosis. Tissue from a tumor may comprise immune cells that are also characterized by the subject methods, and may provide insight into the tumor biology. The tissue sample may comprise formalin-fixed, paraffin-embedded (FFPE) tissue. The tissues can be obtained from any living multicellular organism, such as a mammal, an animal research model (e.g., of a particular disease, such as an immunodeficient rodent with a human tumor xenograft), or a human patient. In certain aspects, tissue samples may be banked. In certain aspects, tissue samples on separate slides may be from the same tissue block.

The tissue sample may be a section e.g. having a thickness within the range of 2-10 μm, such as between 4-6 μm. Techniques for preparing such sections are well known from the field of IHC e.g. using microtomes, including dehydration steps, fixation, embedding, permeabilization, sectioning etc. Thus, a tissue may be chemically fixed and then sections can be prepared in the desired plane. Cryosectioning or laser capture microdissection can also be used for preparing tissue samples. Samples may be permeabilised e.g. to permit uptake of reagents for labelling of intracellular targets (see above).

The size of a tissue sample to be analysed will be similar to current IHC methods, although the maximum size will be dictated by the laser ablation system, and in particular by the size of sample which can fit into its sample chamber. A size of up to 5 mm×5 mm is typical, but smaller samples (e.g. 1 mm×1 mm) are also useful (these dimensions refer to the size of the section, not its thickness).

In addition to being useful for imaging tissue samples, the disclosure can instead be used for imaging of cellular samples such as monolayers of adherent cells or of cells which are immobilised on a solid surface (as in conventional immunocytochemistry). These embodiments are particularly useful for the analysis of adherent cells that cannot be easily solubilized for cell-suspension mass cytometry. Thus, as well as being useful for enhancing current immunohistochemical analysis, the disclosure can be used to enhance immunocytochemistry.

### Serial Sections and Resampling

In certain aspects, serial sections of tissue may be analysed by imaging mass cytometry. Serial sections may be identically stained or stained for different markers. For example, a first serial section may be stained for protein markers (or predominantly protein markers) while a second serial section may be stained for RNA markers (or predominantly RNA markers). This is especially useful when the sample preparation for one set of markers (such as antigen retrieval for protein markers) may damage or impair the ability to detect another set of markers (such as RNA markers). Serial sections may be produced by resin (e.g., BMMA) embedding and array tomography of thin sections, as described further herein.

A plurality of serial sections may be stained with different sets of SBPs that comprise the same or overlapping mass tags. Alternatively, serial sections may be stained with the same or overlapping set of SBPs that comprise the same or overlapping mass tags. Markers present on features shared across serial sections may be integrated or otherwise combined for analysis. For example, the same marker (e.g., bound by the same SBP) detected in a feature, such as a cell, across subsequent sections may be added together to determine expression in that feature. This may provide higher sensitivity, and may be particularly useful for detecting and/or determining the abundance of low expressing markers. Features such as cells may be larger than a single section, or may be split across sections. Various methods allow for thin sections to be cut on the micron scale. Dehydration of the section during sample prep combined with the depth of laser ablation can allow for the majority of a sections thickness to be ablated. In cases where the section is significantly thicker than the depth of laser ablation, resampling at a location can allow for more material from a feature to be analysed. Lasers with a short intense pulse, such as fs lasers, may more cleanly sample from a sample (e.g., with little heat dissipation beyond the site of ablation), better enabling resampling. As described above, resampling and/or analysis of multiple serial sections may allow for higher sensitivity. In addition, resampling and/or analysis of multiple serial sections may allow reconstruction of a 3D mass cytometry image.

In certain aspects, identification of features may be done during an optical interrogation, and the laser may be scanned along optically identified features of interest. Alternatively, features may be identified from a pixel-by-pixel mass cytometry image, such as an array of pixels on the scale of a micron (e.g., 0.5 to 2 microns in diameter). Pixels relating to a feature may be identified at the analysis stage, and the signal from markers in that feature may be integrated. Laser scanning along a feature, grouping of pixels (obtained by translation of a stage and/or laser scanning) into a feature, resampling at a location, and/or integration of features across serial sections, may in any combination improve sensitivity of markers associated with a feature. When laser scanning is applied, it may allow for significant time saving, which becomes even more valuable when analysing serial sections.

IMC provides inherent advantage over immunohistochemistry imaging or immune fluorescent microscopy in that the signals from metal label have little or no overlap, enabling imaging for 40 or more proteins (and/or other markers) simultaneously, from one tissue section. In some cases, IMC may have lower sensitivity than other methods. For example, a detection limit of traditional IMC may be 400 copies of antibody per a 1 micrometer diameter laser spot (pixel), based on antibodies labelled with 100 atoms and a typical transmission factor of the ICP-TOF-MS. A feature, such as a cell, may be more than 10, 20, 50, or 100 square microns. In traditional IMC, a 3-10 micrometer thick (e.g., 5-7 micrometer thick) tissue is typically dried to a thickness at or less than a micrometer, which is an approximate limit of full ablation for a typical laser energy used in IMC (assuming 1 micro Joule at the laser head). Some if not many cells are larger in thickness of the initial sections. Thus, tissue section often contains pieces of cells, rather than full cells. Of note, different laser speeds, wavelengths and energies may modify these assumptions. In some cases, a fast (e.g., fs) laser may allow for resampling and “drilling” into a thicker tissue section.

Interrogating features such as cells by IMC may result in low detection power of low abundance markers that may be distributed evenly (e.g., throughout the cytoplasm), and their abundance in a fraction of a cell may be lower than in a whole cell. Moreover, some markers can be under-represented in a particular fraction of a cell, as some markers can be present in particular cellular compartments. For example, nucleus of a cell (detectable, for example, by iridium nucleic acid intercalator), can be fully present, fully absent, or present in it's fraction, in a particular tissue section. As a result, it can be either fully detectable with good signal to noise ratio, partially detectable, or not detectable/absent at all. Similarly, protein markers can be detectable, partially detectable or not detectable at all, depending on their presence in cell compartments/section. Even for markers above a detection threshold, a higher sensitivity may improve or allow qualitative or quantitative assessment of the abundance of the marker.

As described herein, a method or system may measure of major markers present at high abundance in cells, measurement being performed in sequential tissue sections. Then major marker signals may be used for identifying objects/segmenting cell-like objects representing particular cells in each cross-section, or developing typical phenotypes of cells present in each tissue section. Then, markers signature or cell phenotype may be linked to XY coordinates of each identified object. Then the object of similar major marker signature/phenotype with close XY coordinates are linked to each other as pieces of the same cell sectioned during microtoming. Once the objects in the sequential sections are identified as representing the same cell, signals for all markers are integrated (e.g., summed) between sequential tissue sections, effectively producing a “volume integral” of marker signals. This improves signal and signal to noise ratio, as the sum of the marker signals can potentially scale with the number of summed sections, while background signal would be proportional to a square root of the number of summed sections.

More-over, in cases when a particular cell compartment (or marker in a compartment) is not present in one tissue section, it can be present in a previous or next section of the same tissue block. Thus, detection of some markers can be improved many-fold, or even enabled. Multiple methods of recognition of major marker signatures as belonging to the same cell are available, including known in the field method of image segmentation (for example, watershed method). While the above example is provided for cells, this approach could be used for any feature described herein. Features at similar XY coordinates having similar characteristics such as shape and/or marker expression, and/or having a similar surrounding set of features, can be recognized as belonging to the same cell feature (e.g., cell) after such segmentation.

### Sample Slide

In certain embodiments, the sample may be immobilized on a solid support (also referred to herein as a sample carrier or slide). The solid support may be optically transparent, for example made of glass or plastic. Where the sample carrier is optically transparent, it enables ablation of the sample material through the support, as illustrated in FIG. 5. Sometimes, the sample carrier will comprise features that act as reference points for use with the system and methods described herein, for instance to allow the calculation of the relative position of features/regions of interest that are to be ablated or desorbed and analysed. The reference points may be optically resolvable, or may be resolvable by mass analysis.

### Target Elements

In imaging mass spectrometry, the distribution of one or more target elements (i.e., elements or elemental isotopes) may be of interest. In certain aspects, target elements are labelling atoms as described herein. A labelling atom may be directly added to the sample alone or covalently bound to or within a biologically active molecule. In certain embodiments, labelling atoms (e.g., metal tags) may be conjugated to a member of a specific binding pair (SBP), such as an antibody (that binds to its cognate antigen), aptamer or oligonucleotide for hybridizing to a DNA or RNA target, as described in more detail below. Labelling atoms may be attached to an SBP by any method known in the art. In certain aspects, the labelling atoms are a metal element, such as a lanthanide or transition element or another metal tag as described herein. The metal element may have a mass greater than 60 amu, greater than 80 amu, greater than 100 amu, or greater than 120 amu. Mass spectrometers described herein may deplete elemental ions below the masses of the metal elements, so that abundant lighter elements do not create space-charge effects and/or overwhelm the mass detector.

### Labelling of the Tissue Sample

The disclosure produces images of samples which have been labelled with labelling atoms, for example a plurality of different labelling atoms, wherein the labelling atoms are detected by an system capable of sampling specific, preferably subcellular, areas of a sample (the labelling atoms therefore represent an elemental tag). The reference to a plurality of different atoms means that more than one atomic species is used to label the sample. These atomic species can be distinguished using a mass detector (e.g. they have different m/Q ratios), such that the presence of two different labelling atoms within a plume gives rise to two different MS signals. The atomic species can also be distinguished using an optical spectrometer (e.g. different atoms have different emission spectra), such that the presence of two different labelling atoms within a plume gives rise to two different emission spectral signals.

### Mass Tagged Reagents

Mass-tagged reagents as used herein comprise a number of components. The first is the SBP. The second is the mass tag. The mass tag and the SBP are joined by a linker, formed at least in part of by the conjugation of the mass tag and the SBP. The linkage between the SBP and the mass tag may also comprise a spacer. The mass tag and the SBP can be conjugated together by a range of reaction chemistries. Exemplary conjugation reaction chemistries include thiol maleimide, NHS ester and amine, or click chemistry reactivities (preferably Cu(I)-free chemistries), such as strained alkyne and azide, strained alkyne and nitrone and strained alkene and tetrazine.

### Mass Tags

The mass tag (also referred to as an elemental tag) used in the present invention can take a number of forms. Typically, the tag comprises at least one labelling atom. A labelling atom is discussed herein below. In certain aspects, a mass tag may comprise a metal chelating polymer, such as a linear or branched polymer comprising metal chelating pendant groups. However, other types of mass tags include a metal nanoparticle (e.g., a metal cluster surface functionalized for attachment to a biomolecule) or a metal embedding polymer.

Accordingly, in its simplest form, the mass tag may comprise a metal-chelating moiety which is a metal-chelating group with a metal labelling atom co-ordinated in the ligand. In some instances, detecting only a single metal atom per mass tag may be sufficient. However, in other instances, it may be desirable of each mass tag to contain more than one labelling atom. This can be achieved in a number of ways, as discussed below.

A first means to generate a mass tag that can contain more than one labelling atom is the use of a polymer comprising metal-chelating ligands attached to more than one subunit of the polymer. The number of metal-chelating groups capable of binding at least one metal atom in the polymer can be between approximately 1 and 10,000, such as 5-100, 10-250, 250-5,000, 500-2,500, or 500-1,000. At least one metal atom can be bound to at least one of the metal-chelating groups. The polymer can have a degree of polymerization of between approximately 1 and 10,000, such as 5-100, 10-250, 250-5,000, 500-2,500, or 500-1,000. Accordingly, a polymer based mass tag can comprise between approximately 1 and 10,000, such as 5-100, 10-250, 250-5,000, 500-2,500, or 500-1,000 labelling atoms.

The polymer can be selected from the group consisting of linear polymers, copolymers, branched polymers, graft copolymers, block polymers, star polymers, and hyperbranched polymers. The backbone of the polymer can be derived from substituted polyacrylamide, polymethacrylate, or polymethacrylamide and can be a substituted derivative of a homopolymer or copolymer of acrylamides, methacrylamides, acrylate esters, methacrylate esters, acrylic acid or methacrylic acid. The polymer can be synthesised from the group consisting of reversible addition fragmentation polymerization (RAFT), atom transfer radical polymerization (ATRP) and anionic polymerization. The step of providing the polymer can comprise synthesis of the polymer from compounds selected from the group consisting of N-alkyl acrylamides, N,N-dialkyl acrylamides, N-aryl acrylamides, N-alkyl methacrylamides, N,N-dialkyl methacrylamides, Naryl methacrylamides, methacrylate esters, acrylate esters and functional equivalents thereof.

The polymer can be water soluble. This moiety is not limited by chemical content. However, it simplifies analysis if the skeleton has a relatively reproducible size (for example, length, number of tag atoms, reproducible dendrimer character, etc.). The requirements for stability, solubility, and non-toxicity are also taken into consideration. Thus, the preparation and characterization of a functional water soluble polymer by a synthetic strategy that places many functional groups along the backbone plus a different reactive group (the linking group), that can be used to attach the polymer to a molecule (for example, an SBP), through a linker and optionally a spacer. The size of the polymer is controllable by controlling the polymerisation reaction. Typically the size of the polymer will be chosen so as the radiation of gyration of the polymer is as small as possible, such as between 2 and 11 nanometres. The length of an IgG antibody, an exemplary SBP, is approximately 10 nanometres, and therefore an excessively large polymer tag in relation to the size of the SBP may sterically interfere with SBP binding to its target.

The metal-chelating group that is capable of binding at least one metal atom can comprise at least four acetic acid groups. For instance, the metal-chelating group can be a diethylenetriaminepentaacetate (DTPA) group or a 1,4,7,10-tetraazacyclododecane-1,4,7,10-tetraacetic acid (DOTA) group. Alternative groups include Ethylenediaminetetraacetic acid (EDTA) and ethylene glycol-bis(β-aminoethyl ether)-N,N,N′,N′-tetraacetic acid (EGTA)

The metal-chelating group can be attached to the polymer through an ester or through an amide. Examples of suitable metal-chelating polymers include the X8 and DM3 polymers available from Fluidigm Canada, Inc.

The polymer can be water soluble. Because of their hydrolytic stability, N-alkyl acrylamides, N-alkyl methacrylamides, and methacrylate esters or functional equivalents can be used. A degree of polymerization (DP) of approximately 1 to 1000 (1 to 2000 backbone atoms) encompasses most of the polymers of interest. Larger polymers are in the scope of aspects of the invention with the same functionality and are possible as would be understood by practitioners skilled in the art. Typically the degree of polymerization will be between 1 and 10,000, such as 5-100, 10-250, 250-5,000, 500-2,500, or 500-1,000. The polymers may be amenable to synthesis by a route that leads to a relatively narrow polydispersity. The polymer may be synthesized by atom transfer radical polymerization (ATRP) or reversible addition-fragmentation (RAFT) polymerization, which should lead to values of Mw (weight average molecular weight)/Mn (number average molecular weight) in the range of 1.1 to 1.2. An alternative strategy involving anionic polymerization, where polymers with Mw/Mn of approximately 1.02 to 1.05 are obtainable. Both methods permit control over end groups, through a choice of initiating or terminating agents. This allows synthesizing polymers to which the linker can be attached. A strategy of preparing polymers containing functional pendant groups in the repeat unit to which the liganded transition metal unit (for example a Ln unit) can be attached in a later step can be adopted. This embodiment has several advantages. It avoids complications that might arise from carrying out polymerizations of ligand containing monomers.

To minimize charge repulsion between pendant groups, the target ligands for (M³⁺) should confer a net charge of −1 on the chelate.

The metal-chelating groups can be attached to the polymer by methods known to those skilled in the art, for example, the pendant group may be attached through an ester or through an amide. For instance, to a methylacrylate based polymer, the metal-chelating group can be attached to the polymer backbone first by reaction of the polymer with ethylenediamine in methanol, followed by subsequent reaction of DTPA anhydride under alkaline conditions in a carbonate buffer.

A second means is to generate nanoparticles which can act as mass tags. A first pathway to generating such mass tags is the use of nanoscale particles of the metal which have been coated in a polymer. Here, the metal is sequestered and shielded from the environment by the polymer, and does not react when the polymer shell can be made to react e.g. by functional groups incorporated into the polymer shell. The functional groups can be reacted with linker components (optionally incorporating a spacer) to attach click chemistry reagents, so allowing this type of mass tag to plug in to the synthetics strategies discussed above in a simple, modular fashion.

Grafting-to and grafting-from are the two principle mechanism for generating polymer brushes around a nanoparticle. In grafting to, the polymers are synthesised separately, and so synthesis is not constrained by the need to keep the nanoparticle colloidally stable. Here reversible addition-fragmentation chain transfer (RAFT) synthesis has excelled due to a large variety of monomers and easy functionalization. The chain transfer agent (CTA) can be readily used as functional group itself, a functionalized CTA can be used or the polymer chains can be post-functionalized. A chemical reaction or physisorption is used to attach the polymers to the nanoparticle. One drawback of grafting-to is the usually lower grafting density, due to the steric repulsion of the coiled polymer chains during attachment to the particle surface. All grafting-to methods suffer from the drawback that a rigorous workup is necessary to remove the excess of free ligand from the functionalized nanocomposite particle. This is typically achieved by selective precipitation and centrifugation. In the grafting-from approach molecules, like initiators for atomic transfer radical polymerization (ATRP) or CTAs for (RAFT) polymerizations, are immobilized on the particle surface. The drawbacks of this method are the development of new initiator coupling reactions. Moreover, contrary to grafting-to, the particles have to be colloidally stable under the polymerization conditions.

An additional means of generating a mass tag is via the use of doped beads. Chelated lanthanide (or other metal) ions can be employed in miniemulsion polymerization to create polymer particles with the chelated lanthanide ions embedded in the polymer. The chelating groups are chosen, as is known to those skilled in the art, in such a way that the metal chelate will have negligible solubility in water but reasonable solubility in the monomer for miniemulsion polymerization. Typical monomers that one can employ are styrene, methylstyrene, various acrylates and methacrylates, among others as is known to those skilled in the art. For mechanical robustness, the metal-tagged particles have a glass transition temperature (Tg) above room temperature. In some instances, core-shell particles are used, in which the metal-containing particles prepared by miniemulsion polymerization are used as seed particles for a seeded emulsion polymerization to control the nature of the surface functionality. Surface functionality can be introduced through the choice of appropriate monomers for this second-stage polymerization. Additionally, acrylate (and possible methacrylate) polymers are advantageous over polystyrene particles because the ester groups can bind to or stabilize the unsatisfied ligand sites on the lanthanide complexes. An exemplary method for making such doped beads is: (a) combining at least one labelling atom-containing complex in a solvent mixture comprising at least one organic monomer (such as styrene and/or methyl methacrylate in one embodiment) in which the at least one labelling atom-containing complex is soluble and at least one different solvent in which said organic monomer and said at least one labelling atom-containing complex are less soluble, (b) emulsifying the mixture of step (a) for a period of time sufficient to provide a uniform emulsion; (c) initiating polymerization and continuing reaction until a substantial portion of monomer is converted to polymer; and (d) incubating the product of step (c) for a period of time sufficient to obtain a latex suspension of polymeric particles with the at least one labelling atom-containing complex incorporated in or on the particles therein, wherein said at least one labelling atom-containing complex is selected such that upon interrogation of the polymeric mass tag, a distinct mass signal is obtained from said at least one labelling atom. By the use of two or more complexes comprising different labelling atoms, doped beads can be made comprising two or more different labelling atoms. Furthermore, controlling the ration of the complexes comprising different labelling atoms, allows the production of doped beads with different ratios of the labelling atoms. By use of multiple labelling atoms, and in different radios, the number of distinctively identifiable mass tags is increased. In core-shell beads, this may be achieved by incorporating a first labelling atom-containing complex into the core, and a second labelling atom-containing complex into the shell.

A yet further means is the generation of a polymer that include the labelling atom in the backbone of the polymer rather than as a co-ordinated metal ligand. For instance, Carerra and Seferos (Macromolecules 2015, 48, 297-308) disclose the inclusion of tellurium into the backbone of a polymer. Other polymers incorporating atoms capable as functioning as labelling atoms tin-, antimony- and bismuth-incorporating polymers. Such molecules are discussed inter alia in Priegert et al., 2016 (Chem. Soc. Rev., 45, 922-953).

Thus the mass tag can comprise at least two components: the labelling atoms, and a polymer, which either chelates, contains or is doped with the labelling atom. In addition, the mass tag comprises an attachment group (when not-conjugated to the SBP), which forms part of the chemical linkage between the mass tag and the SBP following reaction of the two components, in a click chemistry reaction in line with the discussion above.

A polydopamine coating can be used as a further way to attach SBPs to e.g. doped beads or nanoparticles. Given the range of functionalities in polydopamine, SBPs can be conjugated to the mass tag formed from a PDA coated bead or particle by reaction of e.g. amine or sulfhydryl groups on the SBP, such as an antibody. Alternatively, the functionalities on the PDA can be reacted with reagents such as bifunctional linkers which introduce further functionalities in turn for reaction with the SBP. In some instances, the linkers can contain spacers, as discussed below. These spacers increase the distance between the mass tag and the SBP, minimising steric hindrance of the SBP. Thus aspects of the invention comprises a mass-tagged SBP, comprising an SBP and a mass tag comprising polydopamine, wherein the polydopamine comprises at least part of the link between the SBP and the mass tag. Nanoparticles and beads, in particular polydopamine coated nanoparticles and beads, may be useful for signal enhancement to detect low abundance targets, as they can have thousands of metal atoms and may have multiple copies of the same affinity reagent. The affinity reagent could be a secondary antibody, which could further boost signal.

### Labelling Atom

Labelling atoms that can be used with the disclosure include any species that are detectable by MS or OES and that are substantially absent from the unlabelled tissue sample. Thus, for instance, ¹²C atoms would be unsuitable as labelling atoms because they are naturally abundant, whereas ¹¹C could in theory be used for MS because it is an artificial isotope which does not occur naturally. Often the labelling atom is a metal. In preferred embodiments, however, the labelling atoms are transition metals, such as the rare earth metals (the 15 lanthanides, plus scandium and yttrium). These 17 elements (which can be distinguished by OES and MS) provide many different isotopes which can be easily distinguished (by MS). A wide variety of these elements are available in the form of enriched isotopes e.g. samarium has 6 stable isotopes, and neodymium has 7 stable isotopes, all of which are available in enriched form. The 15 lanthanide elements provide at least 37 isotopes that have non-redundantly unique masses. Examples of elements that are suitable for use as labelling atoms include Lanthanum (La), Cerium (Ce), Praseodymium (Pr), Neodymium (Nd), Promethium (Pm), Samarium (Sm), Europium (Eu), Gadolinium, (Gd), Terbium (Tb), Dysprosium (Dy), Holmium (Ho), Erbium (Er), Thulium (Tm), Ytterbium (Yb), Lutetium (Lu), Scandium (Sc), and Yttrium (Y). In addition to rare earth metals, other metal atoms are suitable for detection e.g. gold (Au), platinum (Pt), iridium (Ir), rhodium (Rh), bismuth (Bi), etc. The use of radioactive isotopes is not preferred as they are less convenient to handle and are unstable e.g. Pm is not a preferred labelling atom among the lanthanides.

In order to facilitate time-of-flight (TOF) analysis (as discussed herein) it is helpful to use labelling atoms with an atomic mass within the range 80-250 e.g. within the range 80-210, or within the range 100-200. This range includes all of the lanthanides, but excludes Sc and Y. The range of 100-200 permits a theoretical 101-plex analysis by using different labelling atoms, while taking advantage of the high spectral scan rate of TOF MS. As mentioned above, by choosing labelling atoms whose masses lie in a window above those seen in an unlabelled sample (e.g. within the range of 100-200), TOF detection can be used to provide rapid imaging at biologically significant levels.

Various numbers of labelling atoms can be attached to a single SBP member dependent upon the mass tag used (and so the number of labelling atoms per mass tag) and the number of mass tags that are attached to each SBP). Greater sensitivity can be achieved when more labelling atoms are attached to any SBP member. For example, greater than 10, 20, 30, 40, 50, 60, 70, 80, 90 or 100 labelling atoms can be attached to a SBP member, such as up to 10,000, for instance as 5-100, 10-250, 250-5,000, 500-2,500, or 500-1,000 labelling atoms. As noted above, monodisperse polymers containing multiple monomer units may be used, each containing a chelator such as diethylenetriaminepentaacetic acid (DTPA) or DOTA. DTPA, for example, binds 3+ lanthanide ions with a dissociation constant of around 10⁻⁶ M. These polymers can terminate in a thiol which can be used for attaching to a SBP via reaction of that with a maleimide to attach a click chemistry reactivity in line with those discussed above. Other functional groups can also be used for conjugation of these polymers e.g. amine-reactive groups such as N-hydroxy succinimide esters, or groups reactive against carboxyls or against an antibody's glycosylation. Any number of polymers may bind to each SBP. Specific examples of polymers that may be used include straight-chain (“X8”) polymers or third-generation dendritic (“DN3”) polymers, both available as MaxPar™ reagents. Use of metal nanoparticles can also be used to increase the number of atoms in a label, as also discussed above.

In some embodiments, all labelling atoms in a mass tag are of the same atomic mass. Alternatively, a mass tag can comprise labelling atoms of differing atomic mass. Accordingly, in some instances, a labelled sample may be labelled with a series of mass-tagged SBPs each of which comprises just a single type of labelling atom (wherein each SBP binds its cognate target and so each kind of mass tag is localised on the sample to a specific e.g. antigen). Alternatively, in some instance, a labelled sample may be labelled with a series of mass-tagged SBPs each of which comprises a mixture of labelling atoms. In some instances, the mass-tagged SBPs used to label the sample may comprise a mix of those with single labelling atom mass tags and mixes of labelling atoms in their mass tags.

### Spacer

As noted above, in some instances, the SBP is conjugated to a mass tag through a linker which comprises a spacer. There may be a spacer between the SBP and the click chemistry reagent (e.g. between the SBP and the strained cycloalkyne (or azide); strained cycloalkene (or tetrazine); etc.). There may be a spacer between the between the mass tag and the click chemistry reagent (e.g. between the mass tag and the azide (or strained cycloalkyne); tetrazine (or strained cycloalkene); etc.). In some instances there may be a spacer both between the SNP and the click chemistry reagent, and the click chemistry reagent and the mass tag.

The spacer might be a polyethylene glycol (PEG) spacer, a poly(N-vinylpyrolide) (PVP) spacer, a polyglycerol (PG) spacer, poly(N-(2-hydroxylpropyl)methacrylamide) spacer, or a polyoxazoline (POZ, such as polymethyloxazoline, polyethyloxazoline or polypropyloxazoline) or a C5-C20 non-cyclic alkyl spacer. For example, the spacer may be a PEG spacer with 3 or more, 4 or more, 5 or more, 6 or more, 7 or more, 8 or more, 9 or more, 10 or more, 11 or more, 12 or more, 15 or more of 20 or more EG (ethylene glycol) units. The PEG linker may have from 3 to 12 EG units, from 4 to 10, or may have 4, 5, 6, 7, 8, 9, or 10 EG units. The linker may include cystamine or derivatives thereof, may include one or more disulfide groups, or may be any other suitable linker known to one of skill in the art.

Spacers may be beneficial to minimize the steric effect of the mass tag on the SBP to which is conjugated. Hydrophilic spacers, such as PEG based spacers, may also act to improve the solubility of the mass-tagged SBP and act to prevent aggregation.

### SBPs

Mass cytometry, including imaging mass cytometry is based on the principle of specific binding between members of specific binding pairs. The mass tag is linked to a specific binding pair member, and this localises the mass tag to the target/analyte which is the other member of the pair. Specific binding does not require binding to just one molecular species to the exclusion of others, however. Rather it defines that the binding is not-nonspecific, i.e. not a random interaction. An example of an SBP that binds to multiple targets would therefore be an antibody which recognises an epitope that is common between a number of different proteins. Here, binding would be specific, and mediated by the CDRs of the antibody, but multiple different proteins would be detected by the antibody. The common epitopes may be naturally occurring, or the common epitope could be an artificial tag, such as a FLAG tag. Similarly, for nucleic acids, a nucleic acid of defined sequence may not bind exclusively to a fully complementary sequence, but varying tolerances of mismatch can be introduced under the use of hybridisation conditions of a differing stringencies, as would be appreciated by one of skill in the art. Nonetheless, this hybridisation is not non-specific, because it is mediated by homology between the SBP nucleic acid and the target analyte. Similarly, ligands can bind specifically to multiple receptors, a facile example being TNFα which binds to both TNFR1 and TNFR2.

The SBP may comprise any of the following: a nucleic acid duplex; an antibody/antigen complex; a receptor/ligand pair; or an aptamer/target pair. Thus a labelling atom can be attached to a nucleic acid probe which is then contacted with a tissue sample so that the probe can hybridise to complementary nucleic acid(s) therein e.g. to form a DNA/DNA duplex, a DNA/RNA duplex, or a RNA/RNA duplex. Similarly, a labelling atom can be attached to an antibody which is then contacted with a tissue sample so that it can bind to its antigen. A labelling atom can be attached to a ligand which is then contacted with a tissue sample so that it can bind to its receptor. A labelling atom can be attached to an aptamer ligand which is then contacted with a tissue sample so that it can bind to its target. Thus, labelled SBP members can be used to detect a variety of targets in a sample, including DNA sequences, RNA sequences, proteins, sugars, lipids, or metabolites.

The mass-tagged SBP therefore can be a protein or peptide, or a polynucleotide or oligonucleotide.

Examples of protein SBPs include an antibody or antigen binding fragment thereof, a monoclonal antibody, a polyclonal antibody, a bispecific antibody, a multispecific antibody, an antibody fusion protein, scFv, antibody mimetic, avidin, streptavidin, neutravidin, biotin, or a combination thereof, wherein optionally the antibody mimetic comprises a nanobody, affibody, affilin, affimer, affitin, alphabody, anticalin, avimer, DARPin, Fynomer, kunitz domain peptide, monobody, or any combination thereof, a receptor, such as a receptor-Fc fusion, a ligand, such as a ligand-Fc fusion, a lectin, for example an agglutinin such as wheat germ agglutinin.

The peptide may be a linear peptide, or a cyclical peptide, such as a bicyclic peptide. One example of a peptide that can be used is Phalloidin.

A polynucleotide or oligonucleotide generally refers to a single- or double-stranded polymer of nucleotides containing deoxyribonucleotides or ribonucleotides that are linked by 3 ‘−5’ phosphodiester bonds, as well as polynucleotide analogs. A nucleic acid molecule includes, but is not limited to, DNA, RNA, and cDNA. A polynucleotide analog may possess a backbone other than a standard phosphodiester linkage found in natural polynucleotides and, optionally, a modified sugar moiety or moieties other than ribose or deoxyribose. Polynucleotide analogs contain bases capable of hydrogen bonding by Watson-Crick base pairing to standard polynucleotide bases, where the analog backbone presents the bases in a manner to permit such hydrogen bonding in a sequence-specific fashion between the oligonucleotide analog molecule and bases in a standard polynucleotide. Examples of polynucleotide analogs include, but are not limited to xeno nucleic acid (XNA), bridged nucleic acid (BNA), glycol nucleic acid (GNA), peptide nucleic acids (PNAs), yPNAs, morpholino polynucleotides, locked nucleic acids (LNAs), threose nucleic acid (TNA), 2′-0-Methyl polynucleotides, 2′-0-alkyl ribosyl substituted polynucleotides, phosphorothioate polynucleotides, and boronophosphate polynucleotides. A polynucleotide analog may possess purine or pyrimidine analogs, including for example, 7-deaza purine analogs, 8-halopurine analogs, 5-halopyrimidine analogs, or universal base analogs that can pair with any base, including hypoxanthine, nitroazoles, isocarbostyril analogues, azole carboxamides, and aromatic triazole analogues, or base analogs with additional functionality, such as a biotin moiety for affinity binding.

### Antibody SBP Members

In a typical embodiment, the labelled SBP member is an antibody. Labelling of the antibody can be achieved through conjugation of one or more labelling atom binding molecules to the antibody, by attachment of a mass tag using e.g. NHS-amine chemistry, sulfhydryl-maleimide chemistry, or the click chemistry (such as strained alkyne and azide, strained alkyne and nitrone, strained alkene and tetrazine etc.). Antibodies which recognise cellular proteins that are useful for imaging are already widely available for IHC usage, and by using labelling atoms instead of current labelling techniques (e.g. fluorescence) these known antibodies can be readily adapted for use in methods disclosure herein, but with the benefit of increasing multiplexing capability. Antibodies can recognise targets on the cell surface or targets within a cell. Antibodies can recognise a variety of targets e.g. they can specifically recognise individual proteins, or can recognise multiple related proteins which share common epitopes, or can recognise specific post-translational modifications on proteins (e.g. to distinguish between tyrosine and phosphor-tyrosine on a protein of interest, to distinguish between lysine and acetyl-lysine, to detect ubiquitination, etc.). After binding to its target, labelling atom(s) conjugated to an antibody can be detected to reveal the location of that target in a sample.

The labelled SBP member will usually interact directly with a target SBP member in the sample. In some embodiments, however, it is possible for the labelled SBP member to interact with a target SBP member indirectly e.g. a primary antibody may bind to the target SBP member, and a labelled secondary antibody can then bind to the primary antibody, in the manner of a sandwich assay. Usually, however, the method relies on direct interactions, as this can be achieved more easily and permits higher multiplexing. In both cases, however, a sample is contacted with a SBP member which can bind to a target SBP member in the sample, and at a later stage label attached to the target SBP member is detected.

### Nucleic Acid SBPs, and Labelling Methodology Modifications

RNA is another biological molecule which the methods and system disclosed herein are capable of detecting in a specific, sensitive and if desired quantitative manner. In the same manner as described above for the analysis of proteins, RNAs can be detected by the use of a SBP member labelled with an elemental tag that specifically binds to the RNA (e.g. an poly nucleotide or oligonucleotide of complementary sequence as discussed above, including a locked nucleic acid (LNA) molecule of complementary sequence, a peptide nucleic acid (PNA) molecule of complementary sequence, a plasmid DNA of complementary sequence, an amplified DNA of complementary sequence, a fragment of RNA of complementary sequence and a fragment of genomic DNA of complementary sequence). RNAs include not only the mature mRNA, but also the RNA processing intermediates and nascent pre-mRNA transcripts.

In certain embodiments, both RNA and protein are detected using methods of the claimed invention.

To detect RNA, cells in biological samples as discussed herein may be prepared for analysis of RNA and protein content using the methods and system described herein. In certain aspects, cells are fixed and permeabilized prior to the hybridization step. Cells may be provided as fixed and/or pemeabilized. Cells may be fixed by a crosslinking fixative, such as formaldehyde, glutaraldehyde. Alternatively or in addition, cells may be fixed using a precipitating fixative, such as ethanol, methanol or acetone. Cells may be permeabilized by a detergent, such as polyethylene glycol (e.g., Triton X-100), Polyoxyethylene (20) sorbitan monolaurate (Tween-20), Saponin (a group of amphipathic glycosides), or chemicals such as methanol or acetone. In certain cases, fixation and permeabilization may be performed with the same reagent or set of reagents. Fixation and permeabilization techniques are discussed by Jamur et al. in “Permeabilization of Cell Membranes” (Methods Mol. Biol., 2010).

Detection of target nucleic acids in the cell, or “in-situ hybridization” (ISH), has previously been performed using fluorophore-tagged oligonucleotide probes. As discussed herein, mass-tagged oligonucleotides, coupled with ionization and mass spectrometry, can be used to detect target nucleic acids in the cell. Methods of in-situ hybridization are known in the art (see Zenobi et al. “Single-Cell Metabolomics: Analytical and Biological Perspectives,” Science vol. 342, no. 6163, 2013). Hybridization protocols are also described in U.S. Pat. No. 5,225,326 and US Pub. No. 2010/0092972 and 2013/0164750, which are incorporated herein by reference.

Prior to hybridization, cells present in suspension or immobilized on a solid support may be fixed and permeabilized as discussed earlier. Permeabilization may allow a cell to retain target nucleic acids while permitting target hybridization nucleotides, amplification oligonucleotides, and/or mass-tagged oligonucleotides to enter the cell. The cell may be washed after any hybridization step, for example, after hybridization of target hybridization oligonucleotides to nucleic acid targets, after hybridization of amplification oligonucleotides, and/or after hybridization of mass-tagged oligonucleotides.

Cells can be in suspension for all or most of the steps of the method, for ease of handling. However, the methods are also applicable to cells in solid tissue samples (e.g., tissue sections) and/or cells immobilized on a solid support (e.g., a slide or other surface). Thus, sometimes, cells can be in suspension in the sample and during the hybridization steps. Other times, the cells are immobilized on a solid support during hybridization.

Target nucleic acids include any nucleic acid of interest and of sufficient abundance in the cell to be detected by the subject methods. Target nucleic acids may be RNAs, of which a plurality of copies exist within the cell. For example, 10 or more, 20 or more, 50 or more, 100 or more, 200 or more, 500 or more, or 1000 or more copies of the target RNA may be present in the cell. A target RNA may be a messenger NA (mRNA), ribosomal RNA (rRNA), transfer RNA (tRNA), small nuclear RNA (snRNA), small interfering RNA (siRNA), long noncoding RNA (lncRNA), or any other type of RNA known in the art. The target RNA may be 20 nucleotides or longer, 30 nucleotides or longer, 40 nucleotides or longer, 50 nucleotides or longer, 100 nucleotides or longer, 200 nucleotides or longer, 500 nucleotides or longer, 1000 nucleotides or longer, between 20 and 1000 nucleotides, between 20 and 500 nucleotides in length, between 40 and 200 nucleotides in length, and so forth.

In certain embodiments, a mass-tagged oligonucleotide may be hybridized directly to the target nucleic acid sequence. However, hybridization of additional oligonucleotides may allow for improved specificity and/or signal amplification.

In certain embodiments, two or more target hybridization oligonucleotides may be hybridized to proximal regions on the target nucleic acid, and may together provide a site for hybridization of an additional oligonucleotides in the hybridization scheme.

In certain embodiments, the mass-tagged oligonucleotide may be hybridized directly to the two or more target hybridization oligonucleotides. In other embodiments, one or more amplification oligonucleotides may be added, simultaneously or in succession, so as to hybridize the two or more target hybridization oligonucleotides and provide multiple hybridization sites to which the mass-tagged oligonucleotide can bind. The one or more amplification oligonucleotides, with or without the mass-tagged oligonucleotide, may be provided as a multimer capable of hybridizing to the two or more target hybridization oligonucleotides.

While the use of two or more target hybridization oligonucleotides improves specificity, the use of amplification oligonucleotides increases signal. Two target hybridization oligonucleotides are hybridized to a target RNA in the cell. Together, the two target hybridization oligonucleotides provide a hybridization site to which an amplification oligonucleotide can bind. Hybridization and/or subsequent washing of the amplification oligonucleotide may be performed at a temperature that allows hybridization to two proximal target hybridization oligonucleotides, but is above the melting temperature of the hybridization of the amplification oligonucleotide to just one target hybridization oligonucleotide. The first amplification oligonucleotide provides multiple hybridization sites, to which second amplification oligonucleotides can be bound, forming a branched pattern. Mass-tagged oligonucleotides may bind to multiple hybridization sites provided by the second amplification nucleotides. Together, these amplification oligonucleotides (with or without mass-tagged oligonucleotides) are referred to herein as a “multimer”. Thus the term “amplification oligonucleotide” includes oligonucleotides that provides multiple copies of the same binding site to which further oligonucleotides can anneal. By increasing the number of binding sites for other oligonucleotides, the final number of labels that can be found to a target is increased. Thus, multiple labelled oligonucleotides are hybridized, indirectly, to a single target RNA. This is enables the detection of low copy number RNAs, by increasing the number of detectable atoms of the element used per RNA.

One particular method for performing this amplification comprises using the RNAscope® method from Advanced cell diagnostics, as discussed in more detail below. A further alternative is the use of a method that adapts the QuantiGene® FlowRNA method (Affymetrix eBioscience). The assay is based on oligonucleotide pair probe design with branched DNA (bDNA) signal amplification. There are more than 4,000 probes in the catalog or custom sets can be requested at no additional charge. In line with the previous paragraph, the method works by hybridization of target hybridization oligonucleotides to the target, followed by the formation of a branched structure comprising first amplification oligonucleotides (termed preamplification oligonucleotides in the QuantiGene® method) to form a stem to which multiple second amplification oligonucleotides can anneal (termed simply amplification oligonucleotides in the QuantiGene® method). Multiple mass-tagged oligonucleotides can then bind.

Another means of amplification of the RNA signal relies on the rolling circle means of amplification (RCA). There are various means why which this amplification system can be introduced into the amplification process. In a first instance, a first nucleic acid is used as the hybridisation nucleic acid wherein the first nucleic acid is circular. The first nucleic acid can be single stranded or may be double-stranded. It comprises as sequence complementary to the target RNA. Following hybridisation of the first nucleic acid to the target RNA, a primer complementary to the first nucleic acid is hybridised to the first nucleic acid, and used for primer extension using a polymerase and nucleic acids, typically exogenously added to the sample. In some instances, however, when the first nucleic acid is added to sample, it may already have the primer for extension hybridised to it. As a result of the first nucleic acid being circular, once the primer extension has completed a full round of replication, the polymerase can displace the primer and extension continues (i.e. without 5′→3′ exonuclase activity), producing linked further and further chained copies of the complement of the first nucleic acid, thereby amplifying that nucleic acid sequence. Oligonucleotides comprising an elemental tag (RNA or DNA, or LNA or PNA and the like) as discussed above) may therefore be hybridised to the chained copies of the complement of the first nucleic acid. The degree of amplification of the RNA signal can therefore be controlled by the length of time allotted for the step of amplification of the circular nucleic acid.

In another application of RCA, rather than the first, e.g., oligonucleotide that hybridises to the target RNA being circular, it may be linear, and comprise a first portion with a sequence complementary to its target and a second portion which is user-chosen. A circular RCA template with sequence homologous to this second portion may then be hybridised to this the first oligonucleotide, and RCA amplification carried out as above. The use of a first, e.g., oligonucleotide having a target specific portion and user-chosen portion is that the user-chosen portion can be selected so as to be common between a variety of different probes. This is reagent-efficient because the same subsequent amplification reagents can be used in a series of reactions detecting different targets. However, as understood by the skilled person, when employing this strategy, for individual detection of specific RNAs in a multiplexed reaction, each first nucleic acid hybridising to the target RNA will need to have a unique second sequence and in turn each circular nucleic acid should contain unique sequence that can be hybridised by the labelled oligonucleotide. In this manner, signal from each target RNA can be specifically amplified and detected.

Other configurations to bring about RCA analysis will be known to the skilled person. In some instances, to prevent the first, e.g., oligonucleotide dissociating from the target during the following amplification and hybridisation steps, the first, e.g., oligonucleotide may be fixed following hybridisation (such as by formaldehyde).

Further, hybridisation chain reaction (HCR) may be used to amplify the RNA signal (see, e.g., Choi et al., 2010, Nat. Biotech, 28:1208-1210). Choi explains that an HCR amplifier consists of two nucleic acid hairpin species that do not polymerise in the absence of an initiator. Each HCR hairpin consists of an input domain with an exposed single-stranded toehold and an output domain with a single-stranded toehold hidden in the folded hairpin. Hybridization of the initiator to the input domain of one of the two hairpins opens the hairpin to expose its output domain. Hybridization of this (previously hidden) output domain to the input domain of the second hairpin opens that hairpin to expose an output domain identical in sequence to the initiator. Regeneration of the initiator sequence provides the basis for a chain reaction of alternating first and second hairpin polymerization steps leading to formation of a nicked double-stranded ‘polymer’. Either or both of the first and second hairpins can be labelled with an elemental tag in the application of the methods and system disclosed herein. As the amplification procedure relies on output domains of specific sequence, various discrete amplification reactions using separate sets of hairpins can be performed independently in the same process. Thus this amplification also permits amplification in multiplex analyses of numerous RNA species. As Choi notes, HCR is an isothermal triggered self-assembly process. Hence, hairpins should penetrate the sample before undergoing triggered self-assembly in situ, suggesting the potential for deep sample penetration and high signal-to-background ratios

Hybridization may include contacting cells with one or more oligonucleotides, such as target hybridization oligonucleotides, amplification oligonucleotides, and/or mass-tagged oligonucleotides, and providing conditions under which hybridization can occur. Hybridization may be performed in a buffered solution, such as saline sodium-citrate (SCC) buffer, phosphate-buffered saline (PBS), saline-sodium phosphate-EDTA (SSPE) buffer, TNT buffer (having Tris-HCl, sodium chloride and Tween 20), or any other suitable buffer. Hybridization may be performed at a temperature around or below the melting temperature of the hybridization of the one or more oligonucleotides.

Specificity may be improved by performing one or more washes following hybridization, so as to remove unbound oligonucleotide. Increased stringency of the wash may improve specificity, but decrease overall signal. The stringency of a wash may be increased by increasing or decreasing the concentration of the wash buffer, increasing temperature, and/or increasing the duration of the wash. RNAse inhibitor may be used in any or all hybridization incubations and subsequent washes.

A first set of hybridization probes, including one or more target hybridizing oligonucleotides, amplification oligonucleotides and/or mass-tagged oligonucleotides, may be used to label a first target nucleic acid. Additional sets of hybridization probes may be used to label additional target nucleic acids. Each set of hybridization probes may be specific for a different target nucleic acid. The additional sets of hybridization probes may be designed, hybridized and washed so as to reduce or prevent hybridization between oligonucleotides of different sets. In addition, the mass-tagged oligonucleotide of each set may provide a unique signal. As such, multiple sets of oligonucleotides may be used to detect 2, 3, 5, 10, 15, 20 or more distinct nucleic acid targets.

Sometimes, the different nucleic acids detected are splice variants of a single gene. The mass-tagged oligonucleotide can be designed to hybridize (directly or indirectly through other oligonucleotides as explained below) within the sequence of the exon, to detect all transcripts containing that exon, or may be designed to bridge the splice junctions to detect specific variants (for example, if a gene had three exons, and two splice variants—exons 1-2-3 and exons 1-3—then the two could be distinguished: variant 1-2-3 could be detected specifically by hybridizing to exon 2, and variant 1-3 could be detected specifically by hybridizing across the exon 1-3 junction.

### Histochemical Stains

The histochemical stain reagents having one or more intrinsic metal atoms may be combined with other reagents and methods of use as described herein. For example, histochemical stains may be colocalized (e.g., at cellular or subcellular resolution) with metal containing drugs, metal-labelled antibodies, and/or accumulated heavy metals. In certain aspects, one or more histochemical stains may be used at lower concentrations (e.g., less than half, a quarter, a tenth, etc.) from what is used for other methods of imaging (e.g., fluorescence microscopy, light microscopy, or electron microscopy).

To visualize and identify structures, a broad spectrum of histological stains and indicators are available and well characterized. The metal-containing stains have a potential to influence the acceptance of the imaging mass cytometry by pathologists. Certain metal containing stains are well known to reveal cellular components, and are suitable for use in the subject invention. Additionally, well defined stains can be used in digital image analysis providing contrast for feature recognition algorithms. These features are strategically important for the development of imaging mass cytometry.

Often, morphological structure of a tissue section can be contrasted using affinity products such as antibodies. They are expensive and require additional labelling procedure using metal-containing tags, as compared to using histochemical stains. This approach was used in pioneering works on imaging mass cytometry using antibodies labelled with available lanthanide isotopes thus depleting mass (e.g. metal) tags for functional antibodies to answer a biological question.

The subject invention expands the catalog of available isotopes including such elements as Ag, Au, Ru, W, Mo, Hf, Zr (including compounds such as Ruthenium Red used to identify mucinous stroma, Trichrome stain for identification of collagen fibers, osmium tetroxide as cell counterstain). Silver staining is used in karyotyping. Silver nitrate stains the nucleolar organization region (NOR)-associated protein, producing a dark region wherein the silver is deposited and denoting the activity of rRNA genes within the NOR. Adaptation to IMC may require that the protocols (e.g., oxidation with potassium permanganate and a silver concentration of 1% during) be modified for use lower concentrations of silver solution, e.g., less than 0.5%, 0.01%, or 0.05% silver solution.

In certain aspects, two sections of the same tissue (e.g., serial tissue sections) may both be stained by metal containing histochemical stain, and analysed by two or more different imaging modalities. One of these imaging modalities may be atomic mass spectrometry.

Autometallographic amplification techniques have evolved into an important tool in histochemistry. A number of endogenous and toxic heavy metals form sulfide or selenide nanocrystals that can be autocatalytically amplified by reaction with Ag ions. The larger Ag nanocluster can then be readily visualized by IMC. At present, robust protocols for the silver amplified detection of Zn—S/Se nanocrystals have been established as well as detection of selenium through formation of silver-selenium nanocrystals. In addition, commercially available quantum dots (detection of Cd) are also autocatalytically active and may be used as histochemical labels.

Aspects of the subject invention may include histochemical stains and their use in imaging by elemental mass spectrometry. Any histochemical stain resolvable by elemental mass spectrometry may be used in the subject invention. In certain aspects, the histochemical stain includes one or more atoms of mass greater than a cut-off of the elemental mass spectrometer used to image the sample, such as greater than 60 amu, 80 amu, 100 amu, or 120 amu. For example, the histochemical stain may include a metal tag (e.g., metal atom) as described herein. The metal atom may be chelated to the histochemical stain, or covalently bound within the chemical structure of the histochemical stain. In certain aspects, the histochemical stain may be an organic molecule. Histochemical stains may be polar, hydrophobic (e.g., lipophilic), ionic or may comprise groups with different properties. In certain aspects, a histochemical stain may comprise more than one chemical.

Histochemical stains include small molecules of less than 2000, 1500, 1000, 800, 600, 400, or 200 amu. Histochemical stains may bind to the sample through covalent or non-covalent (e.g., ionic or hydrophobic) interactions. Histochemical stains may provide contrast to resolve the morphology of the biological sample, for example, to help identify individual cells, intracellular structures, and/or extracellular structures. Intracellular structures that may be resolved by histochemical stains include cell membrane, cytoplasm, nucleus, Golgi body, ER, mitochondria, and other cellular organelles. Histochemical stains may have an affinity for a type of biological molecule, such as nucleic acids, proteins, lipids, phospholipids or carbohydrates. In certain aspects, a histochemical stain may bind a molecule other than DNA. Suitable histochemical stains also include stains that bind extracellular structures (e.g., structures of the extracellular matrix), including stroma (e.g., mucosal stroma), basement membrane, interstitial stroma, proteins such as collage or elastin, proteoglycans, non-proteoglycan polysaccharides, extracellular vesicles, fibronectin, laminin, and so forth.

In certain aspects, histochemical stains and/or metabolic probes may indicate a state of a cell or tissue. For example, histochemical stains may include vital stains such as cisplatin, eosin, and propidium iodide. Other histochemical stains may stain for hypoxia, e.g., may only bind or deposit under hypoxic conditions. Probes such as Iododeoxyuridine (IdU) or a derivative thereof, may stain for cell proliferation. In certain aspects, the histochemical stain may not indicate the state of the cell or tissue. Probes that detect cell state (e.g., viability, hypoxia and/or cell proliferation) but are administered in-vivo (e.g., to a living animal or cell culture) be used in any of the subject methods but do not qualify as histochemical stains.

Histochemical stains may have an affinity for a type of biological molecule, such as nucleic acids (e.g., DNA and/or RNA), proteins, lipids, phospholipids, carbohydrates (e.g., sugars such as mono-saccharides or di-saccharides or polyols; oligosaccharides; and/or polysaccharides such as starch or glycogen), glycoproteins, and/or glycolipids. In certain aspects the histochemical stain may be a counterstain.

The following are examples of specific histochemical stains and their use in the subject methods:

Ruthenium Red stain as a metal-containing stain for mucinous stroma detection may be used as follows: Immunostained tissue (e.g., de-paraffinized FFPE or cryosection) may be treated with 0.0001-0.5%, 0.001-0.05%, less than 0.1%, less than 0.05%, or around 0.0025% Ruthenium Red (e.g., for at least 5 minutes, at least 10 minutes, at least 30 minutes, or around 30 min at 4-42° C., or around room temperature). The biological sample may be rinsed, for example with water or a buffered solution. Tissue may then be dried before imaging by elemental mass spectrometry.

Phosphotungstic Acid (e.g., as a Trichrome stain) may be used as a metal-containing stain for collagen fibers. Tissue sections on slides (de-paraffinized FFPE or cryosection) may be fixed in Bouin's fluid (e.g., for at least 5 minutes, at least 10 minutes, at least 30 minutes, or around 30 minutes at 4-42° C. or around room temperature). The sections may then be treated with 0.0001%-0.01%, 0.0005%-0.005%, or around 0.001% Phosphotangstic Acid for (e.g., for at least 5 minutes, at least 10 minutes, at least 30 minutes, or around 15 minutes at 4-42° C. or around room temperature). Sample may then be rinsed with water and/or buffered solution, and optionally dried, prior to imaging by elemental mass spectrometry. Triichrome stain may be used at a dilution (e.g., 5 fold, 10 fold, 20 fold, 50 fold or great dilution) compared to concentrations used for imaging by light (e.g., fluorescence) microscopy.

In some embodiments, the histochemical stain is an organic molecule. In some embodiments, the second metal is covalently bound. In some embodiments, the second metal is chelated. In some embodiments, the histochemical stain specifically binds cell membrane. In some embodiments, the histochemical stain is osmium tetroxide. In some embodiments, the histochemical stain is lipophilic. In some embodiments, the histochemical stain specifically binds an extracellular structure. In some embodiments, the histochemical stain specifically binds extracellular collagen. In some embodiments, the histochemical stain is a trichrome stain comprising phosphotungstic/phosphomolybdic acid. In some embodiments, trichrome stain is used after contacting the sample with the antibody, such as at a lower concentration than would be used for optical imaging, for instance wherein the concentration is a 50 fold dilution of trichrome stain or greater.

### Metal-Containing Drugs

Metals in medicine is a new and exciting field in pharmacology. Little is known about the cellular structures that are involved in transiently storing metal ions prior to their incorporation into metalloproteins, nucleic acid metal complexes or metal-containing drugs or the fate of metal ions upon protein or drug degradation. An important first step towards unravelling the regulatory mechanisms involved in trace metal transport, storage, and distribution represents the identification and quantitation of the metals, ideally in context of their native physiological environment in tissues, cells, or even at the level of individual organelles and subcellular compartments. Histological studies are typically carried out on thin sections of tissue or with cultured cells.

A number of metal-containing drugs are being used for treatment of various diseases, however not enough is known about their mechanism of action or biodistribution: cisplatin, ruthenium imidazole, metallocene-based anti-cancer agents with Mo, tungstenocenes with W, B-diketonate complexes with Hf or Zr, auranofin with Au, polyoxomolybdate drugs. Many metal complexes are used as MRI contrast agents (Gd(III) chelates). Characterization of the uptake and biodistribution of metal-based anti-cancer drugs is of critical importance for understanding and minimizing the underlying toxicity.

The atomic masses of certain metals present in drugs fall into the range of mass cytometry. Specifically, cisplatin and others with Pt complexes (iproplatin, lobplatin) are extensively used as a chemotherapeutic drug for treating a wide range of cancers. The nephrotoxicity and myelotoxicity of platinum-based anti-cancer drugs is well known. With the methods and reagents described herein, their subcellular localization within tissue sections, and colocalization with mass- (e.g. metal-) tagged antibodies and/or histochemical stains can now be examined. Chemotherepeutic drugs may be toxic to certain cells, such as proliferating cells, through direct DNA damage, inhibition of DNA damage repair pathways, radioactivity, and so forth. In certain aspects, chemotherapeutic drugs may be targeted to tumor through an antibody intermediate.

In certain aspects, the metal containing drug is a chemotherapeutic drug. Subject methods may include administering the metal containing drug to a living animal, such as an animal research model or human patient as previously described, prior to obtaining the biological sample. The biological sample may be, for example, a biopsy of cancerous tissue or primary cells. Alternatively, the metal containing drug may be added directly to the biological sample, which may be an immortalized cell line or primary cells. When the animal is a human patient, the subject methods may include adjusting a treatment regimen that includes the metal containing drug, based on detecting the distribution of the metal containing drug.

The method step of detecting the metal containing drug may include subcellular imaging of the metal containing drug by elemental mass spectrometry, and may include detecting the retention of the metal containing drug in an intracellular structure (such as membrane, cytoplasm, nucleus, Golgi body, ER, mitochondria, and other cellular organelles) and/or extracellular structure (such as including stroma, mucosal stroma, basement membrane, interstitial stroma, proteins such as collage or elastin, proteoglycans, non-proteoglycan polysaccharides, extracellular vesicles, fibronectin, laminin, and so forth).

A histochemical stain and/or mass- (e.g. metal-) tagged SBP that resolves (e.g., binds to) one or more of the above structures may be colocalized with the metal containing drug to detected retention of the drug at specific intracellular or extracellular structures. For example, a chemotherapeutic drug such as cisplatin may be colocalized with a structure such as collagen. Alternatively or in addition, the localization of the drug may be related to presence of a marker of cell viability, cell proliferation, hypoxia, DNA damage response, or immune response.

In some embodiments, the metal containing drug comprises a non-endogenous metal, such as wherein the non-endogenous metal is platinum, palladium, cerium, cadmium, silver or gold. In certain aspects, the metal containing drug is one of cisplatin, ruthenium imidazole, metallocene-based anti-cancer agents with Mo, tungstenocenes with W, B-diketonate complexes with Hf or Zr, auranofin with Au, polyoxomolybdate drugs, N-myristoyltransferase-1 inhibitor (Tris(dibenzylideneacetone) dipalladium) with Pd, or a derivative thereof. For example the drug may comprise Pt, and may be, for example, cisplatin, carboplatin, oxaliplatin, iproplatin, lobaplatin or a derivative thereof. The metal containing drug may include a non-endogenous metal, such as platinum (Pt), ruthenium (Ru), molybdenum (Mo), tungsten (W), hafnium (Hf), zirconium (Zr), gold (Au), gadolinium (Gd), palladium (Pd) or an isotope thereof. Gold compounds (Auranofin, for example) and gold nanoparticle bioconjugates for photothermal therapy against cancer can be identified in tissue sections.

### Multiplexed Analysis

One feature of the disclosure is its ability to detect multiple (e.g. 10 or more, and even up to 100 or more) different target SBP members in a sample e.g. to detect multiple different proteins and/or multiple different nucleic acid sequences. To permit differential detection of these target SBP members their respective SBP members should carry different labelling atoms such that their signals can be distinguished. For instance, where ten different proteins are being detected, ten different antibodies (each specific for a different target protein) can be used, each of which carries a unique label, such that signals from the different antibodies can be distinguished. In some embodiments, it is desirable to use multiple different antibodies against a single target e.g. which recognise different epitopes on the same protein. Thus, a method may use more antibodies than targets due to redundancy of this type. In general, however, the disclosure will use a plurality of different labelling atoms to detect a plurality of different targets.

If more than one labelled antibody is used with the disclosure, it is preferable that the antibodies should have similar affinities for their respective antigens, as this helps to ensure that the relationship between the quantity of labelling atoms detected and the abundance of the target antigen in the tissue sample will be more consistent across different SBPs (particularly at high scanning frequencies). Similarly, it is preferable if the labelling of the various antibodies has the same efficiency, so that the antibodies each carry a comparable quantity of the labelling atom.

In some instances, the SBP may carry a fluorescent label as well as an elemental tag. Fluorescence of the sample may then be used to determine regions of the sample, e.g. a tissue section, comprising material of interest which can then be sampled for detection of labelling atoms. E.g. a fluorescent label may be conjugated to an antibody which binds to an antigen abundant on cancer cells, and any fluorescent cell may then be targeted to determine expression of other cellular proteins that are about by SBPs conjugated to labelling atoms.

If a target SBP member is located intracellularly, it will typically be necessary to permeabilize cell membranes before or during contacting of the sample with the labels. For example, when the target is a DNA sequence but the labelled SBP member cannot penetrate the membranes of live cells, the cells of the tissue sample can be fixed and permeabilised. The labelled SBP member can then enter the cell and form a SBP with the target SBP member. In this respect, known protocols for use with IHC and FISH can be utilised.

A method may be used to detect at least one intracellular target and at least one cell surface target. In some embodiments, however, the disclosure can be used to detect a plurality of cell surface targets while ignoring intracellular targets. Overall, the choice of targets will be determined by the information which is desired from the method, as the disclosure will provide an image of the locations of the chosen targets in the sample.

As described further herein, specific binding partners (i.e., affinity reagents) comprising labelling atoms may be used to stain (contact) a biological sample. Suitable specific binging partners include antibodies (including antibody fragments). Labelling atoms may be distinguishable by mass spectrometry (i.e., may have different masses). Labelling atoms may be referred to herein as metal tags when they include one or more metal atoms. Metal tags may include a polymer with a carbon backbone and a plurality of pendant groups that each bind a metal atom. Alternatively, or in addition, metal tags may include a metal nanoparticle. Antibodies may be tagged with a metal tag by a covalent or non-covalent interaction.

Antibody stains may be used to image proteins at cellular or subcellular resolution. Aspects of aspects of the invention include contacting the sample with one or more antibodies that specifically bind a protein expressed by cells of the biological sample, wherein the antibody is tagged with a first metal tag. For example, the sample may be contacted with 5 or more, 10 or more, 15 or more, 20 or more, 30 or more, 40 or more, 50 or more antibodies, each with a distinguishable metal tag. The sample may further be contacted with one or more histochemical stains before, during (e.g., for ease of workflow), or after (e.g., to avoid altering antigen targets of antibodies) staining the sample with antibodies. The sample may further comprise one or more metal containing drugs and/or accumulated heavy metals as described herein.

Metal tagged antibodies for use in the subject inventions may specifically bind a metabolic probe that does not comprise a metal (e.g., EF5). Other metal tagged antibodies may specifically bind a target (e.g., of epithelial tissue, stromal tissue, nucleus, etc.) of traditional stains used in fluorescence and light microscopy. Such antibodies include anti-cadherin, anti-collagen, anti-keratin, anti-EFS, anti-Histone H3 antibodies, and a number of other antibodies known in the art.

### Single Cell Analysis

Methods of the disclosure include laser ablation of multiple cells in a sample, and thus plumes from multiple cells are analysed and their contents are mapped to specific locations in the sample to provide an image. In most cases a user of the method will need to localise the signals to specific cells within the sample, rather than to the sample as a whole. To achieve this, the boundaries of cells (e.g. the plasma membrane, or in some cases the cell wall) in the sample can be demarcated.

Demarcation of cellular boundaries can be achieved in various ways. For instance, a sample can be studied using conventional techniques which can demarcate cellular boundaries, such as microscopy as discussed above. When performing these methods, therefore, an analysis system comprising a camera as discussed above is particularly useful. An image of this sample can then be prepared using a method of the disclosure, and this image can be superimposed on the earlier results, thereby permitting the detected signals to be localised to specific cells. Indeed, as discussed above, in some cases the laser ablation may be directed only to a subset of cells in the sample as determined to be of interest by the use of microscopy based techniques.

To avoid the need to use multiple techniques, however, it is possible to demarcate cellular boundaries as part of the imaging method of the disclosure. Such boundary demarcation strategies are familiar from IHC and immunocytochemistry, and these approaches can be adapted by using labels which can be detected. For instance, the method can involve labelling of target molecule(s) which are known to be located at cellular boundaries, and signal from these labels can then be used for boundary demarcation. Suitable target molecules include abundant or universal markers of cell boundaries, such as members of adhesion complexes (e.g. β-catenin or E-cadherin). Some embodiments can label more than one membrane protein in order to enhance demarcation.

In addition to demarcating cell boundaries by including suitable labels, it is also possible to demarcate specific organelles in this way. For instance, antigens such as histones (e.g. H3) can be used to identify the nucleus, and it is also possible to label mitochondrial-specific antigens, cytoskeleton-specific antigens, Golgi-specific antigens, ribosome-specific antigens, etc., thereby permitting cellular ultrastructure to be analysed by methods of the disclosure.

Signals which demarcate the boundary of a cell (or an organelle) can be assessed by eye, or can be analysed by computer using image processing. Such techniques are known in the art for other imaging techniques e.g. reference ¹⁵ describes a segmentation scheme that uses spatial filtering to determine cell boundaries from fluorescence images, reference ¹⁶ discloses an algorithm which determines boundaries from brightfield microscopy images, reference ¹⁷ discloses the CellSeT method to extract cell geometry from confocal microscope images, and reference ¹⁸ discloses the CellSegm MATLAB toolbox for fluorescence microscope images. A method which is useful with the disclosure uses watershed transformation and Gaussian blurring. These image processing techniques can be used on their own, or they can be used and then checked by eye. [¹⁵] Arce et al. (2013) Scientific Reports 3, article 2266.[¹⁶] Ali et al. (2011) Mach Vis Appl 23:607-21.[¹⁷] Pound et al. (2012) The Plant Cell 24:1353-61.[¹⁸] Hodneland et al. (2013) Source Code for Biology and Medicine 8:16.

Once cellular boundaries have been demarcated it is possible to allocate signal from specific target molecules to individual cells. It can also be possible to quantify the amount of a target analyte(s) in an individual cell e.g. by calibrating the methods against quantitative standards.

### Element Standard

In certain aspects, a sample carrier may include an element standard. Methods of the subject disclosure may include applying an element standard to a sample carrier. Alternatively, or in addition, methods of the present disclosure may include performing calibration based on the element standard and/or normalizing data obtained from the sample based on the element standard, as discussed further herein. Sample carriers and methods including an element standard may further include additional aspects or steps described elsewhere in the present disclosure.

An element standard may include particles (e.g., polymer beads) comprising known quantities of a plurality of isotopes. In certain aspects, the particles may have different sizes, each comprising quantities of a plurality of isotopes. The particles may be applied to the support holding a sample. For example, when the sample is a cell smear, element standard particles may be applied to the support (e.g., alongside the cell smear).

When the element standard comprises distinct particles as described herein, the subject systems and methods may allow for scanning a laser across the surface of the particle to provide a continuous plume for analysis by ICP-MS. All of a particle may be acquired in this way, providing an integrated signal from a particle that has a known quantity of a plurality of isotopes. The signal acquired from a particle can be integrated over time and used for normalization or calibration as described herein.

Depending on the system and application, instrument sensitivity drift can be caused by a number of factors including ion optics drift, surface charging, detector drift (e.g., aging), temperature and gas flows drifts affecting diffusion, and electronics behaviour (e.g., plasma power, ion optics voltages, etc). Such instrument sensitivity can be accommodated by normalizing or calibrating using an element standard as described herein.

The element standard may include particles, film and/or a polymer that comprise one or more elements or isotopes. The element standard may include a consistent abundance of the elements or isotopes across the element standard. Alternatively, the element standard may include separate regions, each with a different amount of the one or more elements or isotopes (e.g., providing a standard curve). Different regions of the element standard may comprise a different combination of elements or isotopes.

As described herein, elemental standard particles (i.e., reference particles) of known elemental or isotopic composition may be added to the sample (or the sample support or sample carrier) for use as a reference during detection of target elemental ions in the sample. In certain embodiments, reference particles comprise metal elements or isotopes, such as transition metals or lanthanides. For example, reference particles may comprise elements or isotopes of mass greater than 60 amu, greater than 80 amu, greater than 100 amu, or greater than 120 amu. The quantity of the one or more elements or isotopes may be known. For example, the standard deviation of the number of atoms in reference particles of the same elemental or isotopic composition may be 50%, 40%, 30%, 20% or 10% of the average number of atoms.

In certain embodiments, the reference particles may be optically resolvable (e.g., may include one or more fluorophores).

In certain embodiments, reference particles may include elements or elemental isotopes with masses above 100 amu (e.g., elements in the lanthanide or transition element series). Alternatively, or in addition, reference particles may include a plurality of elements or elemental isotopes. For example, the reference particles may include elements or elemental isotopes that are identical to elements or elemental isotope of all, some or none of the labelling atoms in the sample. Alternatively, reference particles may include elements or elemental isotopes of masses above and below the masses of at least one of the labelling atoms. The reference particles may have a known quantity of one or more elements or isotopes. The reference particles may include reference particles with different elements or isotopes, or a different combination of elements or isotopes, than the target elements.

Element standard particles (i.e., reference particles) may have a similar diameter range as particles described generally herein, such as diameter at or between 1 nm and 1 um, between 10 nm and 500 nm, between 20 nm and 200 nm, between 50 nm and 100 nm, less than 1 um, less than 800 nm, less than 600 nm, less than 400 nm, less than 200 nm, less than 100 nm, less than 50 nm, less than 20 nm, less than 10 nm, or less than 1 nm. In certain aspects, the element standard particles may be nanoparticles. Elemental standard particles may have a similar composition as particles described generally herein, e.g., may have a metallic nanocrystal core and/or polymer surface.

Aspects of the invention include methods, samples and reference particles for normalization during a sample run by imaging mass spectrometry. Normalization may be performed by detection of individual reference particles. The reference particle may be used as a standard in imaging mass spectrometry, to correct for instrument sensitivity drift during the imaging of a sample, for example, according to any of the aspects of embodiments described below.

In certain aspects, a method of imaging mass spectrometry of a sample includes providing a sample on a solid support, where the sample includes one or more target elements, and where reference particles are distributed on or within the sample such that a plurality of the reference particles are individually resolvable. Ionizing and atomizing locations on the sample may be performed to produce target elemental ions and reference particle elemental ions. The target elemental ions and elemental ions from individual reference particles may be detected (e.g., at different locations on the sample). Target elemental ions may be normalized elemental ions of one or more individual reference particles detected in proximity to the detected target elemental ions. Alternatively or in addition, target elemental ions detected at a first and second location may be normalized to elemental ions detected from different individual reference particles. An image of the normalized target elemental ions may then be generated by any means known in the art or described herein.

Aspects of the invention include a biological sample on a solid support including a plurality of specific binding partners attached (e.g., covalently or non-covalently) to labelling atoms (e.g., to elemental tags that include labelling atoms). The biological sample may further include reference particles distributed on or within the biological sample on the solid support, such that a plurality of the reference particles are individually resolvable.

Aspects of the invention include preparing such a biological sample by providing a sample on a solid support, wherein the sample is a biological sample on a solid support, labelling the biological sample with specific binding partners attached to labelling atoms, and distributing reference particles on or within the biological sample, such that a plurality of the reference particles are individually resolvable. In certain aspects the sample is a biological sample may include one or more target elements, such as labelling atoms as described herein.

Aspects of the invention include the use of a reference particle, or a composition of reference particles, as a standard in imaging mass spectrometry to correct for instrument sensitivity drift during the imaging of a sample. In certain aspects the sample is a biological sample may include one or more target elements, such as labelling atoms as described herein.

The methods and uses described above may include additional elements, as described below.

The element standard may be deposited on or in a sample or a portion thereof. Alternatively, or in addition, the element standard may be at a position on the sample carrier distinct from a sample, or distinct from where a sample is to be placed.

In another example, elemental standard particles detected within temporal proximity of a portion of the sample, such as within 6 hours, 3 hours, 1 hour, 30 minutes, 10 minutes, 1 minute, 30 second, 10 seconds, 1 second, 500 us, 100 us, 50 us or 10 us, or within a certain number of laser or ion beam pulses (such as within 1000 pulses, 500 pulses, 100 pulses, or 50 pulses) from the detection of target elemental ions may be used to for normalization or calibration.

Target elements, such as labelling atoms, can be normalized within a sample run based on elemental ions detected from individual reference particles. For example, the subject methods may include switching between detecting elemental ions from individual reference particles and detecting only target elemental ions.

Target elemental ions may be detected as an intensity value, such as the area under an ion peak or the number of ion events (pulses) within the same mass channel. In certain embodiments, detected target elemental ions may be normalized to elemental ions detected from individual reference particles. In certain embodiments, target elemental ions in different locations are normalized to different reference particles during the same sample run.

Normalization may include quantification of target elemental ions. In embodiments where the reference particle has a known quantity of one or more elements or isotopes (e.g., with a certain degree of certainty, as described above), the signal detected from elemental ions from the reference particle can be used to quantify target elemental ions.

Normalization to reference particles during a sample run may compensate for instrument sensitivity drift, in which the same number of target elements at different locations may be detected differently. Depending on the system and application, instrument sensitivity drift can be caused by a number of factors including ion optics drift, surface charging, detector drift (e.g., aging), temperature and gas flows drifts affecting diffusion, and electronics behaviour (e.g., plasma power, ion optics voltages, etc).

Aspects of the invention include an element film, or multiple element films, that may be applied to or present on a support, such as a sample carrier, as an element standard. The element film may be an adhesive element film and or a polymer film. In certain embodiments, the element film may comprise a polymer (e.g., plastic) layer that can be mounted on a support. The support may be a sample slide, as described herein. In other embodiments, the element film may be pre-printed on a sample slide. As discussed herein, the sample slide may have one or more regions for binding cells and/or free analyte in a sample.

In certain aspects, the polymer film may be a polyester plastic film. The polymer may be a long chain polymer that, when mixed with a metal solution and volatile solvent, may create a film entrapping the metal after the solvent is evaporated. For example, the polymer film may be a poly(methyl methacrylate) polymer, and the solvent may be toluene. The polymer may be spin coated to allow for even distribution.

The element film may comprise at least 1, 2, 3, 4, 5, 10, or 20 different elements. The element film may comprise at least 1, 2, 3, 4, 5, 10, 20, 30, 40, or 50 different elemental isotopes. The elements or elemental isotopes may include metals, such as lanthanides and/or transition elements. Some or all of the elemental isotopes may have masses of 60 amu or higher, 70 amu or higher, 80 amu or higher, 90 amu or higher, or 100 amu or higher. In certain embodiments, the element film may comprise elements, elemental isotopes, or elemental isotope masses identical to one or more labelling atoms. For example, the element film may comprise mass tags identical to those used to tag sample on the same support. The element film may comprise elemental atoms bound to a polymer (either covalently or by chelation), or may comprise elemental atoms (either free, in clusters, or chelated) bound directly to the film. The element film may comprise an even coating of the elements or elemental isotopes across its surface, although individual isotopes may be present at the same or different amounts. Alternatively, different amounts of the same isotope may be patterned with a known distribution across the surface of the film. The element film may be at least 0.01, 0.1, 1, 10, or 100 square millimeters.

In certain aspects, the element film may be applied to a sample slide after tagging with mass tags (and potentially after washing of unbound mass tags). This may reduce cross contamination of sample from the element film. For example, use of the element film may result in less than 50%, 25%, 10%, or 5% increase in background during sample acquisition. The background may be the signal intensity of one or more (e.g., the majority of) the masses of isotopes present in the element film.

In certain aspects, the average number (or mean intensities) of each elemental isotope (or the majority of elemental isotopes) across the element film may have a coefficient of variation (CV) of less than 20%, less than 15%, less than 10%, or less than 5% or 2%. For example, the CV may be less than 6%. The CV may be measured across at least 2, 5, 10, 20, or 40 regions of interest, where each region is at least 100, 500, 1,000, 5,000, or 10,000 square micrometers. Similarly, the CV of the average number (or mean intensities) of each elemental isotope (or the majority of elemental isotopes) between element films may be less than 20%, 15%, 10%, 5%, or 2%.

The element film may be used for tuning, signal normalization and/or quantitation of labelling atoms (e.g., within a sample run and/or between sample runs). For example, the element film may be used throughout a long sample run (e.g., of more then 1, 2, 4, 12, 24, or 48 hours).

In certain aspects, the adhesive element film may be used to tune the system before sample acquisition, between acquiring sample from different regions (or at different times) on a single solid support, or both. During tuning, the adhesive element film may be subjected to laser ablation, and the resulting ablation plume (e.g., transient) may be transferred to a mass detector as described herein. The spatial resolution, transients cross talk, and/or signal intensity (e.g., number of ion counts over one or more pushes, such as across all pushes in a given transient) may then be read out. One or more parameters may be adjusted based on the readout. Such parameters may include gas flow (e.g., sheath, carrier, and/or makeup gas flow), voltage (e.g., voltage applied to an amplifier or ion detector), and/or optical parameters (e.g., ablation frequency, ablation energy, ablation distance, etc.). For example, the voltage applied to an ion detector may be adjusted such that the signal intensity returns to an expected value (e.g., pre-set value or value obtained from an earlier signal intensity obtained from the same, or similar, adhesive element film).

In certain aspects, the adhesive element film may be used to normalize signal intensity from labelling atoms detected between samples on different solids supports, from labelling atoms detected between regions (or at different times) from a sample on a single solid support, or both. Normalization is performed after sample acquisition, and allows for comparison of signal intensities obtained from different samples, regions, times or operating conditions. Signal intensities (e.g., ion count) acquired from a given elemental isotope (e.g., associated with a mass tag) of a sample or region thereof may be normalized to the signal intensity of the same (or similar) elemental isotope(s) acquired from element film in close spatial or temporal proximity. For example, element film within spatial proximity, such as within 100 um, 50 um, 25 um, 10 um or 5 um of the detected target elemental ions may be used for normalization. In another example, element film detected within temporal proximity such as within 1 minute, 30 second, 10 seconds, 1 second, 500 us, 100 us, 50 us or 10 us, or within a certain number of laser or ion beam pulses (such as within 1000 pulses, 500 pulses, 100 pulses, or 50 pulses) from the detection of target elemental ions may be used to for normalization.

Normalization may include quantification of target elemental ions (e.g., ionized elemental isotopes). In embodiments where the element film has a known quantity of one or more elements or isotopes (e.g., with a certain degree of certainty, as described above), the signal detected from elemental ions from the element film can be used to quantify target elemental ions.

Normalization to element film during a sample run may compensate for instrument sensitivity drift, in which the same number of target elements at different locations may be detected differently. Depending on the system and application, instrument sensitivity drift can be caused by a number of factors including ion optics drift, surface charging, detector drift (e.g., aging), temperature and gas flows drifts affecting diffusion, and electronics behaviour (e.g., plasma power, ion optics voltages, etc). Alternatively or in addition to normalization, parameters affecting the above instrument sensitivity drift factors may be adjusted based on the signal acquired from the element film.

As described below, an elemental (e.g., elemental isotope) standard may be used to generate a standard curve to quantify the amount of mass tags (e.g., number of labelling atoms) or the number of an analyte bound by a given mass tag. Multiple element films (or multiple regions of a single element film) with different known amounts of an element or elemental isotope may be used to generate such a standard curve.

In certain embodiments, the elemental film may be a metal-containing standard on an adhesive tape. This tape can be applied to a stained tissue slide when long image acquisition. These long acquisitions can benefit from periodic sampling to acquire data for active surveillance of instrument performance. This further enables standardization and/or normalization for longitudinal studies.

As described herein, an elemental standard may include reference particles of known elemental or isotopic composition may be added to the sample (or the sample carrier) for use as a reference during detection of target elemental ions in the sample. In certain embodiments, reference particles comprise metal elements or isotopes, such as transition metals or lanthanides. For example, reference particles may comprise elements or isotopes of mass greater than 60 amu, greater than 80 amu, greater than 100 amu, or greater than 120 amu.

Target elements, such as labelling atoms, can be normalized within a sample run based on elemental ions detected from individual reference particles. For example, the subject methods may include switching between detecting elemental ions from individual reference particles and detecting only target elemental ions.

### Pre-Analysis Sample Expansion Using Hydrogels

Conventional light microscopy is limited to approximately half the wavelength of the source of illumination, with a minimum possible resolution of about 200 nm. Expansion microscopy is a method of sample preparation (in particular for biological samples) that uses polymer networks to physically expand the sample and so increase the resolution of optical visualisation of a sample to around 20 nm (WO2015127183). The expansion procedures can be used to prepare samples for imaging mass spectrometry and imaging mass cytometry. By this process, a 1 μm ablation spot diameter would provide a resolution of 1 μm on an unexpanded sample, but with this 1 μm ablation spot represents—100 nm resolution following expansion.

Expansion microscopy may provide enlarged samples in which individual cells (or another feature) in an adherent tissue may be separately sampled by laser scanning systems and methods described herein.

Expansion microscopy of biological samples generally comprises the steps of: fixation, preparation for anchoring, gelation, mechanical homogenization, and expansion.

In the fixation stage, samples chemically fixed and washed. However, specific signalling functions or enzymatic functions such as protein-protein interactions as a function of physiological state can be examined using expansion microscopy without a fixation step.

Next, the samples are prepared so that they can be attached (“anchored”) to the hydrogel formed in the subsequent gelation step. Here, SBPs as discussed elsewhere herein (e.g. an antibody, nanobody, non-antibody protein, peptide, nucleic acid and/or small molecule that can specifically bind to target molecules of interest in the sample) are incubated with the sample to bind to the targets if present in the sample. Optionally, samples can be labelled (sometimes termed ‘anchored’) with a detectable compound useful for imaging. For optical microscopy, the detectable compound could comprise, for example, be provided by a fluorescently labelled antibody, nanobody, non-antibody protein, peptide, nucleic acid and/or small molecule that can specifically bind to target molecules of interest in the sample (US2017276578). For mass cytometry, including imaging mass cytometry, the detectable label could be provided by, for example, an elemental tag labelled antibody, nanobody, non-antibody protein, peptide, nucleic acid and/or small molecule that can specifically bind to target molecules of interest in the sample. In some instances, the SBP binding to the target does not contain a label but instead contains a feature that can be bound by a secondary SBP (e.g. a primary antibody that binds to the target and a secondary antibody that binds to the primary antibody, as common in immunohistochemical techniques). If only a primary SBP is used, this may itself be linked to a moiety that attaches or crosslinks the sample to the hydrogel formed in the subsequent gelation step so that the sample can be tethered to the hydrogel. Alternatively, if a secondary SBP is used, this may contain the moiety that attaches or crosslinks the sample to the hydrogel. In some instances, a third SBP is used, which binds to the secondary SBP. One exemplary experimental protocol is set out in Chen et al., 2015 (Science 347: 543-548) uses a primary antibody to bind to the target, a secondary antibody that binds to the primary antibody wherein the secondary antibody is attached to an oligonucleotide sequence, and then as a tertiary SBP a oligonucleotide complementary to the sequence attached to the secondary antibody, wherein the tertiary SBP comprised a methacryloyl group that can be incorporated into an acrylamide hydrogel. In some instances, the SBP comprising the moiety that is incorporated into the hydrogel also includes a label. These labels can be fluorescent labels or elemental tags and so used in subsequent analysis by, for example, flow cytometry, optical scanning and fluorometry (US2017253918), or mass cytometry or imaging mass cytometry.

The gelation stage generates a matrix in the sample, by infusing a hydrogel comprising densely cross-linked, highly charged monomers into the sample. For example, sodium acrylate along with the comonomer acrylamide and the crosslinker N—N′methylenebisacrylamide have been introduced into fixed and permeablised brain tissue (see Chen et al., 2015). When the polymer forms, it incorporates the moiety linked to the targets in the anchoring step, so that the targets in the sample become attached to the gel matrix.

The sample is then treated with a homogenizing agent to homogenize the mechanical characteristics of the sample so that the sample does not resist expansion (WO2015127183). For example, the sample can be homogenised by degradation with an enzyme (such as a protease), by chemical proteolysis, (e.g. by cyanogen bromide), by heating of the sample to 70-95 degrees Celsius, or by physical disruption such as sonication (US2017276578).

The sample/hydrogel composite is then expanded by dialyzing the composite in a low-salt buffer or water to allow the sample to expand to 4× or 5× its original size in 3-dimensions. As the hydrogel expands, so does the sample and in particular the labels attached to targets and the hydrogel expand, while maintaining their original three dimensional arrangement of the labels. Since the samples expand are expanded in low-salt solutions or water, the expanded samples are clear, allowing optical imaging deep into the samples, and allow imaging without introduction of significant levels of contaminating elements when performing mass cytometry (e.g. by use of distilled water or purified by other processes including capacitive deionization, reverse osmosis, carbon filtering, microfiltration, ultrafiltration, ultraviolet oxidation, or electrodeionization).

The expanded sample can then be analysed by imaging techniques, providing pseudo-improved resolution. For example, fluorescence microscopy can be used with fluorescent labels, and imaging mass cytometry can be used with elemental tags, optionally in combination. Due to the swelling of the hydrogel and the concomitant increase in distance between labels in the expanded sample vis-à-vis the native sample, labels which were not capable of being resolved separately previously (be that due to diffraction limit of visible light in optical microscopy, or spot diameter in IMC).

Variants of expansion microscopy (ExM) exist, which can also be applied using the system and methods disclosed herein. These variants include: protein retention ExM (proExM), expansion fluorescent in situ hybridisation (ExFISH), iterative ExM (iExM), Iterative expansion microscopy involves forming a second expandable polymer gel in a sample that has already undergone a preliminary expansion using the above techniques. The first expanded gel is dissolved and the second expandable polymer gel is then expanded to bring the total expansion to up to ˜20×. For instance, Chang et al., 2017 (Nat Methods 14:593-599) base the technique on the method of Chen et al. 2015 discussed above, with the substitution that the first gel is made with a cleavable cross linker (e.g., the commercially available crosslinker N,N′-(1,2-dihydroxyethylene) bisacrylamide (DHEBA), whose diol bond can be cleaved at high pH). Following anchoring and expansion of the first gel, a labelled oligonucleotide (comprising a moiety for incorporation into a second gel) and complementary to the oligonucleotide incorporated into the first gel was added to the expanded sample. A second gel was formed incorporating the moiety of the labelled oligonucleotide, and the first gel was broken down by cleavage of the cleavable linker. The second gel was then expanded in the same manner as the first, resulting in further spatial separation of the labels, but maintaining their spatial arrangement with respect to the arrangement of the targets in the original sample. In some instances, following expansion of the first gel, an intermediate “re-embedding gel” is used, to hold the expanded first gel in place while the experimental steps are undertaken, e.g., to hybridise the labelled SBP to the first gel matrix, form the unexpanded second hydrogel, before the first hydrogel and the re-embedding gel are broken down to permit the expansion of the second hydrogel. As before the labels used can be fluorescent or elemental tags and so used in subsequent analysis by, for example, flow cytometry, optical scanning and fluorometry, or mass cytometry or imaging mass cytometry, as appropriate.

### Additional High Throughput Sample Handling

An automated sample introduction system, such as a robotic arm, has been described above as a form of high throughput sample handling. Alternatively or in addition, other forms of high throughput sample handling such as array tomography and automated staining may be implemented for imaging (e.g., for IMC) as described below.

### Resin Embedding and Array Tomography

In certain aspects, serial sections of embedded tissue samples may be arrayed (e.g., on a single slide), in a process called array tomography. Such sections may be compatible with an array of imaging modalities described herein, including forms of fluorescence microscopy, electron microscopy, and/or imaging mass cytometry. In certain aspects, individual sections may be imaged by non-destructive means such as fluorescence and/or electron microscopy, before imaging by IMC.

Hard resins, such as the BMMA sample resin described herein, may be embedded upstream of Array Tomography for 3D IMC, e.g., in which serial sections are imaged by IMC and computationally stacked. Array tomography may provide ultrathin sections for Super Resolution IMC with a spot size (pixel size) less than 500 nm, less than 400 nm, less than 300 nm, or less than 200 nm. Alternatively or in addition, Array tomography may allow for higher throughput analysis of a same, 3D reconstruction, and/or use of different staining panels across serial sections that use the same mass tags for different SBPs (thereby increasing multiplexity).

Aspects of the application may include a sample, preparation of a sample, and or analysis of a sample as described herein. Also contemplated are kits comprising any combination of reagents used for sample preparation and/or analysis. For example, kits may include resin embedding reagents and/or array tomography equipment, in addition to mass tagged SBPs.

In certain aspects, a tissue sample may be embedded with a polymer resin (e.g., a “hard” polymer resin). Compared to FFPE (formalin fixed paraffin embedded) samples and other soft embedding sample preparations, embedding in a hard polymer resin allows for thinner sectioning, which has a number of benefits described herein.

The polymer resin may be an epoxy resin. However, epoxy resins may be less suitable for labelling with SBPs, as target epitopes may be damaged. Epoxy forms covalent bonds with biological materials such as proteins, which reduce exposure of epitopes. That said, epoxy preserves of structural details of the sample, that are stable to EM imaging. Ultrathin sectioning may allow for exposure of epitopes for binding by mass tagged SBPs. Epoxy may be cured at high temperatures (e.g., above 50 degrees Celsius), and may be deplasticized with reagents such as sodium ethoxide, which may damage SBP targets. In certain aspects, an epoxy resin may be a Spurr resin or an Araldite resin (a modified epoxy).

The polymer resin may be an acrylic resin, or a derivative thereof. Acrylic resins are less common than epoxy resins, but offer a number of advantages for IMC. In acrylic resin embedding, free radicals react with double bonds of the acrylic monomer, and a new radical, which is one monomer larger, is produced. Monomers will continue to be added in this way and the polymer grows larger until its growth is terminated. The free radicals may have little or no affinity for proteins and nucleic acids, and therefore biomolecules of interest may not incorporated into the polymer network, allowing SBPs to bind to their targets.

An acrylic resin may be a polyhydroxy-aromatic acrylic resin, such as LR White or LR Gold, which has low viscosity and is well suited for immunostaining. However, LR White is resistant to de-plasticization by an organic solvent, and thermal curing at high temperature may be required, either or both of which may reduce SBP binding to targets. Further, low SBP (e.g., antibody) penetration may result in need for ultrathin (e.g., less than 200 nm thick) sections.

An acrylic resin may be a lowicryl (low viscosity at low temperature) resin. Such resins may have highly cross-linked acrylate and methacrylate based media, low viscosity at low temperature and may have a low freezing point (e.g., less than minus 60 degrees Celsius, such as minus 80 degrees Celsius).

An acrylic resin may be a Methyl methacrylate (MMA) resin, such as Butyl-methylmethacrylate (BMMA). BMMA is versatile polymer with variable hardness, such that it may be used for a variety of imaging modalities. BMMA may be cured at low temperatures under UV light. It is soluble in ethanol and acetone, allowing for gentle deplaticization that leaves more SBP targets (e.g., epitopes) intact. BMMA embedded resin may be sectioned at ultrathin and/or thick sections. For example, an ultrathin section may be at or less than 250 nm, 200 nm, 150 nm, 100 nm, or 50 nm in thickness. A thick section may be at or more than 300 nm, 400 nm, 500 nm, 1 um, or 2 um in thickness. In certain aspects, the BMMA section may be less than 100 nm, 150 nm, 200 nm, 300 nm, 400 nm, 500 nm, 1 um, or 2 um in thickness.

BMMA resin embedding may be compatible with histological stains such as H&E (hematoxylin and eosin) stains, immunostains (e.g., with SBPs such as antibodies), in situ hybridization, non-linear microscopy such as second Harmonic generation (SHG) microscopy, fluorescent microscopy such as confocal microscopy, IMS such as Direct ionisation (described herein) or MALDI, IMC by direct ionisation or another means described herein, and/or electron microscopy such as SEM and TEM. Certain SBPs such as antibodies penetrates the semi-thin BMMA sections and may be stripped from them, allowing for iterative microscopy (such as iterative fluorescence microscopy). As such, BMMA embedding may be combined with one or more of the above imaging modalities. BMMA is harder than paraffin, and may provide cleaner thick sections for tomography. In certain aspects, a thick BMMA section may be immunostained (e.g., after deplasticization), and coregistered with an imaging modality of a thinner BMMA section. BMMA sections (e.g., after deplastization) may be compatible with mass tagged SBPs.

In certain aspects, BMMA serial-sections may be cured by exposure to UV, deplasticized using acetone, re-hydrated by immersion in 50-95% ethanol, washed in buffer, exposed to antigen retrieval (e.g., by heating and/or acidification), and/or immuostained (e.g., with mass and/or fluorescent tagged SBPs).

As described herein, embedding may be with an acrylic polymer resin comprises LR White, a lowicryl, or a methyl methacrylate. In certain aspects, the resin, such as a lowicryl or MMA resin, may be cured (photopolymerized) by UV light, which may leave more SBP targets (e.g., epitopes) intact compared to high temperature curing. In certain aspects, the tissue may be was fixed in paraformaldehyde prior to embedding. Methods may include deplasticizing one or more of the tissue sections prior to labelling with the plurality of mass tagged SBPs.

An acrylic resin may be a Methyl methacrylate (MMA) resin, such as Butyl-methylmethacrylate (BMMA). BMMA is versatile polymer with variable hardness, such that it may be used for a variety of imaging modalities. BMMA may be cured at low temperatures under UV light. It is soluble in ethanol and acetone, allowing for gentle deplaticization that leaves more SBP targets (e.g., epitopes) intact. BMMA embedded resin may be sectioned at ultrathin and/or thick sections. For example, an ultrathin section may be at or less than 250 nm, 200 nm, 150 nm, 100 nm, or 50 nm in thickness. A thick section may be at or more than 300 nm, 400 nm, 500 nm, 1 um, or 2 um in thickness. In certain aspects, the BMMA section may be less than 100 nm, 150 nm, 200 nm, 300 nm, 400 nm, 500 nm, 1 um, or 2 um in thickness.

BMMA resin embedding may be compatible with histological stains such as H&E (hematoxylin and eosin) stains, immunostains (e.g., with SBPs such as antibodies), in situ hybridization, non-linear microscopy such as second Harmonic generation (SHG) microscopy, fluorescent microscopy such as confocal microscopy, IMS such as Direct ionisation (described herein) or MALDI, IMC by direct ionisation or another means described herein, and/or electron microscopy such as SEM and TEM. Certain SBPs such as antibodies penetrates the semi-thin BMMA sections and may be stripped from them, allowing for iterative microscopy (such as iterative fluorescence microscopy). As such, BMMA embedding may be combined with one or more of the above imaging modalities. BMMA is harder than paraffin, and may provide cleaner thick sections for tomography. In certain aspects, a thick BMMA section may be immunostained (e.g., after deplasticization), and coregistered with an imaging modality of a thinner BMMA section. BMMA sections (e.g., after deplastization) may be compatible with mass tagged SBPs.

In certain aspects, BMMA serial-sections may be cured by exposure to UV, deplasticized using acetone, re-hydrated by immersion in 50-95% ethanol, washed in buffer, exposed to antigen retrieval (e.g., by heating and/or acidification), and/or immuostained (e.g., with mass and/or fluorescent tagged SBPs).

As described herein, embedding may be with an acrylic polymer resin comprises LR White, a lowicryl, or a methyl methacrylate. In certain aspects, the resin, such as a lowicryl or MMA resin, may be cured (photopolymerized) by UV light, which may leave more SBP targets (e.g., epitopes) intact compared to high temperature curing. In certain aspects, the tissue may be was fixed in paraformaldehyde prior to embedding. Methods may include deplasticizing one or more of the tissue sections prior to labeling with the plurality of mass tagged SBPs.

Computational stitching of the resulting two-dimensional image tiles allows for volumetric analysis (e.g., across features or regions of interest). Multiple imaging modalities may be coregistered. Sections may be labelled with a plurality of distinguably tagged SBPs. Sections may be ultrathin, allowing for high resolution imaging. Ultrathin sections that also allow for depth invariance due to homogenous SBP penetration. This benefit may improve quantitation. In certain aspects, IMC may be performed on thick sections and higher resolution imaging may be performed on thinner sections from the same tissue (e.g., same embedded tissue block). Sections analysed by IMC may have residual resin (e.g., post deplasticization).

As embedding and sectioning is time and skill intensive, may include use of toxic reagents, and expensive equipment (such as diamond knife sectioning tools), such approaches may not be used for IMC analysis unless the above benefits are recognized.

In certain aspects, a tissue sample may be resin embedded and arrayed as described in an embodiment above, then stained with a segmentation panel and segmented as described further herein. Segmentation may be in 3D, such as when serial sections are computationally stacked (e.g., before or after segmentation). In certain aspects, segmented cells on serial sections (e.g., that are at the same or similar position in their respective section) may be assigned to the same cell event. For example, a series of IMC images of serial sections may be converted to a cell event dataset (e.g., in a matrix, such as where each cell is a row in a data set with a value in different columns for signal in a different mass channel representing expression of a marker, or visa versa), such as a fcs dataset (traditionally used for flow cytometry and suspension mass cytometry). The data set may further comprise an X, Y or X, Y, Z coordinate of the centerpoint for each cell. Alternatively, the data set may be a graph (or may be visualized as a graph) in which cells represented as nodes with edges connecting to nodes representing adjacent cells, and each node has values for signal of different mass channels (expression level of different markers).

In certain aspects, a combination of antibodies to cell surface markers (a cell typing panel) may be used to identify the cell type of segmented cells, such as by gating, clustering, or another suitable classification method. Cells, whether represented with a membrane mask in a 2D IMC image or as nodes in a graph, may be colorized based on their cell type. In certain aspects, the IMC dataset may be structured such that single cell data can used as an input to an algorithm to classify the sample (e.g., for diagnostic or prognostic applications), such as a matrix data set or graph data set described above. For example, a matrix or graph data set may be used as an input for a neural network trained to classify tissue, such as to classify cancerous vs. non-cancerous tissue and/or assign a stage to cancerous tissue.

### Automated Staining

In certain aspects, an automated staining system (e.g., a fluidic staining system) may be integrated with the slide hotel. For example, a fluidic staining system may be fluidicially coupled one or more locations of the slide hotel that are configured to retain one or more slides. Alternatively, a slide handling system (such as the robotic arm that may also introduce slides to the imaging mass cytometry system) may be configured to transfer slides from the slide hotel to the fluidic staining system.

The automated staining system may comprise a plurality of reservoirs, including a reservoir for an antibody panel (e.g., mass tagged antibody panel) and/or histochemical stain, a reservoir with a wash solution (for removing unbound antibodies or other reagents), and/or additional reagents, as well as one or more waste receptacles for used reagents. Reagents and steps for IMC sample preparation performed by the automated staining system may include one or more of dewaxing (e.g., in xylene), hydration (e.g., in ethanol), antigen retrieval (e.g., in a suitable buffer), blocking (e.g., in 1-5% BSA), staining panels (e.g., one or more panels, such as a segmentation panel, cell typing panel and/or cell phenotyping panel, e.g., as described herein), and/or non-antibody stains (e.g., histochemical stains or intercalator such as iridium, e.g., as described herein). In certain aspects, the automated staining system may control temperature of the slide and/or solution applied to the slide to 1) maintain reagents in reservoirs at a suitable temperature; 2) heat the slide (e.g., tissue section on the slide) for antigen retrieval at above 70, 80, or 90 degrees Celsius; or 3) maintain the slide at a temperature (incubate) for staining.

In certain aspects, staining of slides (e.g., tissue sections on slides) by the automated staining system may be staggered based on the order in which they are analysed by IMC, e.g., such that slides have a similar duration between processing by the automated staining system and analysis by IMC.

In certain aspects, a system may comprise a sample introduction system (e.g., robotic arm) and slide hotel as described herein. Alternatively or in addition, the system may further comprise a fluidic staining system (e.g., as described above). The system may further comprise a thermal controller for controlling temperature of samples in the hotel and/or automated staining system. A robotic arm may transfer samples to be in fluidic communication (e.g., at a portion of the slide hotel or at a separate staining station) with the fluidic staining system. The slide hotel may be in fluid communication with the fluidic staining system.

In certain aspects, a method of sample handling may include staining the samples (e.g., slides comprising tissue section(s)) with a fluidic staining system (e.g., that introduces mass tagged antibodies to the sample through the fluidic staining system and washes unbound mass tagged antibodies). The method may further include automated transfer of the stained sample into an imaging mass cytometry system, as described further herein.

### Cell Segmentation

Cell segmentation of imaging mass cytometry (IMC) images is a first step in identifying tissue heterogeneity at the single cell level, such as to investigate the tumor immune microenvironment. However, manual segmentation can be tedious and inconsistent, no suitable metal-containing histochemical membrane stain (e.g., for FFPE tissue staining) has been reported to date, and use of specific membrane markers for segmentation may not be applicable across tissues. In certain aspects, a membrane stain comprises an antibody to a junction protein and an antibody to a non-junction protein.

Cell segmentation using membrane markers has been reported in optical microscopy, such as by Ortiz de Solorzano et al. (in “Segmentation of nuclei and cells using membrane related protein markers.” journal of Microscopy 201.3 (2001): 404-415). Multiplexed cell surface markers have been used for cell segmentation of a specific tissue type in fluorescence microscopy, such as by McKinley et al. (in “Optimized multiplex immunofluorescence single-cell analysis reveals tuft cell heterogeneity.” JCI insight 2.11 (2017)) and by Gerdes et al. (in “Single-cell heterogeneity in ductal carcinoma in situ of breast.” Modern Pathology 31.3 (2018): 406-417). Automated segmentation in imaging mass cytometry based on cell surface markers of a particular panel in a particular tissue (i.e., selected from a preexisting IMC data set) was reported by Schüffler et al. (in “Automatic single cell segmentation on highly multiplexed tissue images.” Cytometry Part A 87.10 (2015): 936-942).

Certain embodiments of the subject application include standardized segmentation panel for IMC segmentation across tissue types, an automated segmentation algorithm developed based on the panel, a cell typing panel and related automated cell typing of segmented cells, and/or related methods. Such embodiments may be combined with other aspects of high throughput and automated imaging mass cytometry described herein, such as sample handling and/or rapid acquisition aspects. Such a segmentation panel may be combined with a nuclear stain, such as a metal-containing DNA intercalator (e.g., Iridium) and or a mass tagged antibody to histone (e.g., H3). While segmentation panels described herein may include one or more affinity reagents (e.g., antibodies) to cell surface markers, metal containing histochemical stains (such as a lipophilic stain) may be used herein alone or in combination with an affinity reagent based segmentation panel. Segmentation may be performed based on a segmentation panel and nuclear stain, and optionally further based on a cytosol compartment stain and/or an extracellular stain (e.g., by a metal containing histochemical stain or an antibody to a target localized in the cytosol or extracellular compartment). In certain aspects, a metal containing histochemical stain (such as Ruthenium Red used to identify mucinous stroma, Trichrome stain for identification of collagen fibers, osmium tetroxide as cell counterstain) may be used in segmentation.

### Cell Segmentation Panels and Kits

In certain aspects, a segmentation panel for IMC may comprise antibodies to at least 1, at least 2, at least 3, at least 4, or at least 5 (such as 1, 2, 3, 4 or 5) different targets. The segmentation panel may be used for segmentation across a plurality of tissues, such as across all, all but one, or all but two, of: bladder, breast, colon, larynx, lung, lymph node, pancreas, prostrate, striated muscle, testis, thyroid, and tongue (e.g., and the majority of cancers thereof). The tissue may be human. Alternatively, the tissue may be of a non-human mammal, such as mouse.

In certain aspects, cell segmentation embodiments described herein may be combined with one or more other high throughput embodiments described herein, such as in high throughput/automated sample handing (e.g., Array Tomography, automated sample preparation/staining, and/or automated sample introduction) and/or rapid acquisition (e.g., direct ionization, laser scanning, etc.).

For example, at least 1, at least 2, at least 3, at least 4, or at least 5 (such as 1, 2, 3, 4 or 5) different targets may be selected from: CD3, CD4, CD20, CD44, CD45, CD45RA, CD45RO, CD81, CD298 (Na/K ATPase), CD326 (EpCAM), syntaxin (e.g., syntaxin 4), solute carrier family, GLUT1, collagen (e.g., collagen 1), actin (e.g., beta-acting or pan-actin), catenin (e.g., beta-catenin), villin, keratin (e.g., keratin 8/18, pan-keratin, cytokeratin 7 or pan-cytokeratin), beta-tubulin, cadherin (e.g., E-cadherin or pan-cadherin), smooth muscle actin (SMA), selectin, vimentin, Ankyrin (e.g., Ankyrin 3), G protein, ERM protein family (e.g., Moesin, Ezrin), phosphatidylethanolamine binding protein (i.e., PEBP, such as PEBP 1). The segmentation panel may only comprise markers selected from those listed above, or may additionally comprise one or two additional markers not listed above. For example, the segmentation panel may further comprise mass tagged lectin (such as wheat germ agglutinin (WGA)) and/or a lipophilic compound (such as phalloidin or a derivative thereof).

The markers may be human. Information on protein localization is centralized in the Human Protein Atlas, which is searchable to identify protein targets that specifically localize to the plasma membrane (e.g., cell junctions) across different tissue and cell types, and can be used to identify, for example, one or two additional segmentation markers not listed above. Alternatively, the markers may be of a non-human mammal, such as mouse.

In certain aspects, at least one target (e.g., 1 or 2 targets) of antibodies in the segmentation panel may be a protein regulating cell adhesion, such as a catenin (e.g., beta-catenin) and/or a cell adhesion molecule (CAM) such as EpCAM, an integrin, a cadherin (e.g., E-cadherin or pan-cadherin), or a selectin.

In certain aspects, at least one target (e.g., 1 or 2 targets) of antibodies in the segmentation panel may be a protein modulating transport, such as Syntaxin (e.g., syntaxin 4), solute carrier family (e.g., solute carrier family 1 member 5, solute carrier family 41 member 3, and/or solute carrier family 16 member 1), Na/K ATPase (i.e., CD298), S100 calcium binding protein A4, Glut 1 and/or AP-2 complex (e.g., subunit mu). In certain aspects the segmentation panel may comprise both an antibody to an ion transport protein and an antibody to a small molecule transport protein.

In certain aspects, at least one target (e.g., 1 or 2 targets) of antibodies in the segmentation panel may be involved in cell signalling.

In certain aspects, at least one target (e.g., 1 or 2 targets) of antibodies in the segmentation panel may be structural proteins.

In certain aspects, at least one, but not all, of the antibodies in the segmentation panel may be to a cell surface marker localized at cell junctions.

In certain aspects, at least one target (e.g., 1 or 2 targets) of antibodies in the segmentation panel may be an immune cell marker, such as CD3, CD4, CD20, CD44, CD45, CD45RA, or CD45RO.

In certain aspects, a membrane stain comprises an antibody to a junction protein and an antibody to a non-junction protein.

As described herein, each antibody to a different target may be conjugated to a different mass tag. While lanthanide mass tags conjugated to most or all antibodies in traditional IMC panels are lanthanide mass tags (e.g., loaded on metal chelating polymers), the mass tags of the segmentation panel may be non lanthanide metals, and may be loaded onto a metal chelating polymer or may be of a small molecule attached directly to the antibody. For example, mass tags of the segmentation panel may include platinum, cadmium, hafnium, zirconium, bismuth, indium, and/or tellurium, or enriched isotopes thereof. In certain aspects, a mass tag of the segmentation panel may be a metal containing molecule, such as cisplatin, such cisplatin comprising an enriched platinum isotope. In general, such non-lanthanide mass tags may provide lower signal compared to lanthanide mass tags loaded on metal chelating polymers. This may be due to fewer metal atoms being attached to a given antibody and/or due to the non-lanthanide metal being closer to the cut-off mass range of around 80 amu. Use of such mass tags may allow the segmentation panel to be combined with existing IMC panels. Further, use of lower sensitivity mass tags may be sufficient for the segmentation panel targets, which may be expressed at high abundance.

A kit for cell segmentation may include a membrane stain comprising a plurality of antibodies to different cell surface targets used in segmentation (i.e., a segmentation panel), as described above. Antibodies of the segmentation panel may be conjugated to different mass tags, and the signal for the different mass tags may be integrated to provide a universal membrane stain channel (e.g., for creating a membrane mask as described herein). Alternatively, antibodies of the cell segmentation panel may be conjugated to the same mass tag, such that one mass channel provides a universal membrane stain, which can then be used for segmentation such as by creating a membrane mask as described herein.

Kits comprising a cell segmentation panel may further comprise additional components.

The membrane stain does not comprise antibodies that stains targets in compartments other than the plasma membrane. The membrane stain may bind to membranes of more cell types than any individual antibody of the membrane stain. The plurality of antibodies may be in mixture.

A kit may further include a nuclear stain, a cytosol stain and/or an extracellular matrix stain, e.g., for better individual identifying cells and guiding cell segmentation along the membrane. Alternatively or in addition, the kit may further comprise a panel of antibodies to cell surface targets used to determine cell types (a cell type panel), wherein antibodies of the panel are conjugated to different mass tags and useful for identifying cell populations as described herein (e.g., by automate classification of populations).

In certain aspects, a segmentation panel includes a plurality of mass tags and a plurality of antibodies, wherein each of plurality of antibodies specifically binds a different cell surface marker. Different antibodies may be conjugated to distinguishable mass tags. One or more (e.g., all) of the distinguishable mass tags may be a labelling atom outside of the lanthanide family. Alternatively, the different antibodies may be conjugated to the same mass tag (i.e., providing signal in the same mass channel).

Cancer cells may have different expression that health tissue, and may not be stained well with membrane markers that reliably stain health tissue. Alternatively or in addition, cancerous tissue may be at higher cell density than health tissue and segmentation may be more difficult. As such, at least one of the mass tagged antibodies may specifically bind a cell surface marker that is overexpressed in cancer cells of the tissue section to aid with segmentation of cancerous cells. In certain aspects, at least one of the antibodies specifically binds a cell adhesion protein (e.g., at a cell junction), at least one of the antibodies specifically binds an immune cell marker, at least one of the antibodies specifically binds a fibrous structural protein, at least one of the antibodies specifically binds a transport protein, and/or at least one of the antibodies specifically binds a signalling protein. At least one of the antibodies only binds a protein predominantly expressed (in which the majority is expressed) by less than 20%, less than 10%, or less than 5% of cells in the tissue, such as a tissue selected from: bladder, breast, colon, larynx, lung, lymph node, pancreas, prostrate, striated muscle, testis, thyroid, and tongue. For example, at least one of the antibodies of the segmentation panel is expressed in fewer than 4 of bladder, breast, colon, larynx, lung, lymph node, pancreas, prostrate, striated muscle, testis, thyroid, and tongue and the majority of cancers thereof.

In certain aspects, the segmentation panel enables segmentation of over 80%, over 90%, or over 95%, of cells in tissue sections of at least 8 (e.g., at least 9, at least 10, or all) of bladder, breast, colon, larynx, lung, lymph node, pancreas, prostrate, striated muscle, testis, thyroid, and tongue. The tissue may be of a mammalian species, such as human or mouse. This may include the majority of cancers thereof.

### Cell Segmentation Methods and Computer Readable Medium

Aspects of the subject application include use of the same segmentation panel for IMC of different tissue types (e.g., two or more, 3 or more, 4 or more, 6 or more, 8 or more, or 10 or more tissues recited herein).

The Current IMC data quantification analysis workflow uses a nuclei-based segmentation method in Cell Profiler which defines cells by sizes. This method is based on estimation of cell sizes and therefore is not accurate and efficient considering all different size values for different cell types. Described herein is a panel and use of plasma membrane markers that together provide broad and abundant tissue expression across different tissue and cell types. The segmentation panel may be applied and combined with software tools to define cell boundaries for segmentation and down stream quantitative analysis.

In certain aspects, the membrane stain may apply before, alongside, or after other antibody panels. Cell segmentation may be performed on images obtained by imaging mass cytometry. Segmentation approaches are known in the art, and are described, for example, by Wang et al. in “Cell Segmentation for Image Cytometry: Advances, Insufficiencies, and Challenges.” Cytometry. Part A (2019): 708-711. In general, cell segmentation benefits from clear labeling of cell membrane and of the interior of the cell (e.g., a cell nucleus visualized by a nuclear stain).

As described herein, the segmentation panel may comprise only a single mass tag used across multiple antibodies, or may comprise a different mass tag for different antibodies. In the later case, the channels (signals) from the different mass tags may be combined (e.g., with equal or different weighting) into a single channel representing the entire segmentation stain. This channel may be used alongside additional channels (such as a nuclear stain channel, cytosol channel, and/or extracellular space/matrix channel) by a segmentation program (e.g., as described below).

A variety of segmentation program may be applied to segment cells in IMC images obtained from tissue stained with a segmentation panel. Use of such programs, and such a program may be a neural network, such as a convolutional neural network. In certain aspects, a watershed algorithm and/or edge detection algorithms may be employed by the program. Use of such programs, and computer readable medium comprising such programs, are within the scope of the subject methods and kits. For example, a segmentation kit may comprise a segmentation panel and a computer readable medium comprising a program for segmentation based on the segmentation panel, e.g., as described further herein.

In certain aspects, the program may be trained across a plurality of different tissues to automatically perform segmentation based on the same segmentation panel. The program may be automatically run on a new IMC image. Alternatively, the program may be guided by a human user (e.g., training for a particular tissue or IMC image), such as when a user identifies edges and/or pixels as membrane based on the segmentation panel, and

In certain aspects, the program may classify pixels as membrane and one or more non-membrane categories (e.g., or labels), such as membrane and nuclear; membrane, nuclear and cytosol; membrane, nuclear and extracellular; or membrane, nuclear, cytosol and extracellular. Of note, not all pixels may receive a classification; for example, classification of pixels into membrane and nuclear pixels may leave some pixels with a null classification (neither nuclear or membrane). In certain aspects, the program may assign a confidence level and/or prompt the user to make a call on pixels with uncertain classifications.

The segmentation program may provide a membrane mask that may be overlaid on the IMC image to identify individual cells. Alternatively or in addition, expression (e.g., signal from different mass channels corresponding to different targets) in individual segmented cells may be integrated (e.g., across pixels of that segmented cell) and stored in a separate data set, such as an fcs (flow cytometry) data set or a matrix data set (e.g., in csv format) as described herein. Such data set may be used to identify cell types based on a gating or classification algorithm, e.g., based on a cell type panel, as described further herein.

### Cell Typing of Segmented Cells

To facilitate rapid analysis, the gating strategy associated with a particular panel can be pre-loaded into the software for analyzing the elemental analyzer data. Once selected (e.g., manually or automatically), the software can use that gating strategy on segmented cells to produce results from the elemental analyzer data.

In some cases, the software can automatically identify the cell types of the sample. The automatic identification of cell types can be based on a predetermined gating of cell populations sharing similar expressions of a subset of surface markers. Alternatively or in addition, identification of cell types can also be guided by a clustering algorithm.

In some cases, the software can output cell type results. Cell type results can include relative quantification (e.g., % of total cells, % of parent cells (parent cell population), % of grand-parent cells, and the like) for various cell types. Cell types may include immune cells (e.g., tissue resident cells or tumor infiltrating lymphocytes), such as CD4 αβ T cells (e.g., Total CD4, Naïve, Central memory, Effector, Effector memory, and Regulatory); CD8 αβ T cells (e.g., Total CD8, Naïve, Central memory, Effector, Effector memory); δγ T cells; B cells (e.g., Total B cells, Naïve, Memory, Resting memory, Transitional); NK cells; Monocytes; and/or Dendritic cells. Alternatively or in addition, gating may be performed to identify cells endogenous to the tissue and/or cancerous cells.

Methods may further include classifying individual interrogated cell into cell populations based on the shared panel and its distinct panel. For example, the shared panel may identify the T-cell parent population, but a distinct T-cell panel used for one of the partitions may identify sub-populations within that parent population. Other populations and panels are discussed in this application a suitable for these methods. Classification may be by gating, by a trained clustering algorithm operating in highly dimensional space (where dimensions are related to the number of surface markers used for classification), or by a neural network.

After segmentation, and optionally cell typing and/or phentyping classifications, the resulting data may be used for classification of the tissue section, such as a diagnosis or prognosis of cancer or identification of a suitable treatment. Such classification may be by an algorithm, such as a neural network, that is trained on segmented data.

In certain aspects, a method of automated analysis and cell segmentation for imaging mass cytometry may include one or more of:
a) staining a tissue section with a segmentation panel comprising a plurality of mass tagged antibodies, wherein each of plurality of antibodies specifically binds a different cell surface marker;
b) staining the tissue section with a nuclear stain;
c) imaging the sample by imaging mass cytometry; and
d) segmenting cells in the imaging mass cytometry data set based on signals from the segmentation panel and the nuclear stain.

Segmenting may be based on a single channel that combines signal from the antibodies of the segmentation panel, such as 1) when antibodies of the segmentation panel are conjugated to the same mass tag or 2) wherein antibodies of the segmentation panel that specifically bind different surface markers are conjugated to distinguishable mass tags, further comprising combining the signals from the distinguishable mass tags into the same mass channel in an imaging mass cytometry data set, prior segmenting

In certain aspects, the method may further including staining of cytosol and/or extracellular compartments and basing segmentation on the segmentation panel, nuclear stain, as well as the cytosol and/or extracellular stains.

In certain aspects, the method may further comprise staining the tissue section with a cell-typing panel; and identifying cell types of segmented cells based on the cell-typing panel. The cell-typing panel may include at least one antibody the binds the same cell surface marker as an antibody of the segmentation panel but is differentially mass tagged

A segmentation method described herein may be performed on a plurality of different tissues, such as two or more of bladder, breast, colon, larynx, lung, lymph node, pancreas, prostrate, striated muscle, testis, thyroid, and tongue tissue sections.

In certain aspects, the method further comprising embedding the sample in a resin (e.g., in BMMA) and arraying sections of the sample on the same slide by array tomography, prior to staining, imaging and segmenting the sample.

### Example Segmentation Protocol

Software Downloads: Download and install the following, software and ensure the IMC dataset is available on the desktop:
R Studio 1.2.5042
R 3.6.3
MCD Viewer
Ilastik 1.3.3
Cell Profiler 3.1.9

Preprocessing: If use of multiple PM channels for segmentation is desired, combination of the values of the various PM channels need to be combined into a single channel for segmentation.
In R, combine values of all PM channels that you want to use for segmentation into any ‘Neg’ column. This is a preexisting column. The reason for using the Neg column is MCD viewer expects a certain name for the channels so using a Neg column is preferable to adding a new column since we do not use the Neg column for analysis.

Use the SINGLE combined value column as the new PM Channel column as MCD Viewer does not nicely combine channels set to the same color i.e. multiple PM Channels set to White.

### Raw Image Settings for Export for Segmentation:

| MCD | | | | | Color | Color | Gamma |
|---|---|---|---|---|---|---|---|
| Viewer | Channels | Format | Size | Color | Min | Max | Value |
| Image 1 | 191Ir | TIFF | 16 | White | 0 | 100 | 0.65 |
| | | | BIT | | | | |
| Image 2 | 194Pt, 195Pt, | TIFF | 16 | White | 0 | 100 | 0.79 |
| | 196Pt and | | BIT | | | | |
| | 198Pt | | | | | | |
| Image 3 | 191Ir, 194Pt, | TIFF | 16 | DNA = | 0 | 100 | 0.65 and |
| | 195Pt, 196Pt | | BIT | Blue | | | 0.79 |
| | and 198Pt | | | PM = Red | | | |

### Raw Image Settings for Export for Data Analysis:

| MCD | | | | | Color | Color | Gamma |
|---|---|---|---|---|---|---|---|
| Viewer | Channels | Format | Size | Color | Min | Max | Value |
| Images | All | TIFF | 16 | White | Default | Default | Default |
| | single | | BIT | | | | |
| | channels | | | | | | |

### Step 1: MCD Viewer, Generate Images for Segmentation and Analysis

Inputs: MCD or txt file
Outputs: 16-bit tiff images
For Segmentation: (3) images

DNA Channel (191 iridium)

PM Channels (4 PMs)

Combined DNA and PM

For Data Analysis: (37) Multiple images

All single channel markers included in the panel

### Step 2: Ilastik, Generate Nuclei Probability Map Using Ilastik Pixel Classification

Input: DNA Channel .tiff (Step 1)

### Output: Nuclei Probability Map

### Steps in Ilastik:

### Create New Project □ Pixel Classification

### 1. Input Data:

Load DNA Channel .tiff image into Ilastik

### 2. Feature Selection:

Select All (37) Features (green boxes).

### 3. Training:

Label individual pixels Label 1 if:
Pixel clearly belongs to (is part of) the Nuclei

Label individual pixels Label 2 if:
Pixel belongs to background (non-nuclei).

Manually draw on the image with the labelling tool for the two specific areas, the probability map will be more accurate the more time you take on this task.

Constantly check Uncertainty and Predications to see which types of pixels the classification is unsure about to see what you should label. If the nuclei are not very dense, meaning there is very few overlapping nuclei, more labelling is better. However, if there is a very dense area with many overlapping nuclei, make sure that labels are chosen to generalize well. Generalize meaning the pixels labeled are representative of that label for other pixels in the image that are similar intensities. E.g. a super “bright” pixel that is almost surely part of the nuclei, so that would be a good point to label.

### 4. Predication Export:

Choose Export Image Settings . . . .
Cutout Subregion
   Check y, x, c boxes
Transformations:
   Convert to Data Type: Unassigned 16-bit
   Renormalize [min,max] from: 0.00, 1.00 to, 0, 65535
   Transpose to Axis Order: cyx

### Step 3 and 4: Cell Profiler, Segmentation of ROI

### Inputs:

Combined DNA and PM Channel.tiff (Step 1)

### Nuclei Probability Map (Step 2)

### Output: Segmentation Mask

1. Load the two images into cell profiler

In Names and Types:
Assign a Name to: Images Matching Rules
Create a single image matching the nuclei probability map name
   Image Type: Greyscale
   Set Intensity Range from: Image Metadata

Create two different images matching the Combined DNA and PM .tiff
Image Types: One Greyscale and One Color
Set Intensity Range from: Image Metadata for both
Click the update button to ensure you have all three images.
   2. Add Module: Identify Primary Objects (Please apply these Settings)
   Note: If Nuclei are densely packed, method to distinguish and draw dividing lines for clumped shapes may obtain better results if both are set to Intensity rather than shape.
   3. Add Module: Identify Secondary Objects (Please apply these settings)
   Step 4: Single Channel Analysis (same pipeline as Step 3)

### Inputs:

Single channel images (Step 1)

### Nuclei Probability Map (Step 2)

### Outputs:

Single cell data from the ROI

1. Load individual channel images into Cell Profiler
In Names and Types:
Assign a Name to: Images Matching Rules
For all analysis channel images:
   Image Type: Greyscale
   Set Intensity Range from: Image Metadata

2. Add Module: Measure Object Intensity
Measure Cell Objects Intensity on any (or all) Individual Channels

3. Add Module: Export to Spread Sheet
Export all Measurement values as .csv files

4. Add Module: Overlay Outlines
Optionally overlay identified objects (nuclei or cell, nuclei mask or segmentation mask) on any image(s) previously generated.

5. Save single cell data.

### Optical-Based Segmentation

In certain aspects, a cell membrane and/or nuclear stain may be detected by optical microscopy (e.g., via one or more colorimetric or fluorescent dyes detected by light microscopy, such as by fluorescent microscopy). Such a membrane stain may be histochemical, or may comprise dye conjugated to antibodies that bind one or more cell surface markers. Light microscopy (e.g., brighfield microscopy) itself may be used to identify cell boundaries without a membrane and/or nuclear stain. An optical microscopy (e.g., brightfield or fluorescent) image may be coregistered with an IMC image of the same tissue section, and the optical microscopy image may be used to guide segmentation of the IMC image. For example, segmentation of an optical image may be overlaid on an IMC image, and pixels of the IMC image may be segmented into different cells.

Imaging mass cytometers of the subject application may include an optical microscope (e.g., brightfield or fluorescent) may be integrated with the imaging mass cytometer (e.g., may share an optical path with a laser used for LA-ICP-MS). Further, the optical microscope may be used to focus (e.g., autofocus through a closed circuit loop) the laser ablation system and/or align optical and laser ablation optics for such coregistration.

In certain aspects, an optical microscopy (e.g., brightfield or fluorescent) image may be cell segmented to guide sampling (e.g., by laser ablation) for imaging mass cytometry. For example, cells of a sample (e.g., cell smear or tissue section) may be analysed by optical microscopy, individual cell coordinates may be identified, and laser ablation may be performed one cell at a time. The spot size of the laser ablation may be adjusted and/or the laser may be scanned or modulated as described further herein, to sample a cell identified by optical microscopy for ICP-MS analysis.

In dense tissue, cell-cell adhesion may result in the membrane of two adjacent cells being sampled in the same pixel by IMC (e.g., the same laser ablation spot by LA-ICP-MS). In certain aspects, cell segmentation may include attributing the pixel to both adjacent cells, or to neither cell. Cell typing may be based on cell surface marker expression on pixels not shared with other cells, or may be based on cell surface marker expression consistent across shared pixels (e.g., markers express on all membrane pixels of a cell and/or not just in pixels shared with one adjacent cell).

In certain aspects, edges between cells may be identified by optical microscopy to guide sampling (e.g., laser ablation) of individual edges (e.g., by laser scanning) for IMC analysis. The rest of the cell (e.g., cytosol and nuclear compartments) may be separately sampled, such as in a separate transient signal produced by separate laser ablation. Edges sampled in this, optionally along with intracellular (cytosol and nuclear compartments) sampled separately, may be assigned to (e.g., combined into) the same cell event based on the optical microscopy image. Markers expressed across only a portion of the edges assigned to a cell event may be excluded from use in typing that cell.

### Cell Typing Panel and Automated Cell Typing of Segmented Cells

In certain aspects, a combination of antibodies to cell surface markers (a cell typing panel) may be used to identify the cell type of segmented cells, such as by gating, clustering, or another suitable classification method. Cells, whether represented with a membrane mask in a 2D IMC image or as nodes in a graph, may be colorized based on their cell type. In certain aspects, the IMC dataset may be structured such that single cell data can used as an input to an algorithm to classify the sample (e.g., for diagnostic or prognostic applications), such as a matrix data set or graph data set described herein. For example, a matrix or graph data set may be used as an input for a neural network trained to classify tissue, such as to classify cancerous vs. non-cancerous tissue and/or assign a stage to cancerous tissue.

In certain aspects, an IMC image or dataset may be converted to a cell event dataset (e.g., in a matrix, such as where each cell is a row in a data set with a value in different columns for signal in a different mass channel representing expression of a marker, or visa versa), such as a fcs dataset (traditionally used for flow cytometry and suspension mass cytometry). The data set may further comprise a coordinate (e.g., X, Y coordinate) of the centerpoint for each cell. Alternatively, the data set may be a graph (or may be visualized as a graph) in which cells represented as nodes with edges connecting to nodes representing adjacent cells, and each node has values for signal of different mass channels (expression level of different markers).

In certain aspects, a combination of antibodies to cell surface markers (a cell typing panel) may be used to identify the cell type of segmented cells, such as by gating, clustering, or another suitable classification method. Cells, whether represented with a membrane mask in a 2D IMC image or as nodes in a graph, may be colorized based on their cell type. In certain aspects, the IMC dataset may be structured such that single cell data can used as an input to an algorithm to classify the sample (e.g., for diagnostic or prognostic applications), such as a matrix data set or graph data set described above. For example, a matrix or graph data set may be used as an input for a neural network trained to classify tissue, such as to classify cancerous vs. non-cancerous tissue and/or assign a stage to cancerous tissue.

### Rapid Acquisition

Traditional IMC that involves laser ablation of individual micron-scale pixels may be slow and untenable for the high throughput sample handing methods and systems described herein. As such, laser scanning, direct ionization, and/or spot size adjustment may be implemented to increase sample acquisition time, as discussed below. Such rapid acquisition may be combined with automated/high throughput sample handing embodiments and/or cell segmentation embodiments described above.

### Rapid Acquisition by Laser Scanning

The use of a scanning system to increase the acquisition rate provides numerous advantages over other strategies for increasing the rate at which a sample is imaged. For instance, an area of 100 μm×100 μm can be ablated in with a single laser pulse using appropriately adapted system. However, such ablation results in numerous problems. Ablating a large area of a sample at once with a single laser pulse leads to the ablated material being broken up into large chunks initially flying at velocities near the speed of sound, rather than small particles, and rather than the material being transported away quickly from the sample in the flow of carrier gas (described in more detail below), the large chunks may take longer to be entrained (lengthening the washout time of the sample chamber) than the smaller chunks, fail to be entrained, or just fly randomly off the sample or onto another part of the sample. If the large chunk of material flies off the sample, any information in that chunk of material in the form of detectable atoms, such as labelling atoms, is lost. If the chunk of material lands on another part of the sample, information is lost from the ablated area, and moreover any detectable atoms in the chunk of material now lie on and can interfere with the signal that would be acquired from another part of the sample. As differences in the biological material in an ablated spot (e.g. cartilaginous material versus muscle) can also affect how the product breaks up, larger ablation spots sizes can also compound fractionation of the sample, with some kinds of material being entrained in the flow of gas to a lesser degree than others. Furthermore, as described here, in many applications a small spot size is preferred, of the order of μm rather than 100s of μm, and switching between laser spot sizes multiple orders of magnitude different (e.g. 100 μm vs. 1 μm) also presents technical challenges. For instance, a laser that can ablate with a spot size of 1 μm may not have the energy to ablate an area with a spot size of 100 μm in a single laser pulse, and sophisticated optics are required to facilitate the transition between 1 μm and 100 μm without significant loss of energy in the laser beam or loss of sharpness of the ablation spot.

Any component which can rapidly direct laser radiation to different locations on the sample can be used as a positioner in the laser scanning system. The various types of positioner discussed below are commercially available, and can be selected by the skilled person as appropriate for the particular application for which an system is to be used, as each has inherent strengths and limitations. In some embodiments of aspects of the invention, as set out below, multiple of the positioners discussed below can be combined in a single laser scanning system. Positioners can be grouped generally into those that rely on moving components to introduce relative movements into the laser beam (examples of which include galvanometer mirror, piezoelectric mirror, MEMS mirror, polygon scanner etc.) and those that do not (examples of which include such acousto-optic devices and electro-optic devices). The types of positioners listed in the previous sentence act to controllably deflect the beam of laser radiation to various angles, which results in a translation of the ablation spot. The laser scanning system may comprise a single positioner, or may comprise a positioner and a second positioner. The description of “positioner” and “second positioner” where two positioners are present in the laser scanning system does not define an order in which a pulse of laser radiation hits the positioners on its path from the laser source to the sample.

In embodiments comprising a positioner, the rate at which ablative laser pulses are capable of being directed at the sample may be between 200 Hz-1 MHz, 200 Hz-100 kHz, 200 Hz-50 kHz, 200 Hz-10 kHz, 1 kHz-1 MHz, 5 kHz-1 MHz, 10 kHz-1 MHz, 50 kHz-1 MHz, 100 kHz-1 MHz, 1 kHz to 100 kHz or 10 kHz-100 kHz.

### Galvanometer and Piezoelectric Mirror Positioner

Galvanometer motors on the shaft of which a mirror is mounted can be used to deflect the laser radiation onto different locations on the sample. Movement can be achieved by using a stationary magnet and a moving coil, or a stationary coil and a moving magnet. The arrangement of a stationary coil and moving magnet produces quicker response times. Typically sensors are present in the motor to sense the position of the shaft and the mirror, thereby providing feedback to the controller of the motor. One galvanometer mirror can direct the laser beam within one axis, and accordingly pairs of galvanometer mirrors are used to enable direction of the beam in both X and Y axes using this technology.

One strength of the galvanometer mirror is that it enables large angles of deflection (much greater than, for example, solid state deflectors), which as a consequence can allow more infrequent movement of the sample stage. However, as the moving components of the motor and the mirror have a mass, they will suffer from inertia and so time for acceleration of the components must be accommodated within the sampling method. Typically, non-resonant galvanometer mirrors are used. As will be appreciated by the skilled person, resonant galvanometer mirrors can be used, but an system using only such resonant components as positioners of the laser scanning system will not be capable of arbitrary (also known as random access) scanning patterns. As it is based on a mirror, a galvanometer mirror deflector can degrade laser radiation beam quality and increase the ablation spot size, and so will again be understood by the skilled person to be most applicable in situations which tolerate such effects on the beam.

Galvanometer-mirror based system can be prone to errors in their positioning, through sensor noise or tracking error. Accordingly, in some embodiments, each mirror is associated with a positional sensor, which sensor feeds back on the mirror's position to the galvanometer to refine the position of the mirror. In some instances, the positional information is relayed to another component, such as an AOD or EOD in series to the galvanometer-mirror, which corrects for mirror positioning error.

Similarly, piezoelectric actuators on the shaft of which a mirror is mounted can be used as positioners to deflect the laser radiation onto different locations on the sample. Again, as mirror positioners, which are based on the movement of components with mass, there will inherently be inertia and so a time overhead inherent in movement of the mirror by this component. Accordingly, this positioner will be understood by the skilled person to have application in certain embodiments where nanosecond response times for the laser scanning system are not mandatory. Similarly, as it is based on a mirror, the piezoelectric mirror positioner will degrade laser radiation beam quality and increase the ablation spot size, and so will again be understood by the skilled person to be most applicable in situations which tolerate such effects on the beam.

In piezoelectric mirrors based on a tilt-tip mirror arrangement, direction of the laser radiation onto the sample in the X and Y-axes is provided in a single component.

Piezoelectric mirrors are commercially available from suppliers such as Physik Instrumente (Germany).

Accordingly, in some embodiments of aspects of the invention, the laser scanner system comprises a piezoelectric mirror, such as a piezoelectric mirror array or a tilt-tip mirror.

### MEMS Mirror Positioner

A third kind of positioner which is dependent on physical movement of the surface directing the laser radiation onto a sample is a MEMS (Micro-Electro Mechanical System) mirror. The micro mirror in this component can be actuated by electrostatic, electromechanic and piezoelectric effects. A number of strengths of this type of component derive from their small size, such as low weight, ease of positioning in the system and low power consumption. However, as deflection of the laser radiation is still ultimately based on the movement of parts in the component, and as such the parts will experience inertia. Once again, as it is based on a mirror, the MEMS mirror positioner will degrade laser radiation beam quality and increase the ablation spot size, and so the skilled person will again understand that such scanner components are therefore applicable in situations which tolerate such effects on the laser radiation.

### Polygon Scanner

A further kind of positioner which is dependent on physical movement of the surface directing the laser radiation onto a sample is a polygon scanner. Here, a reflective polygon or multifaceted mirror spins on a mechanical axis, and every time a flat facet of the polygon is traversing the incoming beam an angular deflected scanning beam is produced. Polygon scanners are one-dimensional scanners, can direct the laser beam along a scanned line (and so a secondary positioner is needed in order to introduce a second relative movement in the laser beam with respect to the sample, or the sample needs to be moved on the sample stage). In contrast to the back-and-forward motion of e.g. a galvanometer based scanner, once the end of one line of the raster scan has been reached, the beam is directed back to the position at the start of the scan row. The polygons can be regular or irregular, depending on the application. Spot size is dependent on facet size and flatness, and the scan line length/scan angle on the number of facets. Very high rotational speeds can be achieved, resulting in high scanning speeds. However, this kind of positioner does have drawback, in terms of lower positioning/feedback accuracy due to facet manufacturing tolerances and axial wobble, as well as potential wavefront distortion from the mirror surface. The skilled person will again understand that such scanner components are therefore applicable in situations which tolerate such effects on the laser radiation.

### Electro-Optical Deflector (EOD) Positioner

Unlike the preceding types for laser scanner system component, EODs are solid-state components—i.e. they comprise no moving parts. Accordingly, they do not experience mechanical inertia in deflecting laser radiation and so have very fast response times, of the order of 1 ns. They also do not suffer from wear as mechanical components do. An EOD is formed of an optically transparent material (e.g. a crystal) that has a refractive index which varies dependent on the electric field applied across it, which in turn is controlled by the application of an electric voltage over the medium. The refraction of the laser radiation is caused by the introduction of a phase delay across the cross section of the beam. If the refractive index varies linearly with the electric field, this effect is referred to as the Pockels effect. If it varies quadratically with the field strength, it is referred to as the Kerr effect. The Kerr effect is usually much weaker than the Pockels effect. Two typical configurations are an EOD based on refraction at the interface(s) of an optical prism, and based on refraction by an index gradient that exists perpendicular to the direction of the propagation of the laser radiation. To place an electric field across the EOD, electrodes are bonded to opposing sides of the optically transparent material that acts as the medium. Bonding one set of opposed electrodes generates a 1-dimensional scanning EOD. Bonding a second set of electrodes orthogonally to the first set electrodes generates a 2-dimensional (X, Y) scanner.

The deflection angle of EODs is lower than galvanometer mirrors, for instance, but by placing several EODs in sequence, the angle can be increased, if required for a given system set up. Exemplary materials for the refractive medium in the EOD include Potassium Tantalate Niobate KTN (KTaₓNb₁₋ₓO₃), LiTaO₃, LiNbO₃, BaTiO₃, SrTiO₃, SBN (Sr₁₋ₓBaₓNb₂O₆) and KTiOPO₄ with KTN displaying greater deflection angles at the same field strength.

The angular accuracy of EODs is high, and is principally dependent on the accuracy of the driver connected to the electrodes. Further, as noted above, the response time of EODs is very quick, and quicker even than the AODs discussed below (due to the fact that a (changing) electric field in a crystal is established at the speed of light in the material, rather than at the acoustic velocity in the material; see discussion in Römer and Bechtold, 2014, Physics Procedia 56:29-39).

### Acousto-Optical Deflector (AOD) Positioner

This class of positioner is also a solid state component. The deflection of the component is based on propagating sound waves in an optically transparent material to induce a periodically changing refractive index. The changing refractive index occurs because of compression and rarefaction of the material (i.e. changing density) due to the sound waves propagating through the material. The periodically changing refractive index diffracts a laser beam traveling through the material by acting like an optical grating.

The AOD is generated by bonding a transducer (typically a piezoelectric element) to an acousto-optic crystal (e.g. TeO₂). The transducer, driven by an electrical amplifier, introduces acoustic waves into the refractive medium. At the opposite end, the crystal is typically skew cut and fitted with an acoustic absorbing material to avoid reflection of the acoustic wave back into the crystal. As the waves propagate in one direction through the crystal, this forms a 1-dimensional scanner. By placing two AODs orthogonally in series, or by bonding two transducers on orthogonal crystal faces, a 2-dimensional scanner can be generated.

As for EODs, deflection angle of AODs is lower than galvanometer mirrors, but again compared to such mirror-based scanners the angular accuracy is high, with the frequency driving the crystal being digitally controlled, and commonly resolvable to 1 Hz. Römer and Bechtold, 2014, note that drift, common for galvo-based scanners, as well as temperature dependency in comparison to analog controllers, are not usually problems encountered by AODs.

Exemplary materials for use as the refractive medium of the AOD include tellurium dioxide, fused silica, crystalline quartz, sapphire, AMTIR, GaP, GaAs, InP, SF6, lithium niobate, PbMoO₄, arsenic trisulfide, tellurite glass, lead silicate, Ge₅₅As₁₂S₃₃, mercury (I) chloride, and lead (II) bromide.

In order to change the angle of deflection, the frequency of sound introduced to the crystal must be changed, and it takes a finite amount of time for the acoustic wave to fill the crystal (dependent on the speed of propagation of the soundwave in the crystal and on the size of the crystal), thereby meaning there is a degree of delay. Nevertheless, response time is relatively fast, compared to laser system positioners based on moving parts.

A further characteristic of AODs which can be exploited in particular instances is that the acoustic power applied to the crystal determines how much of the laser radiation is diffracted versus the zero-order (i.e. non-diffracted) beam. The non-diffracted beam is typically directed to a beam dump. Accordingly, an AOD can be used to effectively control (or modulate) the intensity and power of the deflected beam at high speed.

Diffraction efficiency of the AOD is typically nonlinear, and accordingly, curves of diffraction efficiency vs. power can be mapped for different input frequencies. The mapped efficiency curves for each frequency can then be recorded as an equation or in a look-up table for subsequent use in the system and methods disclosed herein.

Accordingly, in some embodiments of aspects of the invention, the laser scanner system comprises an AOD.

### Integration of Positioners

In the preceding paragraphs, two types of laser scanning system positioners are discussed: mirror based, comprising moving parts, and solid state positioners. The former are characterised by high angles of deflection, but comparatively slow response times due to inertia. In contrast, solid state positioners have a lower deflection angle range, but much quicker response times. Accordingly, in some embodiments of aspects of the invention, the laser scanning system includes both mirror based and solid state components in series. This arrangement takes advantages of the strengths of both, e.g. the large range provided by the mirror-based components, but accommodating the inertia of the mirror-based components.

Accordingly, a solid state positioner AOD or EOD) can be used for instance to correct for errors in the mirror-based scanner components. In this case, positional sensors relating to mirror-position feedback to the solid state component, and the angle of deflection introduced into the beam of laser radiation by the solid state component can be altered appropriately to correct for positional error of the mirror-based scanner components.

Rather than ablating a 100 μm^{t} single spot, therefore, 100×100 (i.e. 10,000) 1 μm diameter spots can be used to ablate the area by rastering across the area. A smaller spot size for ablation naturally does not suffer from the problems described above to such a great extent—the particles generated by a smaller ablation spot by necessity are themselves much smaller in size. Furthermore, with smaller spots, the resulting smaller particles resulting from the ablation have shorter and more defined washout times from the sample chamber. Where each of the smaller spots is desired to be resolved separately, this in turn has the consequence that data can be acquired more quickly as the transients from each ablative laser pulse do not overlap when detected in the detector (or overlap to an acceptable degree, as explained below).

However, moving a sample stage in 1 μm increments along a row, and then down a row is relatively slow due to inertia as noted above. Thus, by using a laser scanner system to raster across the area, without moving the sample stage, or moving the sample stage less frequently or at a constant speed, the relatively slow speed of the sample stage does not limit the rate at which the sample can be ablated.

Accordingly, to enable rapid scanning, the laser scanning system must be able to rapidly switch the position at which the laser radiation is being directed on the sample. The time taken to switch the ablating position of the laser radiation is termed the response time of the laser scanning system. Accordingly, in some embodiments of aspects of the invention, the response time of the laser sampling system is quicker than 1 ms, quicker than 500 μs, quicker than 250 μs, quicker than 100 μs, quicker than 50 μs, quicker than 10 μs, quicker than 5 μs, quicker than 1 μs, quicker than 500 ns, quicker than 250 ns, quicker than 100 ns, quicker than 50 ns, quicker than 10 ns, or around 1 ns.

The laser scanning system can direct the laser beam in at least one direction relative to the sample stage on which the sample is positioned during ablation. In some instances, the laser scanning system can direct the laser radiation in two directions relative to the sample stage. By way of example, the sample stage may be used to move the sample incrementally in the X-axis, and the laser may be swept across the sample in the Y axis. When a 1 μm spot size is used, the movement in the X axis may be in 1 μm increments. At a given position in the X axis, the laser scanning system can be used to direct the laser to a series of positions 1 μm apart in the Y axis. Because the rate at which the laser scanning system can direct the laser radiation to different positions in the Y axis is much quicker than the stage can move incrementally in the X axis, a significant increase in ablation rate is achieved in this simple illustration of the operation of the scanner.

In certain aspects, the laser scanning system may be configured to only scan in one direction. For example, the laser scanning system may only have one positioner, which is capable of only scanning in only one direction. In such cases, the sample stage may be moved to provide motion in a different direction, non-parallel to the direction of the laser beam.

In certain aspects, the area scanned (e.g., region of interest) may be increased by movement of the sample stage while the laser beam is being directed by the laser scanning system. In the absence of movement of the sample stage, the area scanned by the laser beam may be limited by the size of a window the beam passes through, such as a window in the top of the laser ablation cell and/or a window in a portion of an injector tube within the laser ablation cell (chamber) positioned for uptake of irradiated sample. Alternatively or in addition, in the absence of movement of the sample stage, the area covered by the laser beam may be limited by a need to position the portion of the sample impacted by the laser beam proximal to an aerosol uptake system (e.g., injector tube) that delivers sample (e.g., sample ablated, desorbed or lifted by the laser beam) to an ionization system and/or mass detector. As such, movement of the stage during laser scanning may increase the area continuously scanned. In certain aspects, multiple regions of interest are scanned.

Rapid scanning may allow processing of more samples. As such, the slide handler of the subject application may be operatively coupled to a laser scanning system, such as an imaging mass cytometer comprising a laser scanning system.

Another application is arbitrary ablation area shaping. If a high repetition rate laser is used, it is possible to deliver a burst of closely-spaced laser pulses in the same time that a nanosecond laser would deliver one pulse. By quickly adjusting the X and Y positions of the ablation spot during a burst of laser pulses, ablation craters of arbitrary shape and size (down to the diffraction limit of the light) can be created. For instance, the n and n+1 positions in a burst may be no more than a distance equal to 10× the laser spot diameter apart (based on the centre of the ablation spot of the nth spot and the (n+1)th spot), such as less than 8×, less than 5×, less than 2.5 times, less than 2× times, less than 1.5×, around 1×, or less than 1× the diameter of the spot size. Particular methods employing this technique are discussed in the methods section below, at page Error! Bookmark not defined. In certain aspects, the arbitrary ablation area may be a ROI determined for a slide in a slide hotel accessed by a slide handling system.

### Rapid Acquisition by Direct Ionization

As described herein, one or more parameters of a direct ionization imaging mass spectrometer may be set to obtain a desired plasma and deliver it to a mass detector. Depending on the application, certain parameters may be predetermined (e.g., a spot size given a desired resolution) and, as described herein, other parameters can be adjusted to obtain the desired plasma properties. As a general direction, an optimal radiation energy, shorter radiation pulse time, smaller spot size, and wavelength absorbed well by the sample will provide a plasma with higher ionization efficiency (e.g., which can be measured by optical emission, or as oxidation or quantity of ions passed to the mass detector). This smaller, faster scale of ablation facilitates formation of a nano-plasma that can lead to ion sampling without neutralization. The radiation pulse time, such as a laser pulse time, may be shorter than the duration of plasma formation, or of the formation of a plasma past neutralization. These parameters, and the material of the sample itself, affect the amount of the sample in the plasma and its temperature (kinetic energy), with less material at a higher temperature expanding more rapidly in vacuum thereby reducing the formation of neutrals.

One can assume that in the earlier stages of plasma evolution it reaches a state of local thermal equilibrium. That means that one temperature value can describe the temperature of electrons and the temperature of ions. To achieve a local thermal equilibrium sufficient density of plasma is required which is the case while the plasma is right at the specimen where the local density is high and collisions are prevalent. As described herein, as the plasma expands into a vacuum, positive ions separate from negative ions and electrons to the point that neutralization through collisions is reduced or eliminated. As such, properties of the plasma described in embodiments herein may describe the plasma past neutralization (e.g., after the majority, such as 80% or 90%, of neutralizing collisions have taken place). For example, when the plasma is past neutralization (e.g., and may be collisionless, or approaching a collisionless state) it may still have a temperature more than 3000K, such as between 3000K and 30000K, such as between 5000K and 10000K. As such, ions in plasma past neutralization may be stably ionized and passed to the detector. The direct ionization methods and systems described herein have unique benefit to imaging mass cytometry, specifically to imaging of metal tags in biological samples.

In a gas at a high temperature and pressure, thermal collisions will ionize some atoms. The Saha ionization equation relates the ionization state of a gas to its temperature, pressure, and ionization energies of its composite atoms, assuming thermal equilibrium. For example, the ionization efficiency of a lanthanide atom in a thermal plasma at 6000K would be high (approaching 100%). Assuming a radiation pulse was applied rapidly enough and at high enough energy (e.g., by a femtosecond or picosecond laser) in a small enough spot size and was absorbed by the sample (e.g., 10% or 20% of the laser light or electron beam was absorbed as thermal energy), the conditions for a highly ionizing (e.g., high lanthanide ionization efficiency) local plasma would be met. In certain aspects, ionization efficiency of lanthanides in the plasma may be higher than that of carbon or other lower mass elements, such that ions delivered to the mass detector are enriched for lanthanide ions. In certain aspects, the parameters (such as spot size, pulse time and/or pulse energy) may be tunable for different applications or to maintain consistency of plasmas (e.g., with real-time feedback on ionization efficiency).

As described below, the radiation providing a plasma at the sample spot may be laser radiation or an charged particle beam, such as an ion beam or electron beam.

### Overview of Direct Ionization by Laser Ablation

Many imaging mass spectrometry applications, including some forms of imaging mass cytometry, uses a laser ablation ICP-MS system. These types of systems have natural challenges to deal with:
The plasma-vacuum interface (as well as the time-of-flight mass spectrometer we use) prevents most of the analyte ions not to reach the detector, lowering the end-to-end sensitivity of the instrument.
The ICP introduces a large background signal from Ar and ArAr ions, which effectively limits our mass range to analyte ions with mass over 80 amu.
The sample transport from the ablation site to the plasma, as well as the dwell time in the plasma itself, is the main factor limiting our ablation rate to hundreds of Hz (e.g. <˜1 kpixel/s).
The laser ablation resolution is about 1 μm due to the choice of wavelength, objective numerical aperture, sampling geometry and the types of samples (e.g. FFPE tissue sections) our existing systems can work with.
The instrument as a whole is quite complex, with the analytes going through many processes and interfaces before being detected. This increases the build cost, operating cost and service cost of our instruments, and complicates end-to-end analysis.

Systems and methods described below provide an alternative setup, where one or more laser sources are used to ablate and ionize the sample, which is already in a vacuum, and the resulting ions are then accelerated into a mass spectrometer directly, without the need for an ICP and vacuum interface.

In our current LA-ICP-MS system the sample is ablated using a laser in a helium/argon environment at near-atmospheric pressure. The ablation event can be thermal or athermal in nature, depending on the choice of laser source (long pulse duration UV laser or femtosecond laser). Either way, the plasma that might form during the ablation process rapidly neutralizes due to the density of the ablated cloud as well as the extended contact with the carrier gases at atmospheric pressure. An ICP with a vacuum interface is then used to ionize the ablated material and sample the ions.

An alternative way to sample the analyte ions would be to create a local plasma and inject the analyte ions directly from this plasma into a mass analyzer. The inventors realized that in order to prevent neutralization, the ablation plasma would need to be sparse enough and expand quickly enough that neutralization is halted and the plasma is ‘frozen’. Past this neutralization ions in the plasma remain ionized (e.g., greater than 80% or 90% of the ions may remain ionized). This means the ablation volume (e.g., spot size) needs to be kept small. Typical laser ablation volumes are about 1×1×1 μm (our HTI platform) or larger (Laser Induced Breakdown Spectroscopy, LA-ICP-MS of geological samples, etc.). We estimate an appropriate ablation volume for ensuring low degree of neutralization to be 100×100×100 nm or smaller (e.g., a spot size of 100 nm or less).

Of note, fs-LIBS literature often describes the LIBS process as a plasma evolution. LIBS plasma eventually cools down, the ions neutralize, and complex molecules form at the final stages of LIBS evolution. This sequence happens because there are just too many neutral particles generated by ablation and they continue to collide as the plasma cools down. In addition, there are too many charged particles in a small volume and the forces of attraction between positive and negative charged particles can overcome all other forces acting on ions in the ablation plume. For a fixed degree of ionization, the number of ions in the plasma plume goes down as roughly the cubic power of pixel size. The same cubic power law applies to the number of neutral species in the ablated plume. Thus, LIBS type of plasma created at a nanoscale could be a source of analytical ions that can be sampled directly into a mass analyzer without neutralization. In other words, the plume originating from a nanoscale ablation can be sampled as a “frozen” plasma. And then, the plasma can be separated into positive and negative particles and the positive ions can then be detected by a mass spectrometer with high efficiency. In the classical LIBS, the topic of ablated pixels at a spatial resolution of 100 nm (or below) remains unexplored because there is no motivation to go there due to poor optical signals that are the main source of information in LIBS. By employing a LIBS type of plasma created from nanoscale ablation in combination with direct sampling of ions into a mass spectrometer. Once the ions from the plasma separate from electrons they can be analyzed. The sample would need to be in a vacuum environment or at a relatively low pressure during the ablation event to facilitate ion extraction and ion manipulation with a minimal time broadening of the ion packets from corresponding pixels.

It might be advantageous to create plasma in a state of a local thermal equilibrium (LTE). This condition has a parallel to the plasma in the traditional ICP-MS. The reason the LTE plasma is useful is because the ionization efficiency becomes dependent on the temperature of the plasma and the ionization potential for a given element. At a temperature of around 7000K the degree of ionization exceeds 90% for the majority of elements (e.g., lanthanide isotopes) used in MaxPar reagents for mass cytometry. At the same time, the degree of ionization for the most abundant biological elements such as carbon, hydrogen and oxygen stays at around a few percent. Therefore, the amount of charged particles in the expanding plasma remains fairly low which in turn helps with the plasma separation into positive and negative particles.

The temperature of the plasma increases with the amount of the laser energy deposited into the ablation volume. Thus, one can adjust the temperature to achieve the desired degree of ionization and an optimal plasma breakup. Note, a non-thermal plasma may also work for this application, though it may be more difficult to model the ion production behaviour for a non-thermal plasma. Experiments can be used as a guidance to develop optimal conditions for ionization with non-thermal plasma. It might happen that a longer pulse duration leads to a plasma that is closer to thermal. But, it might also happen that a shorter pulse duration leads to the thermal plasma. The state of plasma depends on several parameters such as pulse energy, its wavelength, pulse duration and pulse shape. Even the light polarization properties could be contributing to the type of the plasma being created by the laser pulse.

Mean velocity of atoms in the thermal plasma can be calculated from the temperature of the plasma and the mass of the atoms. It comes at around 3000 m/s for carbon atoms at 7000 K. This is the velocity at which plasma will start expanding from the solid being ablated and into the vacuum. At this velocity, the plasma will cover 30 nm of distance in 10 μs. Thus, 10 μs becomes an estimate for a maximum duration of light that can still be used to heat up the plasma. A pulse duration longer than— 10 μs may not be efficient at converting the light energy into the plasma energy. It is fortunate that cost efficient fs fiber lasers produce laser pulses with duration on the scale of 500 fs. Such pulses should be well suited for creating the desired plasma as long as they can be focused to the 100 nm scale using suitable optics.

Such small ablated volumes require special optical arrangements, since most microscopes are limited to a spatial resolution of around 200 nm or larger by the diffraction limit of visible light and limitations on the numerical aperture available. This is shown by the FWHM focal spot diameter formula: D=0.541λ/(√m [symbol] NA [symbol] \hat{ }0.91), where λ is the wavelength of light used, m is the order of the optical process, and NA is the numerical aperture (between 0.7 and 1.4 for this formula to be valid). Using λ=450 nm and NA=1.4 leads to a FWHM spot diameter of about 180 nm.

The spot size formula above indicates there are three ways in which ablation scales of 100 nm or less could be achieved: reducing the wavelength from visible to UV or shorter, using a higher-order (nonlinear) optical process, or increasing the numerical aperture beyond what is available from common off-the-shelf microscope components.

### EUV Laser Ablation

The wavelength can be reduced by using EUV lasers with wavelength below 50 nm. Even though a numerical aperture below 1 will need to be used (as no materials can be used for immersion), the shorter wavelength more than makes up for this and focal spot sizes of 100 nm or less may easily be achieved, potentially down to 10×10×10 nm for high harmonic generation laser sources or tin vapour lasers with a wavelength of 13 nm, which are used commercially in EUV lithography. Even at a numerical aperture of 0.4 (close to what is used in EUV lithography) the 13 nm wavelength will still lead to ablation spot on the 30 nm scale.

This approach will require the use of custom all-reflective optics with very tight surface figure tolerances, and likely a custom laser source. The fact that no materials should be in the path of the laser also implies that the ablation laser may need to reach the sample from the same side as where collection of ions will take place. This will require very specialized optics that can reflect and focus the ablation laser and still have a clear aperture for transmission of the generated ions.

Downsides of this approach include the high cost and complexity of the custom EUV laser source and optics.

The need for the pulse duration below 10 μs may be a significant limitation for the tin-droplet EUV laser mentioned above, though high harmonic generation sources are known to generate attosecond pulse durations and would be viable from this perspective.

### Femtosecond Laser Ablation

A femtosecond laser can also be used, which would make the ablation event nonlinear in nature. This shrinks the effective spot size by the square root of m, where m is the order of the nonlinear process. For example, laser pulses from a frequency-doubled Ti:Sp laser would have a central wavelength of around 400 nm. Using a TIRF objective with numerical aperture of 1.49, and assuming a second-order nonlinear process or higher, the spot size would be 106 nm in diameter or smaller (FWHM). Furthermore, nonlinear ablation processes have well-defined thresholds, so that effective ablation spot sizes well below the FWHM diameter can be achieved by precisely controlling the pulse energy. In literature, factors of 5-10 are routinely achieved, with a 5× reduction commonly considered the upper limit for reproducibility. This would mean ablation sizes on the order of 20-30 nm.

One major benefit of this approach is that standard lasers and microscope optics can be used, which would greatly shorten time-to-market and lower parts cost. Furthermore, the laser pulses can be focused through the sample carrier (i.e., a microscope coverslip in the case of off-the-shelf microscope objectives), which greatly simplifies the instrument design because the ion sampling side can be completely devoted to ion acceleration and collection.

Pulse durations on the order or tens of femtoseconds to hundreds of femtoseconds are routinely achieved in commercial laser systems (e.g., titanium-doped sapphire lasers or ytterbium-doped lasers, respectively). The transition from a nonlinear ablation process to a linear ablation process (i.e., linear absorption) may take place around pulse durations of 1-10 picoseconds. In any case, the pulse duration may not be much longer than tens of ps due to the small spot size and the plasma's speed of expansion. For example, if the ablation plasma expands at 3000 m/s, a 30 nm volume would expand to twice its size/diameter in about 10 μs.

### Solid Immersion Lenses

Another approach could be to use solid immersion lenses to greatly increase the numerical aperture, thereby shrinking the spot size. For example, diamond solid immersion lenses are commercially available and can be used with laser wavelengths of 266 nm. The numerical aperture at this wavelength can be up to about 2.5, limited by the refractive index of the material. At such a high numerical aperture the spot size formula above is not valid anymore, but it can still be used to estimate D=63 nm. A diamond lens of this type was used in a prototype of an optical storage disk by Sony with a storage capacity on the scale of 2 TB enabled by the tight focusing of the beam.

The chief advantages of this approach are that a low-cost, standard laser source can be used (4th harmonic Nd laser), and that the laser can be focused through the sample carrier, leaving the other side free for ion acceleration and collection. There are several major disadvantages, however:
High parts cost and tight tolerances on the immersion lens
Very tight dynamic alignment tolerances on the immersion lens
Very small field of view.

Sample would need to be mounted on the lens itself, or would need to be mounted on a tight-tolerance substrate of the same material, and the interface between the lens and substrate will require optical contact, which is difficult to maintain dynamically.

Laser beam rastering can be employed to facilitate sample interrogation. For example, the laser can be scanned at 5000 lines per second and each laser line can generate 2000 pixels leading to 10 Mpixel/s and 10 MHz laser repetition rate. With 100 nm pixels the laser line will cover 200 micrometers and the velocity of travel will be 500 mm/s. Such parameters could be an extreme case—a more practical setup will involve 1000 pixels per line collected at 1000 lines per second at 100 mm/s. The data can be collected by rastering the beam in two dimensions within the field of view of 100×100 micrometers.

### Mass Spectrometer Considerations

Regardless of which approach is used to shrink the ablation volume to an appropriate size, the ions will need to be accelerated immediately from the sample and injected into the mass spectrometer. This will likely require the sample carrier to be conductive (e.g., using an ITO-coated microscope slide or using a conductive coating made of lower-mass atoms that will not show up in our analyte ion channels, such as a graphene coating). In certain aspects, the sample support may be conductive and charged to repel ions generated by direct ionization as described herein.

Various configurations of ion optics could be used, such as magnetic sector mass analyzers with multiplexed multichannel detection, TOF mass analyzer without pulse extraction or a TOF mass analyzer with pulse extraction. In the case of a TOF with pulse extraction the pulse can be synchronized with the firing of the laser beam. The purpose of the pulsed extraction could be to improve instrument mass resolution as practiced in the art of MALDI mass spectrometers. There the technique goes under the name of delayed extraction.

A benefit of the proposed ionization method over our current ICP-based instrumentation is that there would be no background ions from carrier/plasma gases, etc., and so the mass range of the analyzer can be extended to lower masses. High brightness ion species such as carbon+ ions would be present in the ion beam of this method but can be filtered out on the basis of TOF or magnetic separation. On the other hand, molecular ions and clusters would likely show up in the data and complicate the analysis as compared to our current instrument. The majority of the molecular ions and clusters will appear in the mass range that is outside of the mass range of interest for the elemental tags. Thus, they too can be filtered out by a suitable mass spectrometry filtering. As an alternative, molecular ions and clusters could be suppressed by inducing ion fragmentation by means known in the art of mass spectrometry.

Furthermore, by immediately accelerating the ions away from the ablation site the time duration of the ion pulse in the mass analyzer would be very short, which means a vast improvement in the scanning rate would be possible as compared to our current instrument—up to tens or hundreds of kHz for TOF and up to 100 MHz for magnetic sector instrument. In the case of magnetic sector instrument the limiting factor could be the pulse duration at the detection channel. The ion optics of a magnetic sector instrument can be designed to maintain ion pulse duration at the detector surface on the scale of 10 ns. This may require the ion optics to contain compensation due to the energy spread introduced by the plasma expansion. A cross over ion optics technology fusing a TOF technology that maintains a narrow beam pulse at the detector and a multi-channel magnetic sector technology can be applied to operate at such high acquisition rates.

### Sample Considerations

Because the ablation volume is so much smaller compared to our standard platform, the number of analyte ions per laser ablation event is greatly reduced. This may be a problem if the end-to-end detection efficiency is not proportionally improved. Due to the lack of vacuum interface, and the possibility of using a TOF or a magnetic mass analyzer, the end-to-end detection efficiency may be significantly higher. On the other hand, the ionization efficiency of the analyte ions will likely be reduced as compared to our ICP-based instruments due to some recombination of the plasma during its expansion phase. Either way, the technique would obviously benefit from new staining techniques increasing the number of analyte ions per volume.

Another consideration is that the short ablation depth means that thin samples will need to be used, on the order of 100 nm or thinner. These are routinely used in electron microscopy. These samples are resin-embedded, which would likely be beneficial due to dimensional stability and reproducibility of ablation threshold regardless of the inhomogeneity of the biological sample.

A large number of serial sections can be prepared for a single specimen and then quickly read out by the proposed method. This makes this method well suited for 3D analysis of biological sections. Indeed, at 1 Mpixel/s and 100 nm pixel size an area of 100×100 micrometers can be read out in 1 second and the third dimension can be read out at 1000 layers in 1000 seconds leading to a full 3D image of a 100×100×100 micrometers volume read out in under 20 minutes with a large number of channels detected simultaneously.

Finally, the sensitivity of the instrument at the level of single copy detection and the instrument's ability to image individual antibodies will facilitate tagging of individual antibodies with mass tag barcodes. This, in-turn, allows access to a vast number of tagging options, such that experiments with even 1000 different antibodies could become possible (e.g. using 10 mass channels with binary On/Off barcodes leads to 210=1024 available staining channels).

### Overview of Direct Ionization by Electron Beam

This section describes an alternative setup, where pulsed electron source is used to ablate and ionize the sample, which is already in a vacuum, and the resulting ions are then accelerated into a mass spectrometer directly. With fast enough electronics to generate the electron pulse the need for the laser in this concept is removed which could lead to an additional cost saving for the product.

In, for example, the LA-ICP-MS system used for IMC, the sample is ablated using a laser in a helium/argon environment at near-atmospheric pressure. The ablation event can be thermal or athermal in nature, depending on the choice of laser source (long pulse duration UV laser or femtosecond laser). Either way, the plasma that is formed during the ablation process rapidly neutralizes due to the density of the ablated cloud as well as the extended contact with the carrier gases at atmospheric pressure. An ICP with a vacuum interface is then used to re-ionize the ablated material and sample the ions.

An alternative way to sample the analyte ions would be to prevent neutralization of the ablation by creating a local plasma and injecting the analyte ions from this plasma directly into a mass analyzer. The inventor has realized that in order to prevent neutralization, the sample would need to be in a vacuum environment during the ablation event, and the ablation plasma would need to be sparse enough and expand quickly enough that neutralization is halted and the plasma is ‘frozen’. This means the ablation volume needs to be kept small. Typical laser ablation volumes are about 1×1×1 μm (our HTI platform) or larger (LA-ICP-MS of geological samples, etc.). We can estimate the appropriate ablation volume for ensuring low degree of neutralization in the plasma to be 100×100×100 nm or smaller. Note that the literature for the femtosecond laser induced breakdown spectroscopy (fs-LIBS) often describes the LIBS process as a plasma evolution. LIBS plasma eventually cools down, the ions neutralize, and complex molecules form at the final stages of LIBS evolution. This sequence happens because there are just too many neutral particles generated by ablation and they continue to collide as the plasma cools down. In addition, there are too many charged particles in a small volume and the forces of attraction between positive and negative charged particles can overcome all other forces acting on ions in the ablation plume. For a fixed degree of ionization, the number of ions in the plasma plume goes down as roughly the cubic power of pixel size. The same cubic power law applies to the number of neutral species in the ablated plume. Thus, LIBS type of plasma created at a nanoscale could be a source of analytical ions that can be sampled directly into a mass analyzer without neutralization. In other words, the plume originating from a nanoscale ablation can be sampled as a “frozen” plasma. And then, the plasma can be separated into positive and negative particles and the positive ions can then be detected by a mass spectrometer with high efficiency. In the classical LIBS, the topic of ablated pixels at a spatial resolution of 100 nm (or below) remains unexplored because there is no motivation to go there due to poor optical signals that are the main source of information in LIBS. The inventive step here is to employ LIBS type of plasma created from nanoscale ablation triggered by an electron pulse in combination with direct sampling of ions into a mass spectrometer. Once the ions from the plasma separate from electrons in the plasma they can be analyzed. The sample would need to be in a vacuum environment or at a relatively low pressure during the ablation event to facilitate ion extraction and ion manipulation with a minimal time broadening of the ion packets from corresponding pixels. The vacuum is also needed for the electron beam pulse to be delivered to the specimen.

It might be advantageous to create plasma in a state of a local thermal equilibrium (LTE). This condition has a parallel to the plasma in the traditional ICP-MS. The reason the LTE plasma is useful is because the ionization efficiency becomes dependent on the temperature of the plasma and the ionization potential for a given element. At a temperature of around 7000K the degree of ionization exceeds 90% for the majority of elements used in MaxPar reagents for mass cytometry. At the same time, the degree of ionization for the most abundant biological elements such as carbon, hydrogen and oxygen stays at around of a few percent. Therefore, the amount of charged particles in the expanding plasma remains fairly low which in turn helps with the plasma separation into positive and negative particles.

The temperature of the plasma increases with the amount of the energy deposited into the ablation volume by the pulsed electron beam. Thus, one can adjust the temperature of the plasma by increasing the total charge of the electron pulse (or other parameters of the beam) to achieve the desired degree of ionization and an optimal plasma breakup. Note, the non-thermal plasma can also work for this application. It just makes it harder to anticipate the ion production behavior for the non-thermal plasma. Experiments and modelling can be used as a guidance to develop optimal conditions for ionization with non-thermal plasma. It might happen that a longer pulse duration leads to a plasma that is closer to thermal. But, it might also happen that a shorter pulse duration leads to the thermal plasma. From the technical standpoint it might be easier to operate with a longer electron pulse to avoid repulsion of electrons due to space charge in the beam. However, there is a soft upper limit to the pulse duration imposed by the residence time of the plasma. The electron pulse needs to be shorter than the time needed to expand the plasma away from the specimen.

Mean velocity of atoms in the thermal plasma can be calculated from the temperature of the plasma and the mass of the atoms. It comes at around 3000 m/s for carbon atoms at 7000 K. This is the velocity at which plasma will start expanding from the solid being ablated and into the vacuum. At this velocity, the plasma will cover 30 nm of distance in 10 μs. Thus, 10 μs becomes an estimate for a maximum duration of an electron pulse that can still be used to heat up the plasma. A pulse duration longer than ˜10 μs will not be efficient at converting the electron energy into the plasma energy.

Some electron beams can be routinely focused to a 10 nm diameter spot (or below). This kind of focusing gives its high spatial resolution to electron microscopes.

The beam parameters needed to create a plasma at the desired temperature of 7000 K could be calculated as following.

The electron energy used may correlate with the thickness of the specimen (around 30 nm, proposed). The energy of individual electrons may be chosen low enough so that a large portion of the electron energy is lost in the specimen. Thus, electrons with 30 keV or 100 keV energies (common in electron microscopes) would not be the best choice as their range of penetration into a soft material is on the scale of 1 micrometer or more. At this range, only 3% of the energy may be lost in the first 30 nm and that will be the extent of the energy available for ablation of the specimen. Electrons with significantly lower energy such as 1-2 keV will have a shorter range (comparable to the thickness of the specimen) and are likely to be more suited for this application. Operating electron beams at lower energies also reduces the cost of the electronics for the instrument.

The total energy of the pulse required for an ablation and plasma formation at the specimen can be estimated from the energy balance. Assuming an ablation volume of 10×10×10 nm we can estimate the number of atoms in such volume with an assumption that the atoms are spaced 0.1 nm apart. Thus, the volume subjected to ablation will have 100×100×100 atoms in all three dimensions. This leads to a total of 1 million atoms. In order to break the bonds and heat up atoms to 7000 K one needs to supply ˜2 eV per each atom. Thus, the total amount of energy needed to create the desired plasma is 2 MeV. Considering that the energy of the incoming electrons might be utilized with only 50% efficiency we arrive to the total energy of the electron beam being 4 MeV. Since each electron carries 2 keV, the pulse may need to contain 2000 electrons in order to trigger an ablation. If a pulse of this magnitude arrives within 10 μs it leads to an electron current of 32 □A concentrated into a 10 nm diameter spot.

At this level of electron current and at this electron velocity the space charge effects should be fairly minor. When a larger area needs to be ablated the current will increase with the area and the space charge effects will grow and might become significant. Therefore, the optimal size of the electron beam could be at 10 nm diameter. A much narrower beam is harder to produce and once it enters the specimen at a 1-2 keV energy it would spread to 10 nm volume anyway.

From the peak current and space charge effects point of view it is beneficial to spread the pulse longer. But, the duration of the beam cannot be longer than the time it takes for the plasma to expand. Thus, the optimal pulse duration will need to be around 10 μs. The 10 nm size of the electron beam matches well with the 10 nm size of an antibody. Therefore, only a few antibodies can be interrogated in a given ablation event. The signal from that event will not exceed a signal generated from a few metal tags. This means that the upper limit of dynamic range for such system is reduced to just a few copies per pixel. This could simplify the ion detection system.

If the plasma ionization is sampled efficiently and a tagging reagent is ionized at nearly 100% this would produce 100 ions at the detector assuming close to 100% efficient transmission of ions through the ion path. The ion optics design for the ˜100% efficient transmission will be facilitated by the compact phase space volume of the ion beam emerging from the plasma. Thus, each individual tag may generate a detection event that is easily recognizable from the noise. Therefore, a single copy detection of antibodies becomes a standard mode of operation. This is of high value to mass cytometry customers for several reasons: the antibodies can be counted with high fidelity and their respective locations will be fully characterized; mass tags can then be barcoded to increase the number of readout channels.

### Mass Spectrometer Considerations

Regardless of which approach is used to shrink the ablation volume to an appropriate size, the ions will need to be accelerated immediately from the sample and injected into the mass spectrometer. This will likely require the sample carrier to be conductive (e.g., using an ITO-coated microscope slide or using a conductive coating made of lower-mass atoms that will not show up in our analyte ion channels, such as a graphene coating).

Various configurations of ion optics could be used, such as magnetic sector mass analyzers with multiplexed multichannel detection, TOF mass analyzer without pulse extraction or a TOF mass analyzer without pulse extraction. In the case of a TOF with pulse extraction the pulse can be synchronized with the firing of the electron beam. The purpose of the pulsed extraction could be to improve instrument mass resolution as practiced in the art of MALDI mass spectrometers. There, the technique goes under the name of delayed extraction.

A benefit of the proposed ionization method over our current ICP-based instrumentation is that there would be no background ions from carrier/plasma gases, etc., and so the mass range of the analyzer can be extended to lower masses. High brightness ion species such as carbon+ ions would be present in the ion beam of this method but can be filtered out on the basis of TOF or magnetic separation. On the other hand, molecular ions and clusters would likely show up in the data and complicate the analysis as compared to our current instrument. The majority of the molecular ions and clusters will appear in the mass range that is outside of the mass range of interest for the elemental tags. Thus, they too can be filtered out by a suitable mass spectrometry filtering. As an alternative, molecular ions and clusters could be suppressed by inducing ion fragmentation by means know in the art of mass spectrometry.

Furthermore, by immediately accelerating the ions away from the ablation site the time duration of the ion pulse in the mass analyzer would be very short, which means a vast improvement in the scanning rate would be possible as compared to our current IMC (Hyperion) instrument—up to tens or hundreds of kHz for TOF and up to 100 MHz for magnetic sector instrument. In the case of a magnetic sector instrument the limiting factor could be the pulse duration at the detection channel. The ion optics of a magnetic sector instrument can be designed to maintain ion pulse duration at the detector surface on the scale of 10 ns. This may require the ion optics to contain compensation due to the energy spread introduced by the plasma expansion. A cross over ion optics technology fusing a TOF technology that maintains a narrow beam pulse at the detector and a multi-channel magnetic sector technology can be applied to operate at such high acquisition rates.

### Electron Pulse Generation

The electron pulse needs to produce electrons with the energy on the scale of 1-2 keV. The optimal pulse duration is at around 10 μs. The number of electrons in the pulse required for creating a plasma is around 2000 to 20000. The size of the electron emitter or the beam restricting aperture can be on the order of 1 micrometer providing that the energy distribution of emitted ions facilitates refocusing of the beam to the 10 nm spot size. Schottky electron emitters can be well suited for this task. Ultrafast pulse electronics will be required to create 10 μs wide pulses. A longer electron pulse can be extracted from the emitter and then compressed by an application of an extraction pulse—a similar technique facilitates time of flight focusing in TOF mass analyzers. Alternatively, 10 μs pulse of electrons can be generated from a photocathode. A picosecond or a femtosecond laser can be focused to a 1 micrometer spot to emit the electrons. GaAs or other materials with Negative Electron Affinity (NEA) can be used to serve as an emitter.

The pulse of electrons can be focused to the specimen using a charged particle optics element—an electron beam objective. This element can employ magnetic focusing or electrostatic focusing. Electrostatic focusing could be a cheaper and simpler option for operating with electron energy of 1-2 keV. The design of the electrostatic electron beam objective also needs to support an immersion field that extracts ions from the plasma. Magnetic focusing, on the other hand, can still include the extraction field, but because the big difference in mass between electrons and ions the magnetic objective will act predominantly on electrons while ion trajectories to the first approximation will be unaffected by the magnetic field. This could simplify the design of the objective.

The path of electrons can be separated from the path of ions using methods known in the ion optics art. For example, the electron beam can be deflected by magnetic field while the ions will continue to follow a straight trajectory.

### Sample Considerations

Because the ablation volume is so much smaller compared to our standard platform, the number of analyte ions per laser ablation event is greatly reduced. This would likely be a problem if the end-to-end detection efficiency is not proportionally improved. Due to the lack of vacuum interface, and the possibility of using a TOF or a magnetic mass analyzer, the end-to-end detection efficiency may be significantly higher. On the other hand, the ionization efficiency of the analyte ions could be reduced as compared to our ICP-based instruments due to some recombination of the plasma during its expansion phase. Either way, the technique would obviously benefit from new staining techniques increasing the number of analyte ions per volume.

Another consideration is that the short ablation depth means that thin samples will need to be used, on the order of 100 nm or thinner. These are routinely used in electron microscopy. These samples are resin-embedded, which would likely be beneficial due to dimensional stability and reproducibility of ablation threshold regardless of the inhomogeneity of the biological sample.

A large number of serial sections can be prepared for a single specimen and then quickly read out by the proposed method. This makes this methods well suited for 3D analysis of biological sections. Indeed, at 1 Mpixel/s and 100 nm pixel size an area of 100×100 micrometers can be read out in 1 second and the third dimension can be read out at 1000 layers in 1000 seconds leading to a full 3D image of a 100×100×100 micrometers volume read out in under 20 minutes with a large number of channels detected simultaneously.

Finally, the sensitivity of the instrument at the level of single copy detection and the instrument's ability to image individual antibodies will facilitate tagging of individual antibodies with mass tag barcodes. This, in-turn, allows access to a vast number of tagging options, such that experiments with even 1000 different antibodies could become possible (e.g. using 10 mass channels with binary On/Off barcodes leads to 210=1024 available staining channels).

### Additional Aspects of the Direct Ionization System and Methods

The system and methods of direct ionization imaging mass spectrometry may have alternative or additional aspects as described below.

For example, the system may contain a sample chamber, which is the component in which the sample is placed when it is subjected to analysis. The sample chamber may comprise a stage, which holds the sample (typically the sample is on a sample carrier, such as a microscope slide, e.g. a tissue section, thin EM section, a monolayer of cells or individual cells, such as where a cell suspension has been dropped onto the microscope slide, and the slide is placed on the stage). The sampling and ionisation system acts to remove material from the sample in the sample chamber (the removed material being called sample material herein) which is converted into elemental ions, e.g., as part of the process that causes the removal of the material from the sample.

The ionised material is then analysed by the second system which is the detector system. The detector system can take different forms depending upon the particular characteristics of the ionised sample material being determined, for example a mass detector in mass spectrometry-based analyser apparatus.

In certain aspects, the sampling and ionization system comprises a radiation source that directs radiation (such as a laser or an electron beam) onto a spot of the sample, so as to form a plasma that atomizes and ionizes material at that spot, forming elemental ions (i.e., atomic ions).

In certain aspects, a laser scanning system directs laser radiation onto the sample to be ablated and forms a plasma at that spot. As the laser scanner is faster moving (i.e. has a quicker response time) than a sample stage, due to much lower or no inertia, it enables ablation of discrete spots on the sample to be performed more quickly, so enabling a significantly greater area to be ablated per unit time without loss of resolution. In addition, the rapid change in the spots onto which laser radiation is directed permits the ablation of random patterns, for instance so that a whole cell of non-uniform shape is ablated, by a burst of pulses/shots of laser radiation in rapid succession directed onto locations on the sample using the laser scanner system, and then ionised and detected as a single cloud of material, thus enabling single cell analysis. The locations are typically neighbouring positions, or close to one another.

The ions of the sample material are then passed into the detector system. Although the detector system can detect many ions, some of these may be ions of the atoms that naturally make up the sample. In some applications, for example analysis of minerals, such as in geological or archaeological applications, this may be sufficient.

In some cases, for example when analysing biological samples, the native element composition of the sample may not be suitably informative. This is because, typically, all proteins and nucleic acids are comprised of the same main constituent atoms, and so while it is possible to tell regions which contain protein/nucleic acid from those that do not contain such proteinaceous or nucleic acid material, it is not possible to differentiate a particular protein from all other proteins. However, by labelling the sample with atoms not present in the material being analysed under normal conditions, or at least not present in significant amounts (for example certain transition metal atoms, such as rare earth metals; see section on labelling below for further detail), specific characteristics of the sample can be determined. In common with IHC and FISH, the detectable labels can be attached to specific targets on or in the sample (such as fixed cells or a tissue sample on a slide), inter alia through the use of SBPs such as antibodies, nucleic acids or lectins etc. targeting molecules on or in the sample. In order to detect the ionised label, the detector system is used, as it would be to detect ions from atoms naturally present in the sample. By linking the detected signals to the known positions of the sampling of the sample which gave rise to those signals it is possible to generate an image of the atoms present at each position, both the native elemental composition and any labelling atoms (see e.g. references 2, 3, 4, 5). In aspects where native elemental composition of the sample is depleted prior to detection, the image may only be of labelling atoms. The technique allows the analysis of many labels in parallel (also termed multiplexing), which is a great advantage in the analysis of biological samples, now with increased speed due to the application of a laser scanning system in the apparatus and methods disclosed herein.

Thus, the invention provides an apparatus for analysing a sample, such as a biological sample, comprising:
(i) a sampling and ionisation system to remove material from the sample and to ionise said material to form elemental ions, comprising a radiation source (such as a laser source) for forming a plasma at a sample spot, and optionally a laser scanning system and/or solid support (e.g., such as a sample carrier, transparent slide, electron microscopy mesh, and/or translatable sample stage); and
(ii) a detector to receive elemental ions from said sampling and ionisation system and to detect said elemental ions.

### Combinations of High Throughput and Automated Imaging

The above described embodiments of high throughput and automated sample preparation, segmentation, and rapid acquisition are within the scope of the subject application, alone or in any suitable combination.

1. A system for introduction of slides into an imaging system, comprising:
an automated slide handler comprising 6 degrees of freedom.

2. The system of claim 1, wherein the automated slide handler comprises a robotic arm.

3. The system of claim 1 or 2, wherein the system further comprises a laser ablation system.

4. The system of any one of claim 2, wherein the system further comprises one or more cameras integrated to direct robotic arm operation.

5. The system of any one of claims 1 to 4, further comprising a slide hotel configured to hold a plurality of slides, wherein the slide handler is configured to transfer slides between the slide hotel and one or more imaging systems.

6. The system of any one of claims 1 to 5, wherein the system is configured to record regions of interest for a plurality of slides in the slide hotel.

7. The system of any one of claims 1 to 6, further comprising a sample preparation station.

8. The system of claim 7, wherein the sample preparation station is configured to deliver reagents to samples mounted on one or more slides.

9. The system of claim 8, wherein the reagents comprise mass tagged antibodies.

10. The system of any one of claims 1 to 9, further comprising an imaging system.

11. The system of claim 10, wherein the imaging system comprises an imaging mass cytometer.

12. The system of claim 10 or 11, wherein the imaging system performs pixel by pixel acquisition.

13. The system of any one of claims 1 to 12, wherein the system comprises an imaging mass cytometer, and wherein the system is configured to record one or more regions of interest for imaging by an imaging mass cytometer.

14. The system of claim 13, wherein the imaging mass cytometer comprises a sampling device.

15. The system of claim 14, wherein the sampling device is a laser ablation source.

16. The system of claim 14 or 15, wherein the imaging mass cytometer comprises an inductively coupled plasma mass spectrometer.

17. The system of any one of claims 13 to 16, wherein the imaging mass cytometer comprises a TOF detector.

18. The system of any one of claims 13 to 17, wherein the imaging system comprises an optical microscope integrated with a LA-ICP-MS system.

19. The system of claim 18, wherein the system is configured to create fiducials on slides through laser ablation.

20. The system of claim 19, wherein the system is configured to identify laser ablation fiducials on a slide to direct sampling of an ROI.

21. The system of any one of claims 13 to 20, wherein the imaging system comprises an optical microscope.
The system of any one of claims 1 to 20, wherein system comprises an imaging mass cytometer and an optical microscope separate from the imaging mass cytometer, wherein the slide handler is configured to transfer slides between the optical microscope and the imaging mass cytometer.

22. The system of claim 21, wherein the optical microscope comprises a fluorescence microscope.

23. The system of claim 21, wherein the optical microscope comprises a confocal microscope.

24. The system of any one of claims 1 to 23, wherein the system is configured to perform imaging mass cytometry on an ROI determined by the optical microscope.

25. The system of any one of claims 1 to 24, wherein the system is configured to identify ROI based on features of a tissue section on a slide.

26. A system comprising an imaging mass cytometer operatively coupled to an automated slide handler comprising 6 degrees of freedom.

27. A method of using the system of any one of claims 1 to 26 for automated introduction of a plurality of slides into an imaging system from a slide hotel.

28. The method of claim 27, comprising recording regions of interest (ROIs) on the plurality of slides in a first step.

29. The method of claim 28, further comprising introducing the plurality of slides into the imaging system and imaging regions of interest using the imaging system, in a second step.

30. The method of any one of claims 27 to 29, wherein imaging is by imaging mass cytometry.

31. The method of claim 30, wherein the region of interest is determined by an imaging modality other than imaging mass cytometry.

32. The method of any one of claims 27 to 31, wherein the samples include banked FFPE samples.

33. The method of any one of claims 27 to 31, wherein the samples include banked FFPE samples.

34. The method of any one of claims 27 to 33, further comprising creating fiducials on the slide through laser ablation.

35. The method of any one of claims 27 to 34, further comprising staining the sample with a segmentation panel comprising mass tagged antibodies to a plurality of membrane targets.

36. The method of any one of claims 27 to 35, further comprising automated staining of samples in the slide hotel.

37. The method of any one of claims 27 to 36, further comprising resin embedding and array tomography sample preparation.

38. The method of any one of claims 27 to 36, wherein the automated slide handler comprises a robotic arm and wherein the system further comprises one or more cameras integrated to direct robotic arm operation.

39. The method of claim 38, wherein the one or more cameras comprise a stereoscopic camera positioned on the robotic arm.

40. The method of claim 38, wherein the one or more cameras provide a 3D view.

41. The method of any one of claims 38 to 40, further comprising stopping a motion of the robotic arm and checking a position of the robotic arm or a slide prior to committing to an action requiring alignment of the slide with equipment accessed by the robotic arm.

42. The system of claim 4, wherein the one or more cameras comprise a stereoscopic camera positioned on the robotic arm.

43. The system of claim 4, wherein the one or more cameras provide a 3D view.

44. The system of claim 4, 42 or 43, further comprising fiducials on one or more of a slide, an imaging system, and a slide holder.

45. The system of claim 4, 42, 43 or 44, further comprising a computer readable medium comprising software instructions to halt a motion of the robotic arm, and to check a position of the robotic arm or a slide, prior to committing to an action requiring alignment of the slide with equipment accessed by the robotic arm.

46. The system of claim 45, wherein the equipment accessed by the robotic arm comprises at least one of an imaging system and a slide hotel.

47. A automated imaging system, comprising:
a slide hotel configured to retain a plurality of tissue slides;
an imaging system configured to receive a tissue slide;
a robotic arm comprising a gripper configured to handle the tissue slide, wherein the robotic arm has 6 degrees of freedom, and wherein the robotic arm can access both the slide hotel and the imaging system.
